(19) United States
(12) Patent Application Publication
(10) Pub. No.: US 2011/0172126 A1
(43) Pub. Date: Jul. 14, 2011

(54) LIBRARIES OF PEPTIDE CONJUGATES AND METHODS FOR MAKING THEM

(75) Inventor: Andreas Friedrich Brust, Queensland (AU)

(73) Assignee: XENOME LTD, Indooroopilly, Queensland (AU)

(21) Appl. No.: 13/061,744

(22) PCT Filed: Sep. 3, 2009
(86) PCT No.: PCT/AU2009/001149

§ 371 Date: Mar. 31, 2011

Related U.S. Application Data
(60) Provisional application No. 61/094,019, filed on Sep. 3, 2008.

(51) Int. Cl. C40B 40/10; C40B 50/00; C40B 50/18

(52) U.S. Cl. 506/18; 506/23; 506/32

(57) ABSTRACT

The invention relates to peptide conjugates including at least one turn inducer wherein the turn inducer comprises a 5-7 membered saturated or unsaturated nitrogen containing heterocyclic ring and methods of making the peptides. Libraries of these peptides, methods of making the libraries are also described and methods of screening the libraries for therapeutic activity are also described.

### FIELD OF THE INVENTION

The present invention relates generally to peptide conjugates including at least one turn inducer and methods of making such peptides. In particular, the present invention relates to such peptide conjugates and libraries thereof, which may possess therapeutic activity. The invention also relates to methods of preparing the libraries of peptide conjugates.

### BACKGROUND OF THE INVENTION

A common method of approaching drug discovery is to identify a biochemical pathway that is operating in a pathological process and those steps that occur in the pathway that may be modulated to disrupt the pathological process. Assays that determine the ability of the enzymes or receptors in the pathway to function may then be used for screening a variety of compounds to identify those with potential therapeutic activity for the pathological condition. With high-throughput screening techniques, vast numbers of compounds may be assayed in a short period of time. The supply of suitable compounds to assay becomes a rate-limiting step in the search for potential therapeutic agents.

Combinatorial libraries are collections of compounds prepared using multistep synthetic routes where different chemical entities may be inserted at any particular synthetic step. This type of synthesis lends itself well to the preparation of peptide combinatorial libraries.

Together with α-helices and β-sheets, turns are one of the three major classes of polypeptide secondary structure. A turn is defined as a region where a peptide chain reverses its overall direction. Turns may account for as much as one third of the residues in a globular protein and they often are located on the surface of a protein where they may undergo post-translational modification and may serve as sites of recognition in interactions with receptors, enzymes or antibodies. Turn structures are capable of participating in biological recognition events in either an active role, where the precise spatial orientation of pharmacophore information is critical to the interaction, or in a more passive manner, where the importance relates to the proper positioning of the two chains as they enter and exit the turn.

Structural studies have shown that a large number of small peptides, such as somatostatin, oxytocin, vasopressin, desmopressin, luteinizing hormone-releasing hormone (LHRH), Leu-enkephalin, angiotensin II and bradykinin, include turns such as β-turns or γ-turns.

The structural mimicry of turns is a promising tool for efficient discovery of bioactive compounds. For example, turn mimetic technology such as that disclosed in WO9948913A1, is used to reproduce structural and functional elements in bioactive peptides but with improved druglike characteristics such as greater stability or better bioavailability compared to the template peptide or protein turn structure from which it is derived or upon which it is modelled. However, despite the emergence of a number of turn mimetic technologies, there are few examples of drugs in clinical development derived from such platforms. Moreover, given the low rate of registration of new chemical entities through regulatory agencies such as the Food and Drug Administration, it is clear that there is a pressing need for new technologies to identify and develop greater numbers of candidates for drug development.

One method of identifying new drug candidates is to screen libraries of compounds against validated or interesting drug targets for example GPCRs, ion channels, transporters, kinases or proteases. Libraries of peptides incorporating turn inducers are desirable for screening as potential therapeutic agents or as lead compounds for the development of therapeutic agents. Combinatorial chemistry techniques can be utilized for creating large libraries of peptide turn mimetics for medium to high throughput de novo screening experiments. Smaller, focussed libraries can also be developed for knowledge-based screening (ie designing a subset of peptide conjugates based on a known pharmacophore or functional element). Such libraries can be created using combinatorial or semi-combinatorial chemistry techniques. Upon screening, libraries incorporating turn inducers have demonstrated a high efficiency of producing novel bioactive peptide conjugates with stable turn structures. At least some of the peptide conjugates of the present invention have been identified as inhibitors of transporters such as the norepinephrine transporter (hNET) and, as such, may be suitable therapeutic agents for treating pain, migraine, depression, schizophrenia, anxiety and other psychotic disorders. Additionally hNET inhibitors may be useful in influencing learning memory and endocrine and autonomic functions. Other peptide conjugates of the present invention have been identified as modulators of other important classes of drug targets such as GPCRs and ion channels, modulators of which may be suitable therapeutic agents for treating cancer, autoimmune disorders, gastrointestinal disorders, pulmonary disorders, metabolic disorders, musculoskeletal disorders or ophthalmological disorders.

### SUMMARY OF THE INVENTION

The present invention is predicated in part on the discovery that peptides including a substituted N-containing heterocyclic ring could be used to mimic both β-turns and γ-turns and may be adapted to present a variety of amino acid side chains in specific orientations before, at or after the turn and that libraries of these peptides may be screened for therapeutic value.

The present invention provides libraries of peptide conjugates and methods of making these libraries. The present invention also provides methods of designing a focussed library tailored to bind to a specified receptor or target. The present invention also relates to the use of the library in identifying peptide conjugates of potential therapeutic value and peptide conjugates that are useful as modulators of a number of important drug classes including transporters, such as human norepinephrine transport (hNET) inhibitors, GPCRs, ion channels, kinases and proteases.

In a first aspect, the present invention provides a library of peptide conjugates comprising two or more different peptide conjugates represented by formula (I):

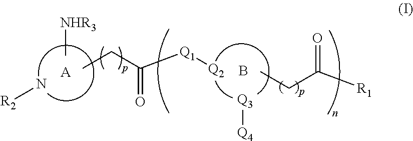

wherein:
A and any B present are independently selected from a 5-7 membered saturated or unsaturated nitrogen-containing heterocyclic ring;
R₁ is an amino acid or a peptide having 2 to 5 amino acid residues, wherein the amino acid or peptide is optionally capped with a C-terminal capping group;
one of R₂ and R₃ is an amino acid or a peptide having 2 to 5 amino acid residues wherein the amino acid or peptide is optionally capped with an N-terminal capping group;
the other of R₂ and R₃ is hydrogen, —C₁₋₁₀ alkyl, —C₂₋₁₀alkenyl, —C₂₋₁₀alkynyl, —C₃₋₈ cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆ alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
each Q₁ is independently NH or absent;
when Q₁ is NH, Q₂ is C or CH, Q₃ is N and Q₄ is R₄;
when Q₁ is absent, Q₂ is N, Q₃ is C or CH and Q₄ is NHR₄;
each R₄ is independently selected from hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein the carbonyl containing substituents (—(CH₂)ₚCOQ₁) and/or (—(CH₂)ₚCOR₁) are in an α-, β- or γ-position of the A and/or B rings with respect to the A and/or B ring nitrogen atoms;
or a salt thereof.

In another aspect of the invention there is provided a method of producing a focussed peptide conjugate library, said method comprising the steps of:
i) identifying a bioactive turn-containing peptide and its target receptor or enzyme;
ii) identifying amino acid residues around the turn in the bioactive peptide;
iii) preparing a focussed library comprising two or more peptide conjugates of formula (V)

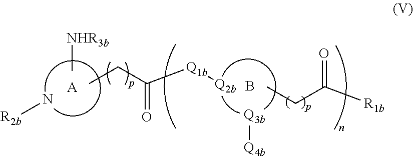

wherein A and any B present are independently selected from a 5-7 membered saturated or unsaturated nitrogen-containing heterocyclic ring;
R_{1b} is an amino acid residue or a peptide of 2 to 5 residues wherein the amino acid residue or peptide is optionally capped with a C-terminal capping group;
one of R_{2b} and R_{3b} is hydrogen, a substituent selected from —C₁₋₁₀alkyl, —C₂₋₁₀alkenyl, —C₂₋₁₀alkynyl, —C₃₋₈cycloalkyl, —CO₀₋₆ alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆ alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
the other of R_{2b} and R_{3b} is an amino acid or a peptide of 2 to 5 residues wherein the amino acid or peptide is optionally capped with an N-terminal capping group;
each Q_{1b} is independently NH or absent;
when Q_{1b} is NH, Q_{2b} is C or CH, Q_{3b} is N and Q_{4b} is R_{4b};
when Q_{1b} is absent, Q_{2b} is N, Q_{3b} is C or CH and Q_{4b} is NHR_{4b};
each R_{4b} is independently selected from hydrogen, a substituent selected from —C₁₋₁₀alkyl, —C₂₋₁₀alkenyl, —C₂₋₁₀alkynyl, —C₃₋₈cycloalkyl, —C₀₋₆ alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein at least one amino acid of R_{1b}, R_{2b} or R_{3b} is an amino acid that forms part of the peptide turn in the bioactive turn-containing peptide or an amino acid that is a conservative substitution thereof and/or at least one of R_{2b}, R_{3b} or R_{4b} is a substituent, acyl group or sulfonyl group that mimics the side chain of an amino acid residue that forms part of the peptide turn in the bioactive turn-containing peptide or a conservative substitution thereof; and
wherein the carbonyl containing substituents (—(CH₂)ₚCOQ_{1b}) and/or (—(CH₂)ₚCOR_{1b}) are in an α-, β- or γ-position of the A and/or B rings with respect to the A and/or B ring nitrogen atoms; or a salt thereof.

In another aspect of the present invention there is provided a method of preparing a library of peptide conjugates comprising the steps of:
i) preparing a first peptide attached to a compartmentalized solid phase support through a safety catch linker,
ii) introducing a turn inducer represented by the formula (II)

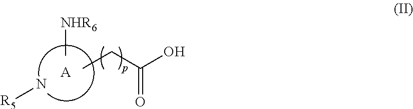

wherein A is a 5-7 membered saturated or unsaturated nitrogen-containing heterocyclic ring, p is 0 or 1, R₅ and R₆ are independently orthogonal amino protecting groups wherein at least one protecting group is stable under conditions used to deprotect the other amino protecting group, wherein the carboxylic acid or acetyl substituent is in the α-, β- or γ-position of the ring with respect to the ring nitrogen atom;
iii) deprotecting one of the amino protecting groups R₅ or R₆ on the N-terminal turn inducer;
iv) optionally repeating step ii) and iii) one or two times;
v) introducing a second peptide at the free amino group of the N-terminal turn inducer;
vi) deprotecting the remaining turn inducer protecting group(s), R₅ or one to three R₆s, the N-terminal protecting group and side chain protecting groups; and
vii) cleaving the peptide conjugates from the compartmentalized solid support and linker;
   wherein the first peptide and second peptide independently comprise 1 to 5 amino acid residues; and
   wherein at least one of preparing the first peptide, introducing the turn inducer(s), and introducing the amino acids of the second peptide involves a split and mix strategy to introduce variation into the amino acid sequence or turn inducer(s) of the peptide conjugate.

According to another aspect of the invention there is provided a peptide conjugate comprising the formula (VI):

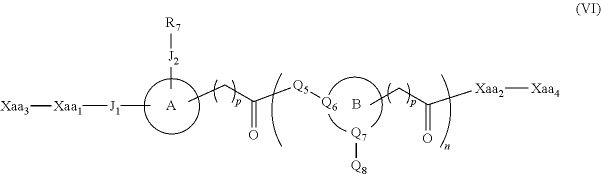

wherein Xaa₁ is absent or is an amino acid residue;
Xaa₂ is absent or is an amino acid residue;
Xaa₃ is an amino acid residue or a peptide having 2 to 4 amino acid residues wherein the amino acid residue or peptide are optionally capped with an N-terminal capping group;
Xaa₄ is an amino acid residue or a peptide having 2 to 4 amino acid residues wherein the amino acid residue or peptide are optionally capped with a C-terminal capping group;
wherein Xaa₃ and Xaa₄ are optionally linked through cyclization of an amino acid side chain of Xaa₃ and an amino acid side chain of Xaa₄, the N-terminal capping group and C-terminal capping group, an amino acid side chain of Xaa₃ and the C-terminal capping group or an amino acid side chain of Xaa₄ and the N-terminal capping group;
A and any B present are independently selected from a 5-7 membered saturated or unsaturated nitrogen-containing heterocyclic ring;
one of J₁ and J₂ is an amino group, —NH—, attached to an A ring carbon atom;
the other of J₁ and J₂ is a covalent bond with the A ring nitrogen atom;
each Q₅ is independently NH or absent;
when Q₅ is NH, Q₆ is C or CH, Q₇ is N and Q₈ is R₇;
when Q₅ is absent, Q₆ is N, Q₇ is C or CH and Q₈ is NHR₇;
each R₇ is independently selected from hydrogen, —C₁₋₁₀alkyl, —C₂₋₁₀alkenyl , —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein the carbonyl containing substituents (—(CH₂)ₚCOQ₅) and/or (—(CH₂)ₚCOXaa₂) are attached to the A and/or B rings at a carbon atom in an α-, β- or γ-position with respect to the A and/or B ring nitrogen atom; or a salt thereof.

In yet another aspect of the present invention there is provided a method of treating or preventing pain, migraine, inflammation, lower urinary tract disorders, cardiovascular disorders, mood disorders, depression, schizophrenia, anxiety, psychotic disorders, memory disorders, endocrine or autonomic disfunction, oncological disorders such as cancer, autoimmune disorders, gastrointestinal disorders, pulmonary disorders, metabolic disorders, musculoskeletal disorders or ophthalmological disorders, comprising administering to a subject in need thereof an effective amount of a peptide conjugate comprising the formula (VI):

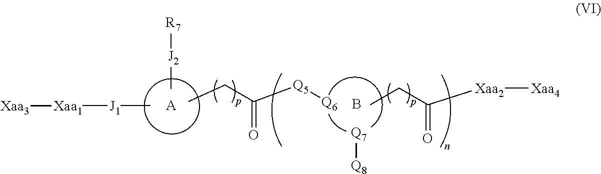

wherein Xaa₁ is absent or is an amino acid residue;
Xaa₂ is absent or is an amino acid residue;
Xaa₃ is an amino acid residue or a peptide having 2 to 4 amino acid residues wherein the amino acid residue or peptide are optionally capped with an N-terminal capping group;
Xaa₄ is an amino acid residue or a peptide having 2 to 4 amino acid residues wherein the amino acid residue or peptide are optionally capped with a C-terminal capping group;
wherein Xaa₃ and Xaa₄ are optionally linked through cyclization of an amino acid side chain of Xaa₃ and an amino acid side chain of Xaa₄, the N-terminal capping group and C-terminal capping group, an amino acid side chain of Xaa₃ and the C-terminal capping group or an amino acid side chain of Xaa₄ and the N-terminal capping group;
A and any B present are independently selected from a 5-7 membered saturated or unsaturated nitrogen-containing heterocyclic ring;
one of J₁ and J₂ is an amino group —NH— attached to an A ring carbon atom;
the other of J₁ and J₂ is a covalent bond with the A ring nitrogen atom;
each Q₅ is independently NH or absent;
when Q₅ is NH, Q₆ is C or CH, Q₇ is N and Q₈ is R₇;
when Q₅ is absent, Q₆ is N, Q₇ is C or CH and Q₈ is NHR₇;
each R₇ is independently selected from hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, or —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein the carbonyl containing substituents (—(CH₂)ₚCOQ₅) and/or (—(CH₂)ₚCOXaa₂) are attached to the A and/or B rings at a carbon atom in an α-, β- or γ-position with respect to the A and/or B ring nitrogen atom; or a salt thereof.

In yet a further aspect the present invention provides a pharmaceutical composition comprising a peptide conjugate comprising the formula (VI):

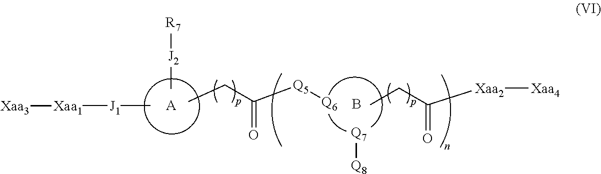

wherein Xaa₁ is absent or is an amino acid residue;
Xaa₂ is absent or is an amino acid residue;
Xaa₃ is an amino acid residue or a peptide having 2 to 4 amino acid residues wherein the amino acid residue or peptide are optionally capped with an N-terminal capping group;
Xaa₄ is an amino acid residue or a peptide having 2 to 4 amino acid residues wherein the amino acid residue or peptide are optionally capped with a C-terminal capping group;
wherein Xaa₃ and Xaa₄ are optionally linked through cyclization of an amino acid side chain of Xaa₃ and an amino acid side chain of Xaa₄, the N-terminal capping group and C-terminal capping group, an amino acid side chain of Xaa₃ and the C-terminal capping group or an amino acid side chain of Xaa₄ and the N-terminal capping group;
A and any B present are independently selected from a 5-7 membered saturated or unsaturated nitrogen-containing heterocyclic ring;
one of J₁ and J₂ is an amino group —NH— attached to an A ring carbon atom;
the other of J₁ and J₂ is a covalent bond with the A ring nitrogen atom;
each Q₅ is independently NH or absent;
when Q₅ is NH, Q₆ is C or CH, Q₇ is N and Q₈ is R₇;
when Q₅ is absent, Q₆ is N, Q₇ is C or CH and Q₈ is NHR₇;
each R₇ is independently selected from hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein the carbonyl containing substituents (—(CH₂)ₚCOQ₅) and/or (—(CH₂)ₚCOXaa₂) are attached to the A and/or B ring at a carbon atom in an α-, β- or γ-position with respect to the A and/or B ring nitrogen atom; or a salt thereof, together with a pharmaceutically acceptable carrier.

### DESCRIPTION OF THE INVENTION

### Definitions

As used herein, the term “5-7 membered saturated or unsaturated nitrogen containing heterocyclic ring” refers to a cyclic hydrocarbon ring in which at least one carbon atom has been replaced with a nitrogen atom. Optionally one to three more carbon atoms may be replaced with heteroatoms independently selected form N, S and O. The ring may be saturated or unsaturated or fused to a second ring which is optionally aromatic. Examples of suitable nitrogen containing rings include pyrrolidine, 2-pyrroline, 3-pyrroline, pyrazolidine, imidazolidine, 2-pyrazoline, piperidine, piperazine, thiazine, 2H-1,2-oxazine, 4H-1,4-oxazine, 1,2,4-oxadiazine, morpholine, thiomorpholine, azepine, indoline, 1H-indazole, 2H-1,2,4-benzoxadiazine, 4H-1,4-benzoxazine, 2,3-dihydrobenzoisoindole, 2,3-dihydroindazole, 2,3-dihydrobenzoimidazole, 1,2,3,4-tetrahydroquinoline, 1,2,3,4-tetrahydroisoquinoline, 1,2-dihydroquinoline, 1,2-dihydroisoquinoline, benzopiperazine, benzothiazine, 4H-1,4-benzoxazine, 2,3-dihydrophthalazine, 2,3,4-trihydro-1,4-benzoxazine, 2H-1,2,4-benzoxadiazine, 4H-1,4-benzoxazine, benzothiomorpholine, 1,2-dihydroquinoxaline, 1,2-dihydro-1,8-naphthyridine, 1,2-dihydro-1,7-naphthyridine, 7,8-dihydro-1,7-naphthyridine, 1,2-dihydro-1,5-naphthyridine, 5,6-dihydro-1,5-naphthyridine, 1,2-dihydro-1,6-naphthyridine and 5,6-dihydro-1,6-naphthyridine.

The term “amino acid” as used herein refers to natural amino acids and non-natural amino acids.

As used herein, the term “natural or common amino acid” refers to amino acids that occur in nature and commonly form the building blocks of proteins. Examples of natural amino acids are given in Table 1 together with their one letter and three letter codes. Natural or common amino acids may be in the L- or D-configuration.

TABLE 1

| | One letter | Three letter | | One letter | Three letter |
|---|---|---|---|---|---|
| Amino Acid | code | code | Amino Acid | code | code |
| L-alanine | A | Ala | D-alanine | a | ala |
| L-arginine | R | Arg | D-arginine | r | arg |
| L-asparagine | N | Asn | D-asparagine | n | asn |
| L-aspartic acid | D | Asp | D-aspartic acid | d | asp |
| L-cysteine | C | Cys | D-cysteine | c | cys |
| L-glutamine | Q | Gln | D-glutamine | q | gln |
| L-glutamic acid | E | Glu | D-glutamic acid | e | glu |
| glycine | G | Gly | | g | gly |
| L-histidine | H | His | D-histidine | h | his |
| L-isoleucine | I | Ile | D-isoleucine | i | ile |
| L-leucine | L | Leu | D-leucine | l | leu |
| L-lysine | K | Lys | D-lysine | k | lys |
| L-methionine | M | Met | D-methionine | m | met |
| L-phenylalanine | F | Phe | D-phenylalanine | f | phe |
| L-proline | P | Pro | D-proline | p | pro |
| L-serine | S | Ser | D-serine | s | ser |
| L-threonine | T | Thr | D-threonine | t | thr |
| L-tryptophan | W | Trp | D-tryptophan | w | trp |
| L-tyrosine | Y | Tyr | D-tyrosine | y | tyr |
| L-valine | V | Val | D-valine | v | val |

As used herein, the term “non-natural amino acid” refers to amino acids that do not occur in nature or are uncommon amino acids. Non-natural amino acids may be derivatives of natural amino acids or may be synthetic compounds containing an amino group and a carboxylic acid group suitably disposed to be incorporated into a peptide, for example, α, β and γ-amino acids. Non-natural amino acids may be in the L- or D-configuration. Examples of suitable non-natural amino acids having modified side chains and other unnatural amino acids is shown in Table 2.

TABLE 2
List of non-naturally occurring amino acids and derivatives

| Non-conventional | | 1 letter | Non-conventional | | 1 letter |
|---|---|---|---|---|---|
| amino acid | Code | code | amino acid | Code | code |
| α-aminobutyric acid | Abu | | L-N-methylalanine | NMA | |
| α-amino-α-methylbutyrate | Mgabu | | L-N-methylarginine | NMR | |
| aminocyclopropane- | Cpro | | L-N-methylasparagine | NMN | |
| carboxylate | | | L-N-methylaspartic acid | NMD | |
| aminoisobutyric acid | Aib | | L-N-methylcysteine | NMC | |
| aminonorbornyl- | Norb | | L-N-methylglutamine | NMQ | |
| carboxylate | | | L-N-methylglutamic acid | NME | |
| L-cyclohexylalanine | CHA | | L-N-methylhistidine | NMH | |
| cyclopentylalanine | Cpen | | L-N-methylisoleucine | NMI | |
| L-N-methylleucine | NML | | L-N-methyllysine | NMK | |
| L-N-methylmethionine | NMM | | L-N-methylnorleucine | NMNLE | |
| L-N-methylnorvaline | NMNVA | | L-N-methylornithine | NMORN | |
| L-N-methylphenylalanine | NMF | | L-N-methylproline | NMP | |
| L-N-methylproline | NMP | | L-N-methylserine | NMS | |
| L-N-methylserine | NMS | | L-N-methylthreonine | NMT | |
| L-N-methyltryptophan | NMW | | L-N-methyltyrosine | NMY | |
| D-ornithine | orn | | L-N-methylvaline | NMV | |
| L-N-methylethylglycine | NMETG | | L-N-methyl-t-butylglycine | NMTBUG | |
| L-norleucine | NLE | | L-norvaline | NVA | |
| α-methyl-aminoisobutyrate | Maib | | α-methyl-γ-aminobutyrate | Mgabu | |
| α-methylcyclohexylalanine | Mchexa | | 4,4′-biphenylalanine | BPA | |
| D-α-methylalanine | mala | | α-methylcylcopentylalanine | Mcpen | |
| D-α-methylarginine | marg | | α-methyl-α-napthylalanine | Manap | |
| D-α-methylasparagine | masn | | α-methylpenicillamine | Mpen | |
| D-α-methylaspartate | masp | | N-(4-aminobutyl)glycine | Nglu | |
| D-α-methylcysteine | mcys | | N-(2-aminoethyl)glycine | Naeg | |
| D-α-methylglutamine | mgln | | N-(3-aminopropyl)glycine | Norn | |
| D-α-methylhistidine | mhis | | N-amino-α-methylbutyrate | Nmaabu | |
| D-α-methylisoleucine | mile | | α-napthylalanine | Anap | |
| D-α-methylleucine | mleu | | N-benzylglycine | Nphe | |
| D-α-methyllysine | mlys | | N-(2-carbamylethyl)glycine | Ngln | |
| D-α-methylmethionine | mmet | | N-(carbamylmethyl)glycine | Nasn | |
| D-α-methylornithine | morn | | N-(2-carboxyethyl)glycine | Nglu | |
| D-α-methylphenylalanine | mphe | | N-(carboxymethyl)glycine | Nasp | |
| D-α-methylproline | mpro | | N-cyclobutylglycine | Ncbut | |
| D-α-methylserine | mser | | N-cyclodecylglycine | Ncdec | |
| D-N-methylserine | nmser | | N-cycloheptylglycine | Nchep | |
| D-α-methylthreonine | mthr | | N-cyclohexylglycine | Nchex | |
| D-α-methyltryptophan | mtrp | | N-cyclodecylglycine | Ncdec | |
| D-α-methyltyrosine | mtyr | | N-cylcododecylglycine | Ncdod | |
| D-α-methylvaline | mval | | N-cyclooctylglycine | Ncoct | |
| D-N-methylalanine | nmala | | N-cyclopropylglycine | Ncpro | |
| D-N-methylarginine | nmarg | | N-cycloundecylglycine | Ncund | |
| D-N-methylasparagine | nmasn | | N-(2,2-diphenylethyl)glycine | Nbhm | |
| D-N-methylaspartate | nmasp | | N-(3,3-diphenylpropyl)glycine | Nbhe | |
| D-N-methylcysteine | nmcys | | N-(3-guanidinopropyl)glycine | Narg | |
| D-N-methylglutamine | nmgln | | N-(1-hydroxyethyl)glycine | Nthr | |
| D-N-methylglutamate | nmglu | | N-(hydroxyethyl))glycine | Nser | |
| D-N-methylhistidine | nmhis | | N-(imidazolylethyl))glycine | Nhis | |
| D-N-methylisoleucine | nmile | | N-(3-indolylyethyl)glycine | Nhtrp | |
| D-N-methylleucine | nmleu | | N-methyl-γ-aminobutyrate | Nmgabu | |
| D-N-methyllysine | nmlys | | D-N-methylmethionine | nmmet | |
| N-methylcyclohexylalanine | Nmchexa | | N-methylcyclopentylalanine | Nmcpen | |
| D-N-methylornithine | nmorn | | D-N-methylphenylalanine | nmphe | |
| N-methylglycine | Nala | | D-N-methylproline | nmpro | |
| N-methylaminoisobutyrate | Nmaib | | D-N-methylserine | nmser | |
| N-(1-methylpropyl)glycine | Nile | | D-N-methylthreonine | nmthr | |
| N-(2-methylpropyl)glycine | Nleu | | N-(1-methylethyl)glycine | Nval | |
| D-N-methyltryptophan | nmtrp | | N-methyl-napthylalanine | Nmanap | |
| D-N-methyltyrosine | nmtyr | | N-methylpenicillamine | Nmpen | |
| D-N-methylvaline | nmval | | N-(p-hydroxyphenyl)glycine | Nhtyr | |
| γ-aminobutyric acid | Gaba | | N-(thiomethyl)glycine | Ncys | |
| L-t-butylglycine | TBUG | | penicillamine | Pen | |
| L-ethylglycine | ETG | | L-α-methylalanine | MALA | |
| L-homophenylalanine | HPHE | | L-α-methylasparagine | MASN | |
| L-α-methylarginine | MARG | | L-α-methyl-t-butylglycine | MTBUG | |
| L-α-methylaspartate | MASP | | L-methylethylglycine | METG | |
| L-α-methylcysteine | MCYS | | L-α-methylglutamate | MGLU | |
| L-α-methylglutamine | MGLN | | L-α-methylhomophenylalanine | MHPHE | |
| L-α-methylhistidine | MHIS | | N-(2-methylthioethyl)glycine | Nmet | |
| L-α-methylisoleucine | MILE | | L-α-methyllysine | MLYS | |
| L-α-methylleucine | MLEU | | L-α-methylnorleucine | MNLE | |
| L-α-methylmethionine | MMET | | L-α-methylornithine | MORN | |
| L-α-methylnorvaline | MNVA | | L-α-methylproline | MPRO | |
| L-α-methylphenylalanine | MPHE | | L-α-methylthreonine | MTHR | |
| L-α-methylserine | MSER | | L-α-methyltyrosine | MTYR | |
| L-α-methyltryptophan | MTRP | | L-N-methyl-homophenylalanine | Nmhphe | |
| L-α-methylvaline | MVAL | | N-(N-(3,3-diphenylpropyl) | Nnbhe | |
| N-(N-(2,2-diphenylethyl) | Nnbhm | | carbamylmethylglycine | | |
| carbamylmethylglycine | | | L-pyroglutamic acid | PYR | U |
| 1-carboxy-1-(2,2-diphenyl- | Nmbc | | D-pyroglutamic acid | pyr | u |
| ethylamino)cyclopropane | | | O-methyl-L-serine | Omser | |
| 4-hydroxyproline | HYP | | O-methyl-L-homoserine | Omhser | |
| ornithine | Orn | | 5-hydroxylysine | Hlys | |
| 2-aminobenzoyl (anthraniloyl) | ABZ | | α-carboxyglutamate | Gla | |
| D-cyclohexylalanine | cha | | phenylglycine | Phg | |
| 4-phenyl-phenylalanine | Bib | | L-pipecolic acid (homoproline) | PIP | |
| L-citrulline | CIT | | L-homoleucine | HLE | |
| α-cyclohexylglycine | CHG | | L-lysine (dimethyl) | DMK | |
| L-1,2,3,4-tetrahydroisoquinoline- | TIC | | L-2-naphthylalanine | NAL | |
| 3-carboxylic acid | | | L-dimethyldopa or L-dimethoxy- | DMD | |
| L-thiazolidine-4-carboxylic acid | THZ | | phenylalanine | | |
| L-homotyrosine | HTyr | | L-3-pyridylalanine | PYA | |
| L-2-furylalanine | FLA | | L-histidine (benzoyloxymethyl) | HBO | |
| L-histidine (3-methyl) | HME | | N-cycloheptylglycine | Nchep | |
| N-(3-guanidinopropyl)glycine | Narg | | L-diphenylalanine | DPA | |
| O-methyl-L-tyrosine | MeY | | O-methyl-L-homotyrosine | Omhtyr | |
| O-glycan-serine | g-Ser | | L-β-homolysine | BHK | |
| Meta-tyrosine | m-Tyr | | O-glycan-threoine | g-Thr | |
| Nor-tyrosine | nor-Tyr | | Ortho-tyrosine | o-Tyr | |
| L-N,N′,N″-trimethyllysine | TMK | | L-N,N′-dimethyllysine | DMK | |
| homolysine | Homolys | | L-homoarginine | HomoARG | |
| norlysine | Nor-Lys | | neotryptophan | neo-tryp | |
| N-glycan Asparagine | g-Asn | | 3-benzothienylalanine | BTA | |
| 7-hydroxy-1,2,3,4-tetrahydro- | MFF | | isoquinoline-3-carboxylic acid | HTI | |
| 4-fluorophenylalanine | | | diaminopropionic acid | DPR | |
| 4-methylphenylalanine | MEF | | homocysteine | HCY | |
| bis-(2-picolyl)amine | | | 3,4-dimethoxyphenylalanine | DMF | |
| pentafluorophenylalanine | PFF | | 4-chlorophenylalanine | CLF | |
| indoline-2-carboxylic acid | INC | | L-1,2,3,4-tetrahydronorharman- | TPI | |
| 2-aminobenzoic acid | ABZ | | 3-carboxylic acid | | |
| 3-amino-2-naphthoic acid | ANZ (ANC) | | Adamantylalanine | ADA | |
| Asymmetric dimethylarginine | ADMA | | Symmetrical dimethylarginine | SDMA | |
| L-tetrahydroisoquinoline-1- | TIQ | | 3-carboxythiomorpholine | CTM | |
| carboxylic acid | | | D-1,2,3,4-tetrahydronorharman- | tpi | |
| D-tetrahydroisoquinoline-1- | tiq | | 3-carboxylic acid | | |
| carboxylic acid | | | 3-Aminobenzoic acid | | |
| 1-Amino-cyclohexane acetic acid | | | 3-Amino-1-carboxymethyl- | | |
| D/L-Allylglycine | | | pyridin-2-one | | |
| 4-Aminobenzoic acid | | | 1-amino-1-cyclohexane | | |
| 1-amino-cyclobutane | | | carboxylic acid | | |
| carboxylic acid | | | 2-aminocyclopentane carboxylic | | |
| 2 or 3 or 4-aminocyclohexane | | | acid | | |
| carboxylic acid | | | 1-amino-1-cyclopropane | | |
| 1-amino-1-cyclopentane | | | carboxylic acid | | |
| carboxylic acid | | | 2-aminoindane-2-carboxylic acid | | |
| 1-aminoindane-1-carboxylic acid | | | 4-amino-tetrahydrothiopyran-4- | TTC | |
| 4-amino-pyrrolidine-2-carboxylic | | | carboxylic acid | | |
| acid | | | azetidine-2-carboxylic acid | | |
| 2-aminotetraline-2-carboxylic acid | | | b-(benzothiazol-2-yl)-alanine | | |
| azetidine-3-carboxylic acid | | | neopentylglycine | | |
| 4-benzyl-pyrolidine-2-carboxylic | | | 2-carboxymethyl piperidine | | |
| acid | | | b-cyclobutyl alanine | | |
| tert-butylglycine | | | allylglycine | | |
| b-(benzothiazolyl-2-yl)-alanine | | | diaminopropionic acid | | |
| b-cyclopropyl alanine | | | homo-cyclohexyl alanine | HCH | |
| diaminobutyric acid | | | (2S,4R)- 4-hydroxypiperidine-2 | | |
| 5,5-dimethyl-1,3-thiazolidine-4- | | | carboxylic acid | | |
| carboxylic acid | | | octahydroindole-2-carboxylic | | |
| (2R,4S)4-hydroxypiperidine-2 | | | acid | | |
| carboxylic acid | | | (2S,4R) and (2S,4R)-4-(2-naphthyl) | | |
| (2S,4S) and (2S,4R)-4-(2- | | | pyrrolidine-2-carboxylic acid | | |
| naphthylmethoxy)-pyrolidine-2- | | | Nipecotic acid | | |
| carboxylic acid | | | (2S,4R)and (2S,4S)-4-(4-phenylbenzyl) | | |
| (2S,4S) and (2S,4R)4-phenoxy- | | | pyrrolidine-2-carboxylic acid | | |
| pyrrolidine-2-carboxylic acid | | | (3S)-1-pyrrolidine-3-carboxylic acid | | |
| (2R,5S)and(2S,5R)-5-phenyl- | | | (2S,4S)-4-tritylmercapto- | | |
| pyrrolidine-2-carboxylic acid | | | pyrrolidine-2-carboxylic acid | | |
| (2S,4S)-4-amino-1-benzoyl- | ABP | | (2S,4S)-4-mercaptoproline | MPC | |
| pyrrolidine-2-carboxylic acid | | | t-butylglycine | TBG | |
| t-butylalanine | TBA | | N,N-bis(3-aminopropyl)glycine | | |
| (2S,5R)-5-phenyl-pyrrolidine-2-carboxylic acid | | | 1-amino-cyclohexane-1-carboxylic acid | | |
| 1-aminomethyl-cyclohexane-acetic acid | | | N-mercaptoethylglycine | | |
| 3,5-bis-(2-amino)ethoxy-benzoic acid | | | diaminobutyric acid | DAB | |
| 3,5-diamino-benzoic acid | | | selenocysteine | SEC | |
| 2-methylamino-benzoic acid | NMA | | | | |
| (or N-methylanthranylic acid) | | | | | |

These types of modifications may be important to stabilize the peptide or alter its ADMET pharmacokinetic or pharmacodynamic properties if administered to an individual, or may provide added affinity for a receptor providing increased activity or specificity.

The amino acid residues in the peptide conjugates of the present invention, may be represented as the L-configuration by three letter or one letter codes in capital letters or having initial capital letters (refer to Table 1). For example, L-alanine may be represented by Ala, ALA or A. The D-configuration is represented by codes that are all lower case letter. For example, D-alanine may be represented by ala or a (refer to Table 1).

The amino acid residues may also undergo side chain modification. Examples of side chain modifications contemplated include modifications of amino groups such as by reductive alkylation, by reaction with an aldehyde followed by reduction with NaBH₄; amidination with methylacetimidate; acylation with acetic anhydride; carbamoylation of amino groups with cyanate; trinitrobenzylation of amino groups with 2,4,6-trinitrobenzene sulphonic acid (TNBS); acylation of amino groups with succinic anhydride and tetrahydrophthalic anhydride; and pyridoxylation of lysine with pyridoxal-5-phosphate followed by reduction with NaBH₄. The guanidine group of arginine residues may be modified by the formation of heterocyclic condensation products with reagents such as 2,3-butanedione, phenylglyoxal and glyoxal. The carboxyl group may be modified by carbodiimide activation via O-acylisourea formation followed by subsequent derivitisation, for example, to a corresponding amide.

Sulfhydryl groups may be modified by methods such as carboxymethylation with iodoacetic acid or iodoacetamide; performic acid oxidation to cysteic acid; formation of mixed disulfides with other thiol compounds; reaction with maleimide, maleic anhydride or other substituted maleimide compounds; formation of mercurial derivatives using 4-chloromercuribenzoate, 4-chloromercuriphenylsulphonic acid, phenylmercury chloride, 2-chloromercuri-4-nitrophenol and other mercurials; carbamoylation with cyanate at alkaline pH. Any modification of cysteine residues must not affect the ability of the peptide to form the necessary disulfide bonds. It is also possible to replace the sulfhydryl groups of cysteine with selenium equivalents such that the peptide forms a diselenium bond or a sulfide-selenium bond in place of one or more of the disulfide bonds.

Tryptophan residues may be modified by, for example, oxidation with N-bromosuccinimide or alkylation of the indole ring with 2-hydroxy-5-nitrobenzyl bromide or sulfenyl halides. Tyrosine residues on the other hand, may be altered by nitration with tetranitromethane to form a 3-nitrotyrosine derivative.

Modification of the imidazole ring of a histidine residue may be accomplished by alkylation with iodoacetic acid derivatives or N-carbethoxylation with diethylpyrocarbonate.

Proline residues may be modified by, for example, hydroxylation in the 4-position, or by aliphatic or aromatic substitution on the proline ring system.

The term “peptide” as used herein, unless otherwise stated, refers to an amino acid sequence of two or more amino acid residues. The number of amino acid residues in a sequence may be defined. For example 2 to 5 amino acid residues may be a peptide having 2, 3, 4 or 5 amino acids linked together by amide bonds. The choice of amino acid residues in the peptide is not particularly limited. The amino acid residues may be random combinations or may be chosen to assist with binding to a specific receptor or to assist with transport of peptides across membranes so that they may come into contact with specific receptors in vivo. The amino acids may also confer stability to the peptide, for example, by participating in cyclization to form a cyclic peptide.

The term “peptide conjugate” as used herein refers to two peptides that are linked together by a turn inducer.

As used herein, the term “turn inducer” refers to the compound of formula II either alone or incorporated into the peptide conjugate. The turn inducer allows the first peptide R₁ and the second peptide, R₂ or R₃, to proceed in different directions thereby forming a turn in the peptide conjugate.

The term “amino acid side chain” as used herein refers to a substituent at the α- or β-position of an amino acid. The side chain may be derived from a natural amino acid such as those set out in Table 1 or a non-natural amino acid as set out in Table 2. A group that mimics an amino acid side chain, presents a substituent that is found at the α- or β-position of an amino acid, either natural or non-natural, but is not part of an amino acid.

The term “acyl” as used herein refers to an optionally substituted alkylcarbonyl group or arylcarbonyl group as defined by (C═O)R where suitable R groups include, but are not limited to, —C₁₋₁₀alkyl, —C₂₋₁₀alkenyl, —C₂₋₁₀alkynyl, —C₃₋₈cycloalkyl, —C₃₋₈cycloalkenyl, -aryl, -heterocyclyl, -heteroaryl, —C₁₋₆alkyl-C₃₋₈cycloalkyl, —C₁₋₆alkyl-C₃₋₈cycloalkenyl, —C₁₋₆alkylaryl, —C₁₋₆alkylheterocyclyl, C₁₋₆alkylheteroaryl, —C₁₋₆alkylNRₐC(═NRₐ)N(Rₐ)₂, —C₁₋₆alkylCON(Rₐ)₂, —C₁₋₆alkylCO₂Rₐ, —C₁₋₆alkylSRₐ, —C₁₋₆alkylN(Rₐ)₂, —C₁₋₆alkylORₐ, —C₁₋₆alkylNSO₂Rₐ, —C₁₋₆alkylSO₃Rₐ and —C₁₋₆alkylOPO₃Rₐ wherein each Rₐ is independently selected from —C₁₋₆alkyl, cycloalkyl, cycloalkenyl, aryl, heterocyclyl and heteroaryl, and where each alkyl, alkenyl, alkynyl, cycloalkyl, cycloalkenyl, aryl, heterocyclyl or heteroaryl group may be optionally substituted with —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl.

The term “sulfonyl” as used herein refers to a group as defined by —SO₂R where suitable R groups include, but are not limited to, —C₁₋₁₀alkyl, —C₂₋₁₀alkenyl, —C₂₋₁₀alkynyl, —C₃₋₈cycloalkyl, —C₃₋₈cycloalkenyl, -aryl, -heterocyclyl, -heteroaryl, —C₁₋₆alkyl-C₃₋₈ cycloalkyl, —C₁₋₆alkyl-C₃₋₈cycloalkenyl, —C₁₋₆alkylaryl, —C₁₋₆alkylheterocyclyl, C₁₋₆alkylheteroaryl, —C₁₋₆alkylNRₐC(═NRₐ)N(Rₐ)₂, —C₁₋₆alkylCON(Rₐ)₂, —C₁₋₆alkylCO₂Rₐ, —C₁₋₆alkylSRₐ, —C₁₋₆alkylN(Rₐ)₂ and —C₁₋₆alkylORₐ, wherein each Rₐ is independently selected from hydrogen, —C₁₋₆alkyl, cycloalkyl, cycloalkenyl, aryl, heterocyclyl and heteroaryl, and where each alkyl, alkenyl, alkynyl, cycloalkyl, cycloalkenyl, aryl, heterocyclyl or heteroaryl group may be optionally substituted with —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl.

As used herein, the term “alkyl” refers to a straight chain or branched saturated hydrocarbon group having 1 to 10 carbon atoms. Where appropriate, the alkyl group may have a specified number of carbon atoms, for example, C₁₋₆alkyl which includes alkyl groups having 1, 2, 3, 4, 5 or 6 carbon atoms in a linear or branched arrangement. Examples of suitable alkyl groups include, but are not limited to, methyl, ethyl, n-propyl, i-propyl, n-butyl, i-butyl, t-butyl, n-pentyl, 2-methylbutyl, 3-methylbutyl, 4-methylbutyl, n-hexyl, 2-methylpentyl, 3-methylpentyl, 4-methylpentyl, 5-methylpentyl, 2-ethylbutyl, 3-ethylbutyl, heptyl, octyl, nonyl, and decyl.

The term “alkenyl” as used herein refers to a straight chain or branched unsaturated hydrocarbon group having 2 to 10 carbon atoms and at least one double bond. Where appropriate, the alkenyl group may have a specified number of carbon atoms, for example, C₂₋₆ alkenyl which include alkenyl groups having 2, 3, 4, 5, or 6 carbon atoms in a linear or branched arrangement. Examples of suitable alkenyl groups include, but are not limited to, ethenyl, propenyl, 1-butenyl, 2-butenyl 1,3-butadienyl, 1-pentenyl, 2-pentenyl, 3-pentenyl, 4-pentenyl, 1,3-pentadienyl, 1,4-pentadienyl, 2,4-pentadienyl, 1-hexenyl, 2-hexenyl, 3-hexenyl, 4-hexenyl, 5-hexenyl, 1,3-hexadienyl, 1,4-hexadienyl, 1,5-hexadienyl, 2,4-hexadienyl, 1,3,5-hexatrienyl, heptenyl, octenyl, nonenyl and decenyl.

The term “alkynyl” as used herein refers to a straight chain or branched unsaturated hydrocarbon group having 2 to 10 carbon atoms and at least one triple bond. Where appropriate, the alkynyl group may have a specified number of carbon atoms, for example, C₂₋₆ alkynyl which includes alkynyl groups having 2, 3, 4, 5 or 6 carbon atoms in a linear or branched arrangement. Examples of suitable alkynyl groups include, but are not limited to, ethynyl, propynyl, butynyl, pentynyl, hexynyl, heptynyl, octynyl, nonynyl and decynyl.

The term “cycloalkyl” as used herein refers to a cyclic or caged saturated hydrocarbon ring having 3 to 10 carbon atoms. Examples of suitable cycloalkyl groups include, but are not limited to, cyclopropyl, cyclobutyl, cyclopentyl, cyclohexyl, cycloheptyl, cyclooctyl, norbornyl and adamantyl.

The term “cycloalkenyl” as used herein refers to a cyclic unsaturated hydrocarbon ring having 3 to 10 carbon atoms and at least one double bond, but it is not aromatic. Examples of suitable cycloalkenyl groups include, but are not limited to, cyclopropenyl, cyclobutenyl, cyclopentenyl, cyclohexenyl, cyclohexadienyl, cycloheptenyl and cyclooctenyl.

As used herein, the term “aryl” is intended to mean any stable, monocyclic or bicyclic carbon ring of up to 7 atoms in each ring, wherein at least one ring is aromatic. Examples of such aryl groups include, but are not limited to, phenyl, naphthyl, tetrahydronaphthyl, indanyl, biphenyl and binaphthyl.

The term “heterocyclic” or “heterocyclyl” as used herein, refers to a cyclic hydrocarbon in which one to four carbon atoms have been replaced by heteroatoms independently selected from N, S, O and Se. A heterocyclic ring may be saturated or unsaturated. Examples of suitable heterocyclyl groups include, but are not limited to, tetrahydrofuranyl, tetrahydrothiophenyl, pyrrolidinyl, pyrrolinyl, pyranyl, piperidinyl, piperazinyl, pyrazolinyl, dithiolyl, oxathiolyl, dioxanyl, dioxinyl, morpholino, thiomorpholino, oxazinyl, azepinyl, diazepinyl, thiazepinyl, oxepinyl and thiapinyl.

The term “heteroaryl” as used herein, represents a stable monocyclic or bicyclic ring of up to 7 atoms in each ring, wherein at least one ring is aromatic and at least one ring contains from 1 to 4 heteroatoms selected from the group consisting of O, N and S. Heteroaryl groups within the scope of this definition include, but are not limited to, acridinyl, carbazolyl, cinnolinyl, quinoxalinyl, pyrazolyl, indolyl, benzotriazolyl, furanyl, thienyl, thiophenyl, benzothienyl, benzofuranyl, quinolinyl, isoquinolinyl, oxazolyl, isoxazolyl, imidazolyl, pyrazinyl, pyridazinyl, pyridinyl, pyrimidinyl, pyrrolyl, tetrahydroquinoline, thiazolyl, isothiazolyl, 1,2,4-triazolyl, 1,2,4-oxadiazolyl, 1,2,4-thiadiazolyl, benzodioxanyl, benzazepinyl, benzoxepinyl, benzodiazepinyl, benzothiazepinyl and benzothiepinyl. Preferred heteroaryl groups have 5- or 6-membered rings, such as pyrazolyl, furanyl, thienyl, oxazolyl, isoxazolyl, imidazolyl, pyrazinyl, pyridazinyl, pyridinyl, pyrimidinyl, pyrrolyl, thiazolyl, isothiazolyl, 1,2,4-triazolyl and 1,2,4-oxadiazolyl and 1,2,4-thiadiazolyl.

As used herein, the term “halogen” or “halo” refers to fluorine (fluoro), chlorine (chloro), bromine (bromo) and iodine (iodo).

As used herein, the term “N-terminal capping group” refers to a group covalently bonded to the N-terminal nitrogen atom. The N-terminal capping group may assist in stabilizing the peptide conjugate in vivo or in vitro. For example, the N-terminal capping group may reduce hydrolysis by in vivo proteolytic enzymes or may reduce degradation of the peptide conjugate under storage conditions. The N-terminal capping group may assist in receptor binding providing substituents for further attractive binding in the receptor active site. The N-terminal capping group may also be chosen to allow penetration of the peptide conjugate to the site of activity, for example, through membranes, through the extracellular matrix or through cell walls. The N-terminal capping group may also be present to provide stabilization of the peptide conjugate through cyclization with the C-terminal capping group or a side chain of an amino acid residue in R₁.

In one embodiment, the N-terminal capping group is selected from a group having the formula:

Q-(CH₂)ₘ—Z—

wherein
Q is a straight chain or branched C₁-C₁₀ alkyl group or an optionally substituted aryl or optionally substituted heterocyclyl or heteroaryl group, Z is absent, —C(═O)—, —S(═O)—, —S(O)₂—, —OP(O)—, —OP(═O)(OH)— or —OP(OH)—, and m is 0 or an integer from 1 to 6. In some embodiments Q is a C₁-C₁₂ alkyl group and m is 0 or Q is a phenyl, naphthyl, tetrahydronaphthyl, pyridyl, indolyl, quinolinyl, coumarinyl, adamantyl or benzodioxanyl group, Z is —C(═O)— or —S(O)₂— and m is 0 or an integer from 1 to 3. Preferred optional substituents for the aryl, heterocyclyl or heteroaryl group include, but are not limited to, one to three substituents selected from hydroxy, C₁₋₆alkyl, C₁C₆alkoxy, halo, aryl, aryloxy, and nitro, especially hydroxy, methyl, methoxy, fluoro, chloro, bromo, iodo, phenyl, phenoxy and nitro. Examples of suitable N-terminal capping groups include, but are not limited to, 4-hydroxyphenylCO—, 4-hydroxyphenylCH₂CO—, 4-hydroxyphenyl(CH₂)₂CO—, 3-hydroxyphenylCO—, 3-hydroxyphenyl CH₂CO—, 3-hydroxyphenyl(CH₂)₂CO—, 2-hydroxyphenylCO—, 2-hydroxyphenylCH₂CO—, 2-hydroxyphenyl(CH₂)₂CO—, 4-methoxyphenylCO—, 4-methoxyphenylCH₂CO—, 4-methoxyphenyl(CH₂)₂CO—, 3-methoxyphenylCO—, 3-methoxyphenylCH₂CO—, 3-methoxyphenyl(CH₂)₂CO—, 2-methoxyphenylCO—, 2-methoxyphenylCH₂CO—, 2-methoxyphenyl(CH₂)₂CO—, 3,4-dimethoxyphenylCO—, 3,4-dimethoxyphenylCH₂CO—, 3,4-dimethoxyphenyl(CH₂)₂CO—, phenylCO—, phenylCH₂CO—, phenyl(CH₂)₂CO—, phenyl(CH₂)₃CO—, naphthyl-2-CO—, naphthyl-2-CH₂CO—, naphthyl-2-(CH₂)₂CO—, naphthyl-2-(CH₂)₃CO—, 1,2,3,4-tetrahydronaphthyl-2-CO—, 1,2,3,4-tetrahydronaphthyl-2-CH₂CO—, 1,2,3,4-tetrahydronaphthyl-2-(CH₂)₂CO—, 1,2,3,4-tetrahydronaphthyl-2-(CH₂)₃CO—, 4-phenyl-phenylCO—, 4-phenyl-phenylCH₂CO—, 4-phenyl-phenyl(CH₂)₂CO—, 3-phenyl-phenylCO—, 3-phenyl-phenylCH₂CO—, 3-phenyl-phenyl(CH₂)₂CO—, 4-phenoxyphenylCO—, 4-phenoxyphenylCH₂CO—, 4-phenoxyphenyl(CH₂)₂CO—, 3-phenoxyphenylCO—, 3-phenoxyphenylCH₂CO—, 3-phenoxyphenyl(CH₂)₂CO—, 4-halophenylCO—, 4-halophenylCH₂CO—, 4-halophenyl(CH₂)₂CO—, 3-halophenylCO—, 3-halophenylCH₂CO—, 3-halophenyl(CH₂)₂CO—, 2-halophenylCO—, 2-halophenylCH₂CO—, 2-halophenyl(CH₂)₂CO—, 3,4-dihalophenylCO—, 3,4-dihalophenylCH₂CO—, 3,4-dihalophenyl(CH₂)₂CO—, 4-nitrophenylCO—, 4-nitrophenylCH₂CO—, 4-nitrophenyl(CH₂)₂CO—, 3-nitrophenylCO—, 3-nitrophenylCH₂CO—, 3-nitrophenyl(CH₂)₂CO—, 2-nitrophenylCO—, 2-nitrophenylCH₂CO—, 2-nitrophenyl(CH₂)₂CO—, 3-indolylCO—, 3-indolylCH₂CO—, 3-indolyl(CH₂)₂CO—, 3-indolyl(CH₂)₃CO—, N-methyl-indolylCO—, N-methyl-3-indolylCH₂CO—, N-methyl-3-indolyl(CH₂)₂CO—, N-methyl-3-indolyl(CH₂)₃CO—, 4-indolylCO—, 4-indolylCH₂CO—, 4-indolyl(CH₂)₂CO—, 4-indolyl(CH₂)₃CO—, 2-pyridylCO—, 2-pyridylCH₂CO—, 2-pyridyl(CH₂)₂CO—, 2-pyridyl(CH₂)₃CO—, 3-quinolinyl-CO—, 3-quinolinylCH₂CO—, 3-quinolinyl(CH₂)₂CO—, 3-quinolinyl(CH₂)₃CO—, 2-quinolinylCO—, 2-quinolinylCH₂CO—, 2-quinolinyl(CH₂)₂CO—, 2-quinolinyl(CH₂)₃CO—, coumarinCO—, coumarinCH₂CO—, coumarin(CH₂)₂CO—, coumarin(CH₂)₃CO—, adamantylCO—, benzodioxanylCO—, (R or S)-1,4-benzodioxane-2-CO—, CH₃CO—, CH₃CH₂CO—, CH₃CH₂CH₂CO—, CH₃(CH₂)₃CO—, CH₃(CH₂)₄CO—, CH₃(CH₂)₅CO—, CH₃(CH₂)₆CO—, CH₃(CH₂)₇CO—, CH₃(CH₂)₈CO—, CH₃(CH₂)₉CO—, CH₃(CH₂)₁₀CO— and CH₃(CH₂)₁₁CO—.

In another embodiment the N-terminal capping group is a guanyl group [H₂NC(═NH)], or a substituted guanyl group in which one or both of the nitrogen atoms are further independently substituted with C₁₋₆alkyl. For example, suitable substituted guanyl groups include, but are not limited to, CH₃NHC(═NH)—, H₂NC(═NCH₃)— and CH₃NHC(═NCH₃)—.

In another embodiment, the N-terminal capping group may be a group that participates in ring closure to form a cyclic peptide thereby stabilizing the conformation of the peptide. Suitable N-terminal capping groups that may participate in cyclization include:

Y—(CH₂)ₘ—Z—

wherein Z and m are defined above and Y is —SH, —OH, —SeH, —NH₂, —CO₂H, —CH═CH₂, a fluoro, nitro-substituted benzoic acid such as 2-fluoro-5-nitrobenzoyl or 1-fluoro-2,4-dinitrobenzoyl, —N═N═N, —C≡CH or halo. These N-terminal capping groups may then cyclize with the C-terminal carboxylic acid or a functionalized side chain of an amino acid residue in R₁, such as a side chain containing an —SH to form a disulfide bond, a —CO₂H to form a thioester, an ester or an amide bond, a —NH₂ to form an amide bond, a —SeH to form a selenosulfide bond or diseleno bond, an —OH or —SH to form an ether or thioether bond, or an azide or alkyne to form a triazole group. Two —CH═CH₂ groups may react under ring closing metathesis conditions to form a —CH═CH— double or after reduction, single carbon carbon bond.

As used herein, the term “C-terminal capping group” refers to a group covalently bonded to the C-terminal carbon atom or carboxy group. Suitable C-terminal capping groups include C-terminal amides, esters, aldehydes and ketones. For example, suitable C-terminal capping groups include, but are not limited to, —CONH₂, —CONH(alkyl), —CON(alkyl)₂, —CONHphenyl, —CON(phenyl)₂, —CONH(alkylphenyl), —CON(alkyl)(phenyl); —CO₂alkyl, —CO₂-phenyl, —CO₂alkylphenyl, —COH, —COalkyl, —COphenyl, —COalkylphenyl, —COSalkyl and —CONHNH₂, where the “CO” group is derived from the C-terminal carboxylic acid.

As used herein, the term “N-terminal turn inducer” refers to the turn inducer that is closest to the N-terminus of the peptide conjugate. When more than one turn inducer is introduced, one of the turn inducers will be closest to the N-terminus of the peptide conjugate. The N-terminal turn inducer may be the only turn inducer introduced or the last turn inducer to be introduced in the peptide conjugate.

As used herein, the term “α-, β- or γ-position in the ring with respect to the ring nitrogen atom in the 1-position” refers to the carbonyl substituent being on a ring carbon atom attached to the ring nitrogen atom or a ring carbon atom one carbon atom or two carbon atoms removed from the ring nitrogen atom, as shown below:

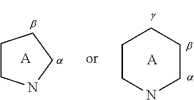

The peptide conjugates of the present invention may be in the form of salts, which are toxicologically safe for systemic or localized administration or suitable for application to a plant or an agricultural, industrial or household environment. Suitable salts may be selected from the group including alkali and alkali earth, ammonium, aluminium, iron, amine, glucosamine, chloride, sulfate, sulfonate, bisulfate, nitrate, citrate, tartrate, bitartrate, phosphate, carbonate, bicarbonate, malate, maleate, napsylate, fumarate, succinate, acetate, benzoate, terephthalate, palmoate, pectinate and S-methyl methionine salts, piperazine and the like.

It will also be recognized that peptide conjugates, the amino acid residues and particularly the turn inducer, of the invention possess asymmetric centres and are therefore capable of existing in more than one stereoisomeric form. The invention thus also relates to compounds in substantially pure isomeric form at one or more asymmetric centres eg., greater than about 90% de, such as about 95% or 97% de or greater than 99% de, as well as mixtures, including racemic mixtures, thereof.

As used herein, the term “conservative substitution” refers to a replacement of an amino acid residue with another amino acid residue or amino acid side chain with generally similar properties such as size, hydrophobicity and/or charge.

As used herein, the term “split and mix” strategy refers to dividing the compartmentalized solid phase supports into a plurality of aliquots and reacting each aliquot with a different moiety, such as different amino acid residues or different turn inducers. The plurality of aliquots may then be mixed before the next reaction. The mixing may be random, such as combining all compartmentalized solid phase supports into one reaction vessel for the next reaction. Alternatively, the mixing may be planned where the compartmentalized solid phase supports are placed in a plurality of reaction vessels and their positions recorded.

As used herein, the term “hydrophobic amino acid residue” refers to an amino acid residue having a hydrophobic side chain. The amino acid residue may be a naturally occurring or common amino acid residue as set out in Table 1 or a non-naturally occurring amino acid residue as set out in Table 2. Examples of hydrophobic amino acid residues include, but are not limited to, L-alanine, L-valine, L-leucine, L-isoleucine, L-proline, L-methionine, L-phenylalanine, L-tryptophan, D-alanine, D-valine, D-leucine, D-isoleucine, D-proline, D-methionine, D-phenylalanine, D-tryptophan, β-homophenylalanine, β-homoisoleucine, β-homoleucine, β-homovaline, β-homomethionine, β-homotyrosine, cyclohexylalanine, norleucine, norvaline, α-methylisoleucine, α-methylleucine, α-methylmethionine, α-methylnorvaline, α-methylphenylalanine, α-methylvaline, α-methyltyrosine, α-methylhomophenylalanine, naphthylalanine and the like.

As used herein, the term “polar, uncharged amino acid residue” refers to an amino acid residue having a polar but uncharged functional group in its side chain. The amino acid residue may be a naturally occurring or common amino acid residue as set out in Table 1 or a non-naturally occurring amino acid residue as set out in Table 2. Examples of polar, uncharged amino acid residues include glycine, L-serine, L-threonine, L-cysteine, L-tyrosine, L-asparagine, L-glutamine, D-serine, D-threonine, D-cysteine, D-tyrosine, D-asparagine, D-glutamine, α-methylserine, α-methylthreonine, α-methylcysteine, α-methyltyrosine, α-methylasparagine, α-methylglutamine, metatyrosine, orthotyrosine, nortyrosine and the like.

As used herein, the term “positively charged amino acid residue” refers to an amino acid residue having a positively charged functional group in its side chain. The amino acid residue may be a naturally occurring or common amino acid residue as set out in Table 1 or a non-naturally occurring amino acid residue as set out in Table 2. Examples of positively charged amino acid residues include L-lysine, L-arginine, L-histidine, L-ornithine, D-lysine, D-arginine, D-histidine, D-ornithine, α-methyllysine, α-methylarginine, α-methylhistidine, α-methylornithine, homolysine, norlysine and the like.

As used herein, the term “negatively charged amino acid residue” refers to an amino acid residue having a negatively charged functional group in its side chain. The amino acid residue may be a naturally occurring or common amino acid residue as set out in Table 1 or a non-naturally occurring amino acid residue as set out in Table 2. Examples of negatively charged amino acid residues include L-glutamic acid, L-aspartic acid, D-glutamic acid, D-aspartic acid, α-methylglutamic acid and α-methylaspartic acid, especially L-glutamic acid and L-aspartic acid.

The terms “selective” and “selectively” as used herein mean that the activity of the peptide conjugate as a modulator of one particular target is considerably greater than any activity of the peptide conjugate at one or more off-targets of particular interest that may or may not belong to the same class. For example, in the case of the selectivity at the neuronal norepinephrine transporter (NET), a modulator is considered selective if its activity at NET is considerably greater than any activity at any of the α1-adrenoceptors or the serotonin transporter (SERT) or the dopamine transporter (DAT). The selectivity of an inhibitor of the neuronal norepinephrine transporter can be measured using techniques known in the art, for example, using appropriate labelled ligand displacement assays.

The term “thiol or selenol bearing amino acid residue” refers to an amino acid residue having a —SH or —SeH in its side chain or attached to its backbone. In particular embodiments, the thiol group or selenol group is present in the amino acid side chain or a further substituent attached at the α-carbon atom or β-carbon of a β-amino acid residue. Examples of thiol and selenol bearing amino acid residues include but are not limited to L-cysteine, D-cysteine, L-homocysteine, D-homocysteine, L-penicillamine, D-penicillamine, L-selenocysteine, D-selenocysteine, 4-mercapto-pyrrolidine-2-carboxylic acid or N-mercaptoalkyl amino acids such as N-mercaptoethyl-glycine, N-mercaptomethyl-alanine, N-mercaptomethyl-threonine, N-mercaptoethyl-serine and N-mercaptopropyl-phenylalanine.

The term “thiol or selenol bearing moiety” refers to a substituent that includes a —SH or —SeH group. The thiol or selenol bearing moiety forms part of an N-terminal capping group or C-terminal capping group. Examples of thiol or selenol bearing moieties include —NH—(CH₂)₁₋₁₀—SH as a C-terminal capping group and —C(O)—(CH₂)₁₋₁₀—SH or 4-mercapto-pyrrolidine-2-carboxylic acid and optionally substituted mercapto-benzoic acids such as 4-mercapto-benzoic acid, 4-mercaptoethyl-benzoic acid, 4-mercapto-2-ethyl-benzoic acid and 3-mercaptoethyl-4-methyl-benzoic acid, as an N-terminal capping group

The term “norepinephrine” as used herein is the same as “noradrenaline”.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

### Combinatorial Libraries of the Invention

The present invention relates to libraries of peptide conjugates comprising two or more different peptide conjugates represented by formula (I):

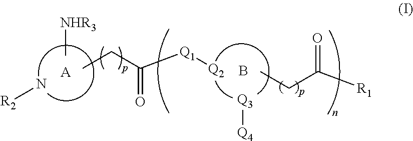

wherein:
A and any B present are independently selected from a 5-7 membered saturated or unsaturated nitrogen-containing heterocyclic ring;
R₁ is an amino acid or a peptide having 2 to 5 amino acid residues, wherein the amino acid or peptide is optionally capped with a C-terminal capping group;
One of R₂ and R₃ is an amino acid or a peptide having 2 to 5 amino acid residues wherein the amino acid or peptide is optionally capped with an N-terminal capping group;
the other of R₂ and R₃ is hydrogen, —C₁₋₁₀alkyl, —C₂₋₁₀alkenyl, —C₂₋₁₀alkynyl, —C₃₋₈ cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
each Q₁ is independently NH or absent;
when Q₁ is NH, Q₂ is C or CH, Q₃ is N and Q₄ is R₄;
when Q₁ is absent, Q₂ is N, Q₃ is C or CH and Q₄ is NHR₄;
each R₄ is independently selected from hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein the carbonyl containing substituents (—(CH₂)ₚCOQ₁) and/or (—(CH₂)ₚCOR₁) are in an α-, β- or γ-position of the A and/or B ring(s) with respect to the A and/or B ring nitrogen atoms;
or a salt thereof.

In some embodiments at least a portion of the peptide conjugates in the library are cyclic as a result of cyclization between a side chain functional group in R₂, R₃ or R₄, the N-terminus or the N-terminal capping group and a side chain functional group in R₁, the C-terminus or C-terminal capping group. For example, a cysteine, homocysteine, penicillamine or selenocysteine residue in R₁ may form a disulfide, diseleno or sulfoseleno bond with a cysteine, homocysteine, penicillamine or selenocysteine residue or a thiol group or selenol group in the N-terminal capping group in R₂ or R₃. Cyclization may also occur between an amino acid side chain bearing an amino group and a side chain bearing a carboxy group to form an amide, or an amino acid side chain bearing a hydroxy or thiol and an amino acid side chain bearing a carboxy group to form an ester or thioester. Cyclization may also occur between two of an amino acid side chain, a N-terminal capping group or a C-terminal capping group bearing a vicinal double bond by ring closing metathesis to form a carbon carbon double bond or after reduction, a carbon carbon single bond. Cyclization may also occur between an N-terminal capping group, a C-terminal capping group or an amino acid side chain that bears a haloalkyl group and a free thiol group or hydroxy group on a corresponding N-terminal capping group, C-terminal capping group or an amino acid side chain to form a thioether or ether respectively. If the N-terminal capping group is 1-fluoro-2,4-dinitro-6-benzoyl or 2-fluoro-5-nitrobenzoyl, and the C-terminal capping group or a corresponding amino acid side chain in R₁ bears a hydroxy, thiol or amino group, cyclization may occur to form an ether, thioether or cyclic amine respectively by nucleophilic substitution of fluorine. Cyclization may also occur between an azide (N═N═N—) in a side chain or N-terminal or C-terminal capping group and a terminal alkyne in a corresponding side chain or N-terminal or C-terminal capping group using a Cu(I) catalyst (Click Chemistry) to form a cyclic peptide that is cyclized through 1,2,3-triazole group. A further option is to cyclize two free thiol groups with an intervening alkylene linker such as —CH₂— to form a —S—CH₂—S— group.

In a particular embodiment, the peptide conjugates are cyclic as a result of disulfide, diseleno or sulfoseleno bond formation between a thiol or selonol bearing amino acid residue in R₁ or a thiol or selenol bearing moiety in the C-terminal capping group and a thiol or selenol bearing amino acid residue in R₂ or R₃, or a thiol or selenol bearing moiety in the N-terminal capping group, especially a disulfide or diseleno or sulfoseleno bond between a cysteine, homocysteine, penicillamine or selenocysteine residue in R₁ and a cysteine, homocysteine, penicillamine or selenocysteine residue in R₂ or R₃, more especially a disulfide bond between a cysteine residue in R₁ and a cysteine residue in R₂ or R₃.

In preferred embodiments, the C-terminal capping group is —CON(R)₂ wherein each R is independently selected from hydrogen or C₁-C₆ alkyl. Examples include, but are not limited to, —CONH₂, —CONHCH₃ or —CON(CH₃)₂, especially —CONH₂.

In some embodiments, at least some of the peptide conjugates of formula (I) in the library are peptide conjugates of formula (IA):

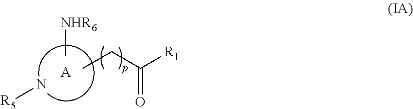

wherein:
A is a 5-7 membered saturated or unsaturated nitrogen-containing heterocyclic ring;
R₁ is an amino acid or a peptide having 2 to 5 amino acid residues, wherein the amino acid or peptide is optionally capped with a C-terminal capping group;
one of R₂ and R₃ is an amino acid or a peptide having 2 to 5 amino acid residues wherein the amino acid or peptide is optionally capped with an N-terminal capping group;
the other of R₂ and R₃ is hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl; and
p is 0 or 1;
wherein the carbonyl containing substituent (—(CH₂)ₚCOR₁) is in an α-, β- or γ-position of the ring with respect to the ring nitrogen atom;
or a salt thereof.

In some embodiments all of the peptide conjugates in the library are peptide conjugates of formula (IA). In some embodiments at least some of the peptide conjugates of formula (IA) are cyclized.

In particular embodiments of the peptide conjugates of formulae (I) or (IA) at least one of the following applies:

A is a 5 or 6-membered saturated or unsaturated nitrogen-containing ring, especially a 5- or 6-membered saturated nitrogen-containing ring, more especially a pyrrolidine ring or piperidine ring, most especially a pyrrolidine ring;

B is a 5 or 6-membered saturated or unsaturated nitrogen-containing ring, especially a 5- or 6-membered saturated nitrogen-containing ring, more especially a pyrrolidine ring or piperidine ring, most especially a pyrrolidine ring;

A and/or B is a 5-membered saturated or unsaturated nitrogen-containing ring and the carbonyl containing substituents (—(CH₂)ₚCOQ₁) and/or (—(CH₂)ₚCOR₁) are in the α- or β-position of the A and/or B ring(s) with respect to the A and/or B ring nitrogen atoms; especially the α-position;

A and/or B is a 6-membered saturated or unsaturated nitrogen-containing ring and the carbonyl containing substituents (—(CH₂)ₚCOQ₁) and/or (—(CH₂)ₚCOR₁) are in the α-, or γ-position of the A and/or B ring(s) with respect to the A and/or B ring nitrogen atoms; especially the γ-position;

The amino substituent —NHR₃ may be attached to the ring at any carbon atom. When the A or B ring is a 5-membered ring, the —NHR₃ substituent may be attached to the ring at the 3-, 4- or 5-position with respect to the ring nitrogen atom, especially the 4-position. When the A or B ring is a 6-membered ring, the —NHR₃ substituent may be attached to the ring at the 2-, 3-, 4-, 5- or 6-position; especially the 4-position;

n is 0 or 1, especially 0;
p is 0;
R₁ is an amino acid residue or a peptide having 2 to 3 amino acid residues optionally capped with an amide, especially where one of the amino acid residues, more especially the 2nd amino acid residue with respect to Ring A or Ring B, is linked to a side chain or an amino acid residue on R₂ or R₃ and is especially a cysteine, homocysteine, penicillamine or selenocysteine residue, more especially a cysteine residue;
R₂ is an amino acid residue or a peptide having 2 to 3 amino acid residues, especially where one of the amino acid residues, especially the 2nd amino acid residue with respect to Ring A, is linked to a side chain or an amino acid residue on R₁ and is especially a cysteine, homocysteine, penicillamine or selenocysteine residue, more especially a cysteine residue, and R₃ is hydrogen or an acyl group, especially an acyl group. This arrangement is a mimetic of a β-turn:

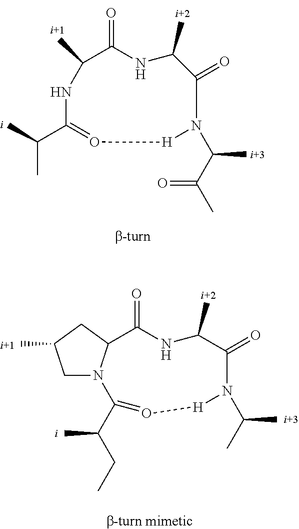

R₃ is an amino acid residue or a peptide having 2 to 3 amino acid residues, where one of the amino acid residues, especially the 2nd amino acid residue with respect to Ring A, is linked to a side chain of an amino acid residue in R₁ and is especially a cysteine, homocysteine, penicillamine or selenocysteine residue, more especially a cysteine residue, and R₂ is hydrogen or an acyl group, especially an acyl group. This arrangement is a mimetic of a γ-turn:

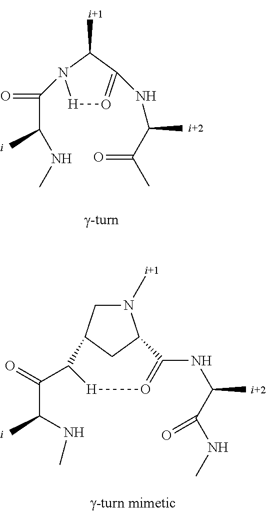

R₁ is attached to the ring via the carbonyl containing group (R₁CO(CH₂)ₚ—) in the α-position relative to the ring nitrogen;
R₂ or R₃ is an acyl group that mimics an amino acid side chain and is selected from —(C═O)R where R is —C₁₋₆alkyl, —C₀₋₆alkylcycloalkyl, —C₁₋₆alkylNRₐC(═NRₐ)N(Rₐ)₂, —C₁₋₆alkylCON(Rₐ)₂, —C₁₋₆alkylCO₂Rₐ, —C₁₋₆alkylSRₐ, —C₀₋₆alkyl(heterocyclyl), —C₀₋₆alkyl(heteroaryl), C₁₋₆alkylN(Rₐ)₂, —C₁₋₆alkylSC₁₋₆alkyl, —C₀₋₆alkylaryl and —C₁₋₆alkylORₐ, wherein each Rₐ is independently selected from hydrogen, —C₁₋₆alkyl, cycloalkyl, aryl, heterocyclyl and heteroaryl, especially hydrogen, and wherein each alkyl, aryl, heterocyclyl or heteroaryl group may be optionally substituted with —C₁₋₃alkyl, —OH, —NH₂ or -oxo (═O), especially where R is —C₁₋₄alkyl, —C₀₋₃alkylcycloalkyl, —C₂₋₄alkylNHC(═NH)NH₂, —C₁₋₂alkylCONH₂, —C₁₋₃alkylCO₂H, —C₁₋₃SH, —C₀₋₃alkylheterocyclyl, —C₀₋₃alkylheteroaryl, —C₀₋₃alkylaryl, —C₁₋₅alkylNH₂, —C₁₋₃alkylSC₁₋₃alkyl, and —C₁₋₃alkylOH, wherein each alkyl, aryl, heterocyclyl or heteroaryl group may be optionally substituted with —C₁₋₃alkyl, —OH, —NH₂ or -oxo (═O). Exemplary acyl groups include but are not limited to:

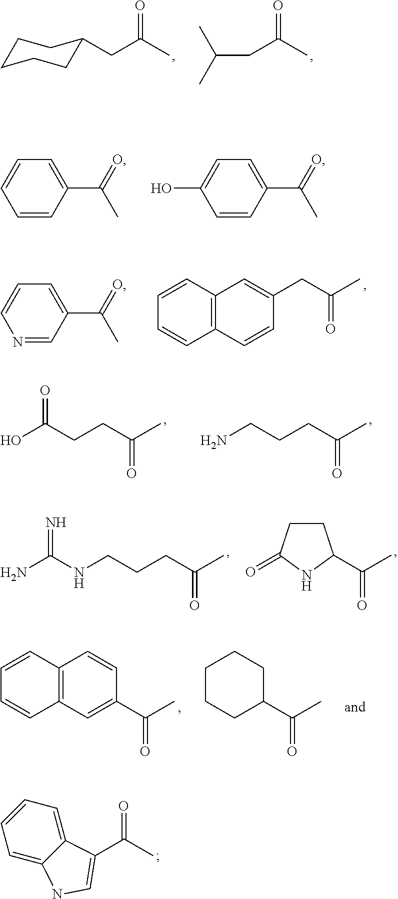

and
R₄ is an acyl group that mimics an amino acid side chain and is selected from —(C═O)R where R is —C₁₋₆alkyl, —C₀₋₆alkylcycloalkyl, —C₁₋₆alkylNRₐC(═NRₐ)N(Rₐ)₂, —C₁₋₆alkylCON(Rₐ)₂, —C₁₋₆alkylCO₂Rₐ, —C₁₋₆alkylSRₐ, —C₀₋₆alkyl(heterocyclyl), —C₀₋₆alkyl(heteroaryl), —C₁₋₆alkylN(Rₐ)₂, —C₁₋₆alkylSC₁₋₆alkyl, —C₀₋₆alkylaryl and —C₁₋₆alkylORₐ, wherein each Rₐ is independently selected from hydrogen, —C₁₋₆alkyl, cycloalkyl, aryl, heterocyclyl and heteroaryl, especially hydrogen, and wherein each alkyl, aryl, heterocyclyl or heteroaryl group may be optionally substituted with —C₁₋₃alkyl, —OH, —NH₂ or -oxo (═O), especially where R is —C₁₋₄alkyl, —C₀₋₃alkylcycloalkyl, —C₂₋₄alkylNHC(═NH)NH₂, —C₁₋₂alkylCONH₂, —C₁₋₃alkylCO₂H, —C₁₋₃SH, —C₀₋₃alkylheterocyclyl, —C₀₋₃alkylheteroaryl, —C₀₋₃alkylaryl, —C₁₋₅alkylNH₂, —C₁₋₃alkylSC₁₋₃alkyl, and —C₁₋₃alkylOH, wherein each alkyl, aryl, heterocyclyl or heteroaryl group may be optionally substituted with —C₁₋₃alkyl, —OH, —NH₂ or -oxo (═O). Exemplary acyl groups include but are not limited to:

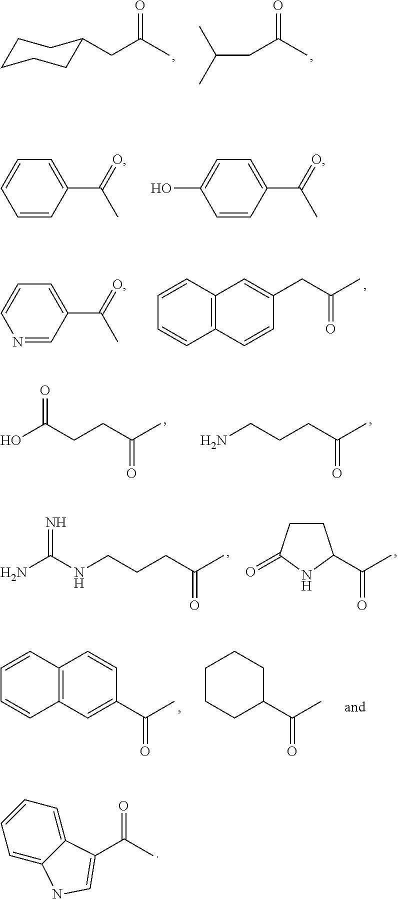

In some embodiments, the library contains two or more peptide conjugates represented by formula III and/or formula IV and/or formula IIIa and/or formula IVa:

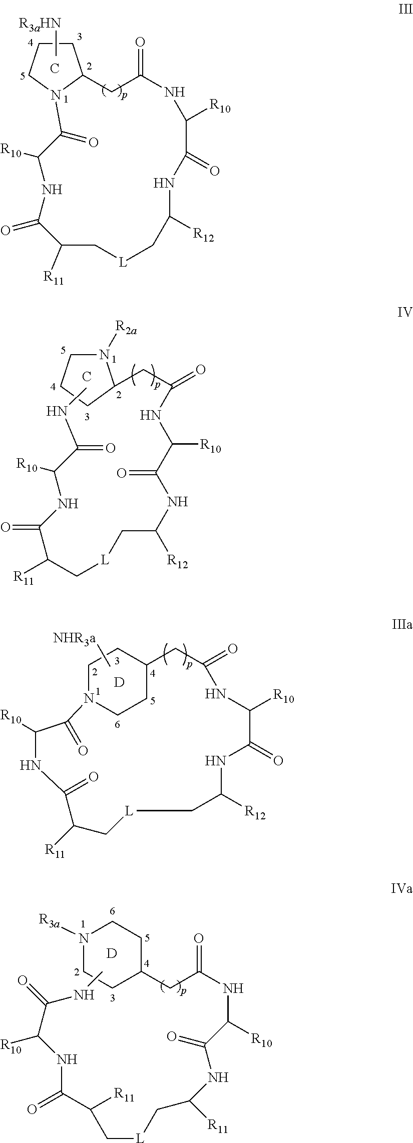

wherein
R₂ₐ and R₃ₐ are hydrogen, acyl, sulfonyl or —C₁₋₆alkyl;
Each R₁₀ is independently selected from an amino acid side chain;
R₁₁ is absent or is NHR₁₃ where R₁₃ is hydrogen, an N-terminal capping group or an amino acid residue or peptide having 2 or 3 amino acid residues optionally capped with an N-terminal capping group;
R₁₂ is absent or is C(O)R₁₄ where R₁₄ is —OH or —NH₂; and
L is a linker that forms a cyclic peptide;

### P is 0 or 1;

or a salt thereof.

In some embodiments, at least one of the following applies:

Ring C is a 4-amino-substituted pyrrolidinyl ring, especially 2S,4S-4-aminopyrrolidinyl or 2S,4R-4-aminopyrrolidinyl ring;
Ring D is a 4-amino-substituted piperidinyl ring;
R₂ₐ and R₃ₐ are hydrogen or an acyl group that mimics an amino acid side chain and is selected from —(C═O)R where R is —C₁₋₆alkyl, —CO₀₋₆ alkyl cycloalkyl, —C₀₋₆alkylNRₐC(═NRₐ)N(Rₐ)₂, —C₁₋₆alkylCON(Rₐ)₂, —C₁₋₆alkylCO₂Rₐ, —C₀₋₆alkylSRₐ, —C₀₋₆alkyl(heterocyclyl), —C₀₋₆alkyl(heteroaryl), —C₀₋₆alkylN(Rₐ)₂, —C₀₋₆alkylSC₁₋₆alkyl, —C₀₋₆alkylaryl and —C₀₋₆alkylORₐ, wherein each Rₐ is independently selected from hydrogen, —C1-6alkyl, cycloalkyl, aryl, heterocyclyl and heteroaryl and wherein each aryl, heterocyclyl or heteroaryl group may be optionally substituted with —C₁₋₃alkyl, —OH, —NH₂ or -oxo (═O), especially where R is —C₁₋₄alkyl, —C₀₋₃alkylcycloalkyl, —C₂₋₄alkylNHC(═NH)NH₂, —C₁₋₂alkylCONH₂, —C₁₋₃alkylCO₂H, —C₁₋₃SH, —C₀₋₃alkylheterocyclyl, —C₀₋₃alkylheteroaryl, —C₀₋₃alkylaryl, —C₁₋₅alkylNH₂, —C₁₋₃alkylSC₁₋₃alkyl, and —C₁₋₃alkylOH, wherein each aryl, heterocyclyl or heteroaryl group may be optionally substituted with —C₁₋₃alkyl, —OH, —NH₂ or -oxo (═O). Exemplary acyl groups include but are not limited to:

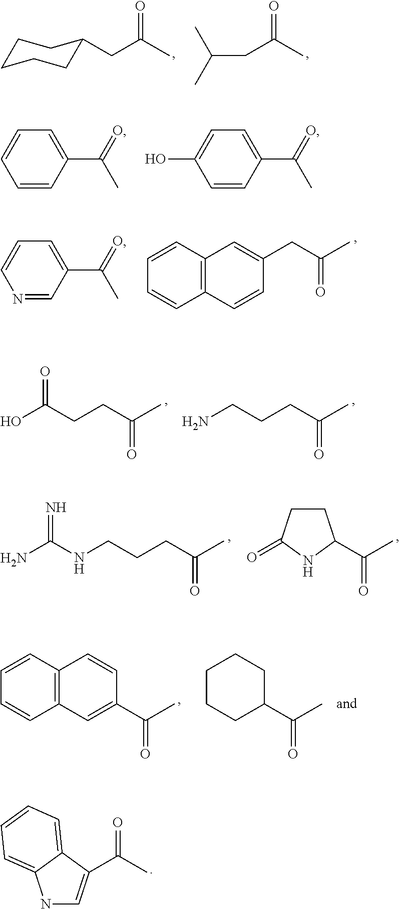

Each R₁₀ is independently selected from a side chain of a natural amino acid, especially hydrogen, —CH₃, —(CH₂)₃NHC(═NH)NH₂, —CH₂CONH, —CH₂CO₂H, —CH₂SH, —(CH₂)₂CONH₂, —(CH₂)₂CO₂H, —H, —CH₂(4-imidazolyl), —CH(CH₃)CH₂CH₃, —CH₂CH(CH₃)₂, —(CH₂)₄NH₂, —(CH₂)₂SCH₃, —CH₂-Phenyl, —CH₂OH, —CH(CH₃)OH, —CH₂(4-hydroxyphenyl), —CH(CH₃)₂ and —CH₂-3-indolyl;

R₁₁ is NHR₁₃ where R₁₃ is hydrogen or an N-terminal capping group, especially hydrogen or —C(═NH)NH₂;
R₁₂ is C(O)R₁₄ where R₁₄ is —OH or a C-terminal capping group, especially —NH₂ thereby forming an amide at the C-terminal;
p is 0;
L is a linker selected from —S—S—, —Se—Se—, —Se—S—, —S—Se—, —C(O)NH—, —NHC(O)—, —OC(O)—, —C(O)O—, —O—, —NH—, —S—, —CH═CH—, —CH₂—CH₂—, —S—(CH₂)ᵣ—S— where r is 1 to 3, or

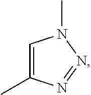

especially —S—S—, —S—CH₂—S—, —Se—Se—, —Se—S— or —S—Se—, more especially —S—S—.

### Focussed Libraries

In some embodiments, the library of peptide conjugates is designed for binding to a particular target such as a receptor or enzyme. Design of this type of library is not random but the amino acid residues of R₁ and R₂ or R₃ and the substituent, acyl or sulfonyl group of R₂ or R₃ and R₄ are selected based at least in part on the known structure of a bioactive peptide or the known structure activity relationships (SAR) of a specific receptor or enzyme and its natural bioactive peptide or protein substrate (Ligand Based Design).

Focussed libraries may also be used to optimize the binding, activity, stability and ADMET (adsorption, distribution, metabolism, elimination and toxicology) properties of a peptide or peptide conjugate identified as a hit while using a library of the present invention or another library.

Focussed libraries may be developed for a desired target receptor or enzyme. Suitable targets may be selected on the basis that they have been proven to be accessible to peptide conjugates, that they have ligands where SAR demonstrates that the presence of a turn element is important for activity, in some embodiments, the target may be known to have ligands that are cyclic peptides, or that the target is of potential therapeutic value.

Accordingly in one aspect of the invention there is provided a method of preparing a focussed peptide conjugate library, said method comprising the steps of:
i) identifying a bioactive turn-containing peptide and its target receptor or enzyme of interest;
ii) identifying amino acid residues around the turn in the bioactive peptide;
iii) preparing a focussed library comprising two or more peptide conjugates of formula (V)

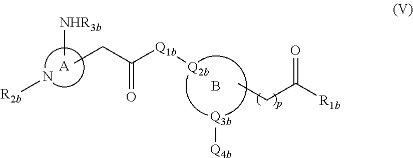

wherein A and any B present are independently selected from a 5-7 membered saturated or unsaturated nitrogen-containing heterocyclic ring;
R_{1b} is an amino acid residue or a peptide of 2 to 5 residues wherein the amino acid residue or peptide is optionally capped with a C-terminal capping group;
one of R_{2b} and R_{3b} is hydrogen, a substituent selected from a substituent selected from —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
the other of R_{2b} and R_{3b} is an amino acid residue or a peptide of 2 to 5 amino acid residues,
wherein the amino acid or peptide is optionally capped with an N-terminal capping group;
each Q_{1b} is independently NH or absent;
when Q_{1b} is NH, Q_{2b} is C or CH, Q_{3b} is N and Q_{4b} is R_{4b};
when Q_{1b} is absent, Q_{2b} is N, Q_{3b} is C or CH and Q_{4b} is NHR_{4b};
each R_{4b} is independently selected from hydrogen, a substituent selected from a substituent selected from —C₁₋₁₀alkyl, —C₂₋₁₀alkenyl, —C₂₋₁₀alkynyl, —C₃₋₈cycloalkyl, —CO₀₋₆ alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group;
wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein at least one amino acid residue of R_{1b}, R_{2b} or R_{3b} is an amino acid residue that forms part of the peptide-turn in the bioactive turn-containing peptide or an amino acid residue that is a conservative substitution thereof, and/or at least one of R_{2b} or R_{3b} and R_{4b} is a substituent, acyl group or sulfonyl group that mimics the side chain of an amino acid residue that forms part of the peptide-turn in the bioactive turn-containing peptide or a conservative substitution thereof; and
wherein the carbonyl containing substituents (—(CH₂)ₚCOQ_{1b}) and/or (—(CH₂)ₚCOR_{1b}) are in an α-, β- or γ-position of the A and/or B rings with respect to the A and/or B ring nitrogen atoms; or a salt thereof.

In some embodiments where R_{1b} or R_{2b} or R_{3b} are a peptide of 2 to 5 amino acid residues, one or more of the 2 to 5 amino acid residues in either R_{1b} or R_{2b} or R_{3b} are selected to be the same as the amino acid residues in the corresponding sequence of the bioactive peptide or protein of interest or a conservative substitution thereof.

In some embodiments at least a portion of R_{1b} and R_{2b} or R_{3b} are a peptide of 2 to 5 amino acid residues where the peptides are linked to form a cyclic peptide.

In some embodiments, the peptide conjugates of formula (V) are peptide conjugates of formula (VA):

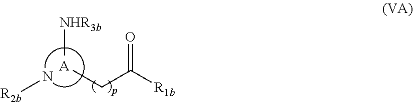

wherein A is a 5-7 membered saturated or unsaturated nitrogen-containing heterocyclic ring;
R_{1b} is an amino acid residue or a peptide of 2 to 5 residues wherein the amino acid or peptide is optionally capped with a C-terminal capping group;
one of R_{2b} and R_{3b} is hydrogen, a substituent selected from —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆ alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆ alkylNRₐSO₂Rₐ, —C₁₋₆ alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
the other of R_{2b} and R_{3b} is an amino acid or a peptide of 2 to 5 residues wherein the amino acid or peptide is optionally capped with an N-terminal capping group;
p is 0 or 1;
wherein at least one amino acid residue of R_{1b}, R_{2b} or R_{3b} is an amino acid residue that forms part of the peptide-turn in the bioactive turn-containing peptide or an amino acid residue that is a conservative substitution thereof, and/or R_{2b} or R_{3b} is a substituent, acyl group or sulfonyl group that mimics the side chain of an amino acid residue that forms part of the peptide-turn in the bioactive turn-containing peptide or a conservative substitution thereof; and
wherein the carbonyl containing substituent (—(CH₂)ₚCOR_{1b}) is in an α-, β- or γ-position of the ring with respect to the ring nitrogen atom; or a salt thereof.

Examples of suitable bioactive peptides and receptors that may be used to build a focussed library include Xen2174 and its receptor human norepinephrine transporter (hNET), somatostatin and somatostatin receptors (SSTRs), α-melanocortin and melanocortin receptors, human anaphylatoxin C5a and the C5a receptor, tachykinins and tachykinin receptors, natriuretic peptides and natriuretic receptors, angiotensin II and angiotensin receptors AT1 and AT2, growth hormone secretagogues (GHS) such as ghrelin and GHS receptors, endothelin, bradykinin and the bradykinine receptor, galanin and galanin receptors, ω-conotoxins and voltage-sensitive calcium channels, mu-conotoxins and voltage-sensitive sodium channels, integrin and integrin receptors, endomorphins and mu opioid receptors, dynorphin and kappa opioid receptors, endorphin and delta opioid receptors, orphanin and ORL-1 and the like.

The peptide conjugate libraries may be designed to interact with specific targets such as the following exemplary ion channels, GPCRs, transporters, enzymes, kinases and proteases:

### Ion Channels

Acid-Sensing (proton-gated) Ion Channels (ASICs), sodium channels, potassium channels, calcium channels, chloride channels, cyclic nucleotide-gated channels, hyperpolarisation activated cyclic nucleotide-gated channels, sigma receptors, transient receptor potential channels (ankyrin, canonical, melastatin, vanilloid), ligand gated ion channels (nicotinic acetylcholine receptors), NMDA, glutamate receptors and organic anion transporters.

### GPCRs and Other Receptors

Angiotension receptors, bombesin receptors, bradykinin receptors, calcitonin gene-related receptors, chemokine receptors, cholycystokinin and gastrin receptors, cytokine receptors, endothelin receptors, galanin receptors, ghrelin receptor, glucagon and glucagon-like receptors, glucocorticoid receptors, glycine receptors, granulocyte colony-stimulating factor receptor, growth hormone receptor, growth hormone releasing hormone receptor, guanylate cyclase-C receptor, melanocortin-concentrating hormone receptors, melanocortin receptors, nueopeptidases, Neuropeptide Y receptors, neurotensin receptors, opioid receptors, orexin receptors, proteinase-activated receptors, somatostatin receptors, tachykinin or neurokinin receptors, vasoactive intestinal peptide receptors, vasopressin and oxytocin receptors, acetylcholine receptors (muscarinic), adenosine receptors (A₁, A_{2A}, A_{2B}, A₃), adrenoreceptors (α1, α2 and β), cannabinoid receptors, dopamine receptors, GABA receptors (A, B and C), glutamate receptors (ion channel and GPCR), glycine receptor, histamine receptors, selectins, leukotriene receptors, lysophospholipid receptors, melatonin receptors, P2 receptors (P2X and P2Y), prostanoid receptors, serotonin receptors, prinergic receptors, parathyroid and parathyroid hormone-like receptors, Peroxisome proliferators-activated receptors, 5-hydroxytryptamine receptors, activin receptors, C5a receptors, amylin receptor, aldosterone receptors, androgen receptors, bone morphogenic protein (BMP) and BMP receptors, growth differentiation factor (GDF) and GDF receptors, epidermal growth factors (EGF) and EGF receptors, colony stimulating factors, estrogen receptors, corticotropin releasing factor, fibroblast growth factor receptors, folate receptors, histamine receptors, immunoglobulin receptors, insulin-like growth factors, insulin receptors, interferon receptors, interleukins and interleukin receptors.

### Transporters

Biogenic amine transporters (dopamine, norepinephrine, serotonin and vesicular monoamine transporters), excitatory amino acid transporters (EAAT1-EEAT5; VGLUT1-VGLUT3), GABA transporters (GAT-1-GAT-3; BGT-1, VGAT), glycine transporters (GLYT-1, GLYT-2), glucose transporters, rhinovirus proteases, leukotriene receptors, metabotropic glutamate receptors, muscarinic receptors, natriuretic peptide receptors, neurokinin receptors, progesterone receptors, prostaglandin receptors, retinoic acid receptors, toll like receptors, transforming growth factor receptors and tumor necrosis factor receptors.

### Enzymes, Kinases and Other Proteases

Abl, AMPKs, Ca/CaMKs, CDKs, Csk, EGFR, Eph, Fak, FGFR, GRKs, GSK-3, InsR, JAKs, MAPKAPs, MAPKKKs, MAPKs, Met, NEKs, PDGFR, B-RAF kinases, BCL kinase, C-Jun kinases, aurora kinases, PKA & PKG, PKB/Akt, PKC, Ret, Src, STE20, Syk, Tec, Tie, Trk & VEGFR, lipooxygenases, acetylcholinesterase, aldehyde dehydrogenases, alcohol dehydrogenases, aldose reductases, β-lactamases, tubulins, carbonic anhydrases, carmite palmitoyltransferases, collegenases, cytochrome Ps, serine proteases (including elastase, trypsin, chymotrypsin), factors II-XII, HCV protease, HIV, β-secretase, γ-secretase, heat shock proteins, SARs proteases, telomerase, thrombin, thyroid peroxidases, adenylyl cyclases, caspases, G proteins, GTP binding proteins, InsP₃/Ryanodine receptors, nitric oxide synthases, nuclear receptors (non-steroids, PPARs, steroids), PAF receptor, phosphodiesterases, phospholipases (C, A₂, D), phosphoprotein phosphatases, (serine/threonine, tyrosine), protein prenyltransferases, histone deacetylases, HIV proteases, plasminogen activators, platelet-activating factors, HPV proteins, IMPDH, inducible nitric oxide synthases, ICAMs, lipases, MMPs, neuromimidases, Nuclear factor-kappa B, ornithine decarboxylase, ubiquitins and urokinases.

Using the above targets and bioactive peptides, libraries of potential therapeutic candidates can be developed for treating a vast number of conditions or diseases that the receptors or targets are associated with. Such conditions or diseases include, but are not limited to pain; angiogenesis related disorders such as tumors, age-related macular degeneration and diabetic retinopathy; inflammatory disorders such as rheumatoid arthritis; pigmentation disorders; metabolic disorders including obesity; sexual function disorders; cardiovascular disorders; dermatological disorders; hypertension; vasospastic disorders; angiodema and capillary Leak Syndrome.

### Methods of Making the Peptide Libraries

The present invention also relates to methods of preparing a library of peptide conjugates comprising the steps of:
i) preparing a first peptide attached to a compartmentalized solid phase support through a safety catch linker,
ii) introducing a turn inducer represented by the formula (II)

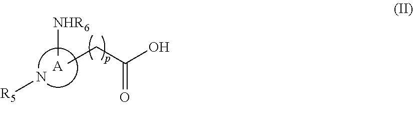

wherein A is a 5-7 membered saturated or unsaturated nitrogen-containing heterocyclic ring, p is 0 or 1; R₅ and R₆ are independently orthogonal amino protecting groups wherein at least one protecting group is stable under conditions used to deprotect the other amino protecting group, wherein the carboxylic acid or acetyl substituent is in the α-, β- or γ-position of the ring with respect to the ring nitrogen atom;
iii) deprotecting one of the amino protecting groups R₅ or R₆ on the N-terminal turn inducer;
iv) optionally repeating steps ii) and iii) one or two more times;
v) introducing a second peptide at the free amino group of the N-terminal turn inducer; deprotecting the remaining turn inducer protecting group(s), R₅ or one to three R₆s, the N-terminal protecting group and side chain protecting groups; and
vii) cleaving the peptide conjugates from the compartmentalized solid support and linker;
   wherein the first peptide and second peptide independently comprise 1 to 5 amino acid residues; and
   wherein at least one of preparing the first peptide, introducing the turn inducer(s) and introducing the amino acids of the second peptide involves a split and mix strategy to introduce variation into the amino acid sequence or turn inducer(s) of the peptide conjugate.

In some embodiments, where a single turn inducer is introduced (step ii) is performed once), the method further comprises introducing a substituent such as an optionally substituted alkyl group, an alkenyl group, an alkynyl group, a cycloalkyl group, a heterocyclyl group, an aryl group, a heteroaryl group, an acyl group or a sulfonyl group at the remaining amino group of the turn inducer after deprotection of its remaining protecting group but before deprotection of the N-terminal protecting group and the side chain protecting groups in step vi).

In some embodiments, where a single turn inducer is introduced, at least a portion of the peptide conjugates do not have further substitution on the turn inducer remaining amino group. In this case, deprotection of the remaining amino group of the turn inducer may be achieved together with the deprotection of other protecting groups such as N-terminal or side chain protecting groups or may be achieved sequentially in deprotection step vi).

In some embodiments, where two or three turn inducers are introduced, each of the remaining R₅ or R₆ of the non-N-terminal turn inducers are protecting groups that may be selectively deprotected in the presence of other R₅ and/or R₆ groups and side chain protecting groups to provide a free amino group. Each free amino group is then optionally substituted. In some embodiments, at least a portion of one or more of the free amino groups are left unsubstituted.

The free amino group of any or all of the turn inducers may be optionally substituted with an alkyl group, cycloalkyl group, aryl group, heteroaryl group, heterocyclyl group or a substituted alkyl group. The substitution may be achieved by methods known in the art such as reaction of the free amino group with an aldehyde (RC(O)H) to form an imine followed by reduction of the imine to form the substituted amino group on the turn inducer. Suitable substituents include —C₁₋₁₀alkyl, —C₂₋₁₀alkenyl, —C₂₋₁₀alkynyl, —C₃₋₈ cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, or —C₁₋₆alkylOPO₃Rₐ wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SHOR—SC₁₋₆alkyl.

The free amino group of any or all of the turn inducers may be optionally acylated with a carboxy containing compound to provide an N-acylated turn inducer within the peptide. This coupling may also be achieved using peptide coupling conditions of activation and amide formation as described herein.

Suitable carboxylic acids include R_{b}—CO₂H where R_{b} is —C₁₋₆alkyl, —C₂₋₆alkenyl, —C₁₋₆alkynyl, —C₀₋₆alkylcycloalkyl, —C₀₋₆alkylcycloalkenyl, —C₁₋₆alkylNRₐC(═NRₐ)N(Rₐ)₂, —C₁₋₆alkylCON(Rₐ)₂—C₁₋₆alkylCO₂Rₐ, —C₁₋₆alkylSRₐ, —C₀₋₆alkyl(heterocyclyl), —CO₀₋₆ alkyl(heteroaryl), —C₁₋₆ alkylN(Rₐ)₂, —C₁₋₆alkylSC₁₋₆alkyl, —C₀₋₆alkylaryl, —C₁₋₆alkylORₐ, —C₁₋₆alkylNSO₂Rₐ, —C₁₋₆alkylSO₃Rₐ and —C₁₋₆alkylOPO₃Rₐ wherein each Rₐ is independently selected from hydrogen, —C₁₋₆alkyl, cycloalkyl, aryl, heterocyclyl and heteroaryl, and wherein each alkyl, alkenyl, alkynyl, cycloalkyl, cycloalkenyl, aryl, heterocyclyl or heteroaryl group may be optionally substituted with —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl, especially where R_{b} is —C₁₋₄alkyl, —C₀₋₃alkylcycloalkyl, —C₂₋₄alkylNHC(═NH)NH₂, —C₁₋₂alkylCONH₂, —C₁₋₃alkylCO₂H, —C₁₋₃alkylSH, —C₀₋₃alkylheterocyclyl, —C₀₋₃alkylheteroaryl, —CO₀₋₃alkylaryl, —C₁₋₅alkylNH₂, —C₁₋₃alkylSC₁₋₃alkyl, and —C₁₋₃alkylOH, wherein each aryl, heterocyclyl or heteroaryl group may be optionally substituted with —C₁₋₃alkyl, —OH, —NH₂ or -oxo (═O). Exemplary carboxylic acids include

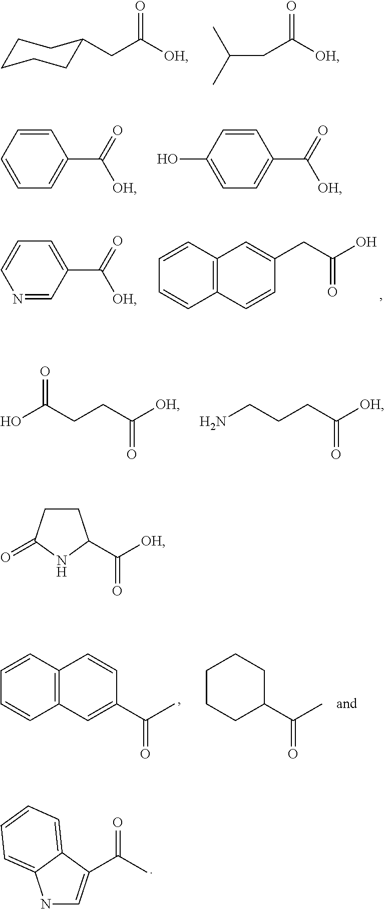

The free amino group may be optionally substituted with a sulfonyl group to provide a sulfonamide substituted turn inducer in the peptide. The sulfonamide may be prepared by methods known in the art, for example, the free amino group may be reacted with an appropriate sulfonylchloride reactant. Suitable sulfonyl groups include —SO₂R_{b} where R_{b} is —C₁₋₆alkyl, —C₂₋₆alkenyl, —C₁₋₆alkynyl, —C₀₋₆alkylcycloalkyl, —C₀₋₆alkylcycloalkenyl, —C₁₋₆alkylNRₐC(═NRₐ)N(Rₐ)₂, —C₁₋₆ alkylCON(Rₐ)₂—C₁₋₆alkylCO₂Rₐ, —C₁₋₆alkylSRₐ, —C₀₋₆alkyl(heterocyclyl), —CO₀₋₆ alkyl(heteroaryl), —C₁₋₆alkylN(Rₐ)₂, —C₁₋₆alkylSC₁₋₆alkyl, —C₀₋₆alkylaryl, —C₁₋₆alkylORₐ, —C₁₋₆alkylNSO₂Rₐ, —C₁₋₆alkylSO₃Rₐ and —C₁₋₆alkylOPO₃Rₐ wherein each Rₐ is independently selected from hydrogen, —C₁₋₆alkyl, cycloalkyl, aryl, heterocyclyl and heteroaryl, and wherein each alkyl, alkenyl, alkynyl, cycloalkyl, cycloalkenyl, aryl, heterocyclyl or heteroaryl group may be optionally substituted with —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl, especially where R_{b} is —C₁₋₄alkyl, —C₀₋₃alkylcycloalkyl, —C₂₋₄alkylNHC(═NH)NH₂, —C₁₋₂alkylCONH₂, —C₁₋₃alkylCO₂H, —C₁₋₃alkylSH, —C₀₋₃alkylheterocyclyl, —C₀₋₃alkylheteroaryl, —C₀₋₃alkylaryl, —C₁₋₅alkylNH₂, —C₁₋₃alkylSC₁₋₃alkyl, and —C₁₋₃alkylOH, wherein each aryl, heterocyclyl or heteroaryl group may be optionally substituted with —C₁₋₃alkyl, —OH, —NH₂ or -oxo (═O). Exemplary sulfonyl groups include

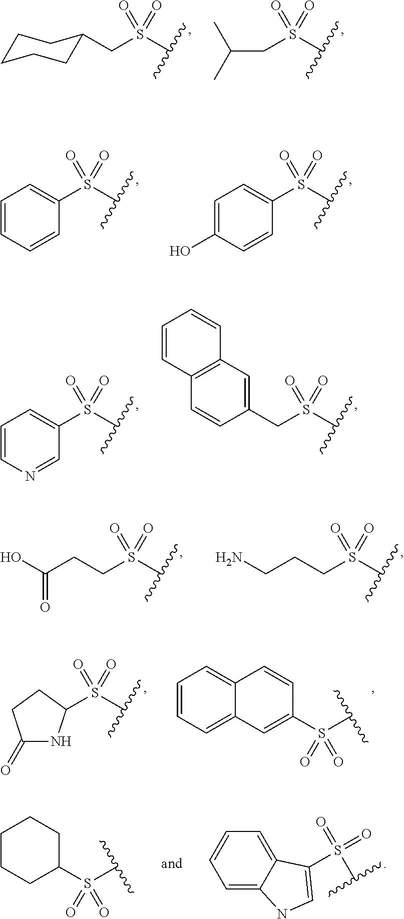

In some cases, the substituent or the R_{b} group of the carboxylic acid or sulfonyl group may have functional groups, other than the required carboxylic acid or sulfonyl group, protected. In some cases, the substituent or the R_{b} groups of the carboxylic acid or sulfonyl group may be further elaborated after the introduction. For example, additional carboxylic acid functional groups in the substituent or the R_{b} could be amidated or esterified, hydroxy groups in the substituent or the R_{b} could be esterified or etherified, amino groups in the substituent or R_{b} could be alkylated, sulfonamidated or guanylated.

In some embodiments, the split and mix strategy is also applied for the introduction of the substituent, acyl group or sulfonyl group at the free amino group of the turn inducer(s) providing further variation in the peptide conjugates of the library.

In some embodiments, the method further comprises cyclizing the peptide conjugates to form cyclic peptide conjugates. Cyclization may occur after deprotection of the side chain and terminal protecting groups or after cleaving the peptide conjugates from the compartmentalized solid phase support and safety catch linker. In some embodiments, the library may be divided into aliquots and a proportion of the peptide conjugates, e.g. 10%, 20%, 30%, 40%, 50%, 60%, 70%, 80% or 90%, are cyclized while the remainder of peptides are not. In other embodiments, all of the peptide conjugates in the library are cyclized.

The peptide conjugates in the library may be designed to include a thiol or selenol containing amino residue or a thiol or selenol bearing moiety in the C-terminal capping group in the first peptide and a thiol or selenol containing amino residue or a thiol or selenol bearing moiety in the N-terminal capping group in the second peptide. In some embodiments, the thiol or selenol containing amino residue is cysteine, homocysteine, penicillamine or selenocysteine or the thiol or selenol bearing moiety in the C-terminal capping group is —NH(CH₂)₁₋₁₀SH. In some embodiments, the thiol or selenol containing amino residue in the second peptide is cysteine, homocysteine, penicillamine or selenocysteine or the thiol or selenol bearing moiety in the N-terminal residue is —CO(CH₂)₁₋₁₀SH or -4-mercapto-2-pyrrolidinyl carboxylic acid. Cyclization to form a disulfide, diseleno or sulfo-seleno bond may be performed by exposing the deprotected and/or cleaved peptide conjugates to oxidative conditions. Such conditions for forming disulfide bonds are known in the art, for example, exposing the peptide to dimethylsulfoxide (DMSO) and trifluoroacetic acid (TFA).

The peptide conjugates in the library may be designed to include other residues that may be linked to form a cyclic peptide conjugate, for example, by ester, thioester or amide, ether, thioether or carbon carbon bond formation or triazole formation. For example, the first peptide and the second peptide include amino acid residues having a complementary pair of side chain functional groups such as a carboxylic acid, amino, thiol, hydroxy group or double bond or where a free N-terminal amino group is present. Cyclization occurs when a side chain or terminal amino group and side chain carboxy group are reacted to form an amide or a side chain hydroxy or thiol group or a side chain or carboxy group are reacted to form an ester or thioester or two side chain alkene groups are reacted using ring closing metathesis to form a —CH═CH— group which may be further reduced to a single bond or a side chain alkyl halide may be reacted with a side chain hydroxy or thiol group to form an ether or thioether. Cyclization may also be achieved by reacting a fluoro, nitro-phenyl substituent such as a 1-fluoro-2,4-dinitrophenyl substituent or a 2-fluoro-5-nitrophenyl substituent in the N-terminal capping group with a free thiol or hydroxy or amine group on a side chain in R₁ to provide an ether, thioether or amine respectively. Another means of cyclization is using “Click chemistry” in which one of a complementary pair of N-terminal capping group, C-terminal capping group and amino acid side chain has a terminal alkynyl group and the other of the complementary pair has an azide group (—N═N═N) and in the presence of a copper (Cu) catalyst, cyclization occurs to provide a triazole linking group between the first peptide and the second peptide. Since conditions for such cyclizations may require activation of the carboxy group or other conditions that may affect other side chain functionality on the peptide conjugate, selective deprotection of the peptide may be required before cyclization thereby exposing only those functional groups that are to be cyclized. After cyclization, deprotection of other side chain and terminal protecting groups and cleavage of the peptide may occur.

In embodiments where cyclization occurs, the first peptide and the second peptide independently have 2 to 5 amino acid residues.

Suitable protecting groups and conditions for protection and deprotection can be found in “Protective Groups in Organic Synthesis” 3^{rd} Edition, Theodora W. Greene and Peter G. M. Wuts, 1999, John Wiley & Sons.

The solid phase synthesis of the peptide conjugates is carried out using standard techniques of deprotection of the N-terminal protecting group, activation of the amino acid to be added to the peptide and reaction of the activated amino acid with the free terminal amine of the peptide.

Suitable protecting groups for the side chain functional groups are selected to be stable to the reaction conditions used in the peptide synthesis and if required, to allow selective removal of the protecting group during or after synthesis of the peptide backbone.

The peptide conjugate may be synthesized using standard chemistries such as t-Butoxy carbonyl (BOC) chemistry or Fmoc chemistry. For example, if BOC chemistry is used, deprotection of the N-terminal BOC group will require all side chain protection to be stable to BOC deprotection conditions, such as TFA. If Fmoc chemistry is used, all of the side chain protection used will need to be stable to mild base conditions, such as piperidine in DMF, used for 9-fluorenylmethoxycarbonyl (Fmoc) deprotection.

Careful selection of protecting groups used for functional groups of side chains or functional groups on the turn inducer is required for any functional groups that require selective deprotection and further elaboration during or at the end of the peptide backbone synthesis. Suitable protecting groups are known in the art and can be found in Green and Wuts, ibid.

In one embodiment, BOC chemistry is used for the peptide conjugate synthesis and therefore in the compound of formula II, one of R₅ and R₆ in the N-terminal turn inducer, whichever is designated as the N-terminus for further growth of the peptide will have BOC protection. The other of R₅ and R₆, the protection on the remaining amino group, must be a group that is stable to BOC deprotection conditions and in some embodiments is also able to be removed without affecting the protecting groups of the amino acid side chains in the peptide conjugate or BOC-protection of the N-terminus. A suitable protecting group for the remaining amino group of the turn inducer when the N-terminus is BOC protected is Fmoc.

In another embodiment, Fmoc chemistry is used for the peptide conjugate synthesis and therefore in the compound of formula II, one of R₅ and R₆ in the N-terminal turn inducer, whichever is designated as the N-terminus for further growth of the peptide will have Fmoc protection. The other of R₅ and R₆, the protection on the remaining amino group, must be a group that is stable to Fmoc deprotection conditions and is also able to be removed without affecting the protecting groups of the amino acid side chains in the peptide conjugate or Fmoc-protection of the N-terminus. Suitable protecting groups for the remaining amino group of the turn inducer when the N-terminus is Fmoc protected are known in the art, for example, N-methyltrityl (Mtt) or N-allyloxycarbonyl (Aloc).

In particular embodiments, BOC chemistry is used for the peptide conjugate synthesis and one of R₅ and R₆ of the N-terminal turn inducer, attached to the nitrogen atom designated as the N-terminus of the turn inducer, is BOC and the other of R₅ and R₆, protection on the remaining amino group, is Fmoc.

The compartmentalized solid phase support can be any solid phase support which is presented as a discrete unit and is capable of binding the linker and is stable to peptide synthesis conditions. Selection of a suitable resin is made in accordance with the type of chemical strategy employed and in some cases, the C-terminal capping group required (Methods in Enzymology, V289, Solid Phase Synthesis). Examples of suitable resins include polystyrene resins, polyamide resins and PEG resins. Compartmentalization may be provided by enclosing a pre-determined amount of the resin in a porous bag, known as a “tea bag” resin or a porous can, such as an Irori can. The resin may also be coated on a solid device such as a disc or tube. Multipins and resin beads are also suitable for small quantities of compounds to be synthesized. In one embodiment, the compartmentalized solid support used is a lantern such as SynPhase™ PS Lanterns.

The compartmentalized solid phase support allows each compartment, for example, a lantern, can or a tea bag, to be added to a reaction vessel separately or with other lanterns or tea bags to undergo a particular reaction. During subsequent mixing or splitting steps the reactions occurring at a particular lantern, can or tea bag can be documented so that at cleavage from the lantern or tea bag, the sequence of the peptide conjugate is known or is limited to only a few possibilities. Alternatively, the identity of the peptide may be elucidated after it is identified as a hit or chemical coding may be used.

The safety catch linker is any linker that requires two steps rather than one step for cleavage and is compatible with the deprotection methods used in the solid phase synthesis. In particular embodiments, the safety catch linker is stable to both BOC and Fmoc deprotection conditions. Examples of suitable safety catch linkers include the safety catch amide linker (SCAL)

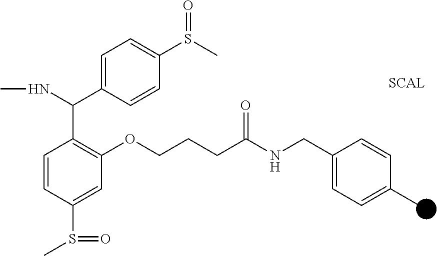

and the alkanesulfonamide safety catch linker

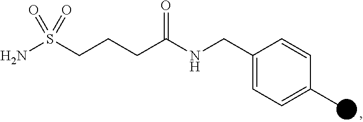

especially the SCAL linker.

The safety catch linker allows the peptide to remain compartmentalized during cleavage of protecting groups, either stepwise or in one reaction. It also allows intensive washing procedures to remove products of side reactions and byproducts. This allows very clean assay-ready peptide conjugates to be produced.

Coupling of the solid phase support and the safety catch linker may be performed by methods known in the art, such as those used in standard peptide bond formation. For example, when using SynPhase™ PS Lanterns and an Fmoc-SCAL linker, the PS-Lanterns are activated by treatment with an activating agent as used in peptide bond formation, such as O-benzotriazole-N—N—N′,N′-tetramethyl-uronium-hexafluorophosphate (HBTU) and a base such as N,N-diisopropylethylamine (DIEA), in dimethylformamide (DMF) and dichloromethane (DCM) and reacted with the Fmoc protected SCAL-linker. Fmoc deprotection is then undertaken under standard conditions by covering the lanterns, with piperidine/DMF (50%). Excess piperidine is then removed by washing.

The peptide conjugate is synthesized using standard solid phase synthetic methods using N-terminally protected amino acids by activation using coupling reagents such as N—N′-carbonyldiimidazole (CDI), N,N′-dicyclohexylcarbodiimide (DCC), HBTU, benzyotriazole-1-yl-oxy-tris-(dimethylamino)-phosphonium hexafluorophosphate (BOP), 3-(Diethoxy-phosphoryloxy)-3H-benzo[d][1,2,3]-triazin-4-one (DEPBT), N,N′-diisopropyl)carbodiimide (DIC), 1-ethyl-3-(3-dimethylaminopropyl)carbodiimide hydrochloride (EDC HCL), 2-(1H-2-Azabenzotriazol-1-yl)-1,1,3,3-tetramethyluronium hexafluorophosphate methanaminium (HATU), 1-hydroxy-7-azabenzotriazole (HOAt), N-hydroxybenzotriazole (HOBT), hydroxy-3,4-dihydro-4-oxo-1,2,3-benzotriazine (HOOBT), 1H-benzotriazolium-1-[bis(dimethylamino)methylene]-5-chloro-hexafluorophosphate-3-oxide (HCTU), 6-chloro-1-hydroxybenzotriazole (Cl-HOBt), benzotriazol-1-yl-oxytripyrrolidinophosphonium hexafluorophosphate (PyBOP), bromo-tris-pyrrolidinophosphonium hexafluorophosphate (PyBrOP), O-(benzotriazol-1-yl)-N,N,N′,N′-tetramethyluronium tetrafluoroborate (TBTU), N,N,N′,N′-tetramethyl-O-(3,4-dihydro-4-oxo-benzotriazin-3-yl)uronium tetrafluoroborate (TDBTU), 2-(7-aza-1H-benzotriazol-1-yl)-1,1,3,3-tetramethyluronium tetrafluoroborate (TATU), O—(N-succinimidyl)-1,1,3,3-tetramethyluronium tetrafluoroborate (TSTU) and 4,5-dicyanoimidazole.

BOC deprotection may also be performed using standard conditions of neat trifluoroacetic acid (TFA).

The desired number and type of amino acids are coupled to form the first peptide and after introduction of the turn inducer(s), the second peptide.

One or up to three turn inducers of formula (II) may also be introduced using standard amino acid coupling techniques as described above, especially using HATU/DIEA coupling reagent.

Deprotection of the N-terminal BOC group of the compound of formula II allows further amino acids to be coupled introducing the second peptide of the peptide conjugate.

In some embodiments, after all desired amino acids have been added and before final N-terminal deprotection and side chain deprotection, the protection on the remaining amino group on the turn inducer within the peptide, for example, Fmoc, is deprotected using standard conditions, for example with Fmoc deprotection, standard conditions include piperidine/DMF (50%).

In some embodiments, after all amino acids have been added and before deprotection of the remaining amino group on the turn inducer, the N-terminal protecting group is removed and replaced with an N-terminal capping group. The N-terminal capping group must be stable to further reactions such as deprotection and substitution of the remaining turn inducer amino group, deprotection of side chain protecting groups and cleavage from the linker.

After deprotection and optional substitution, acylation or sulfonylation of the remaining amino group of the turn inducer and further optional derivatization, such as guanylation, of the turn inducer substituent, acyl or sulfonyl group on the remaining amino group, the side chain and N-terminal protecting groups are removed under acidic conditions. In some embodiments, the N-terminal protecting group is removed before the side chain protecting groups. After deprotection of the N-terminal protecting group, an N-terminal capping group may be introduced.

In some embodiments, the side chain protecting groups are all removed at the same time, for example, using HF.

In some embodiments, ring A of the compound of formula II is a 5- or 6-membered saturated or unsaturated nitrogen-containing heterocyclic ring, especially a 5- or 6-membered saturated nitrogen-containing heterocyclic ring, more especially a pyrrolidine ring or a piperidine ring, most especially a pyrrolidine ring.

In some embodiments, the carboxylic acid or acetyl substituent is in the α-position with respect to the ring nitrogen atom, especially when the A ring is a 5-membered ring such as a pyrrolidine ring.

In some embodiments, when the A ring is a 6-membered ring, the carboxylic acid or acetyl substituent is in the γ-position with respect to the ring nitrogen atom, especially when the 6-membered ring is a piperidine ring.

The amino acids used in the synthesis of the first peptide and the second peptide may be any amino acid and may be selected at random or may be selected to mimic amino acid residues before or after a turn in a naturally occurring peptide or protein or a peptide or protein of interest.

In some embodiments, the first peptide and the second peptide independently have 2 or 3 amino acid residues. In some embodiments, the first peptide and the second peptide both have 2 amino acid residues.

In some embodiments, the split and mix strategy is performed more than once. In some embodiments, split and mix strategy is performed before the addition of every amino acid and turn inducer, except the first amino acid. In some embodiments, the split and mix strategy is applied before the addition of every amino acid residue. In some embodiments, the split and mix strategy is applied before addition of every amino acid residue and the turn inducer.

In some embodiments, a C-terminal capping group is introduced during synthesis, after or during cleavage of the peptide conjugate from the linker and solid support.

A schematic diagram showing an embodiment of the method of the invention is attached as FIG. 1.

In particular embodiments of the method, one or more of the following apply:

The compartmentalized solid phase support is a disc, tea bag, Irori can or a lantern, especially a lantern.

The safety catch linker is a SCAL linker.

The synthesis of the peptide conjugate is performed under BOC chemistry conditions.

During synthesis of the first peptide, 2 to 5 amino acid residues especially 2 to 3, more especially 2 amino acid residues, are introduced and one of the amino acid residues has a functional group in its side chain, optionally protected that is capable of cyclization with the N-terminal nitrogen atom or capping group or the side chain of another amino acid residue in the peptide conjugate. In particular, the amino acid may be a cysteine, homocysteine, penicillamine, selenocysteine, glutamic acid, aspartic acid, lysine, serine or threonine residue or a residue containing an allyl, propargyl, methylazide or alkylbromo/alkylchloro group, especially a cysteine, homocysteine, penicillamine or selenocysteine residue, most especially a cysteine residue.

One or two, especially one, turn inducers are introduced.

In the turn inducer, ring A is a 5 or 6-membered saturated or unsaturated nitrogen-containing ring, especially a 5- or 6-membered saturated nitrogen-containing ring, more especially a pyrrolidine ring or a piperidine ring, most especially a pyrrolidine ring.

In the N-terminal turn inducer, one of R₅ and R₆ is BOC and the other is Fmoc.

In the turn inducer(s), the amino group is attached at the 3-, 4-, 5- or 6-position of the ring with respect to the nitrogen atom in the one position, especially in the 4-position.

P is 0.

The carboxylic acid or acetyl group of the turn inducer is in a position α to the ring nitrogen atom.

During synthesis of the second peptide, 2 to 5 amino acid residues especially 2 to 3, more especially 2 amino acid residues are introduced and one amino acid residue has a functional group in its side chain, optionally protected that is capable of cyclization with the C-terminal carboxylic acid or capping group or the side chain of another amino acid residue in the peptide conjugate. In particular, the amino acid may be a cysteine, homocysteine, penicillamine, selenocysteine, glutamic acid, aspartic acid, lysine, serine or threonine residue or a residue containing an allyl, propargyl, methylazide or alkylbromo group, especially a cysteine, homocysteine, penicillamine or selenocysteine residue, most especially a cysteine residue.

Substitution, acylation or sulfonylation of the free amino group of the one to three turn inducers independently introduces a group that mimics an amino acid side chain, especially by acylation.

The N-terminal protecting group is removed before the side chain protecting groups, particularly where the N-terminal protecting group is BOC or Fmoc, especially BOC.

The side chain protecting groups are all removed simultaneously (HF).

Before cleavage of the peptide conjugate the compartmentalized solid phase supports bearing the deprotected peptide are place in individual containers or compartments, such as one lantern per well of a 96 well cleavage block. The lanterns may be sorted by the sequence of the amino acids used in the synthesis and/or the turn inducer used.

When two amino acids in the peptide have side chains capable of cyclizing, a further cyclization step is included. For example, where the amino acid residue two before the turn inducer and the second amino acid residue after the turn inducer are cysteine, homocysteine, penicillamine or selenocysteine, a disulfide, diseleno or sulfoseleno bond may be formed by exposure to oxidative conditions such as dimethylsulfoxide (DMSO), thereby cyclizing the peptide conjugate.

The cyclizable amino acid residues are both cysteine and a disulfide bond is formed upon cyclization.

In one embodiment the method of the present invention, there is provided a method of preparing a library of peptide conjugates comprising the steps of:
i) preparing a first peptide attached to a lantern solid phase support through a SCAL linker;
ii) introducing a turn inducer represented by the formula (IIa)

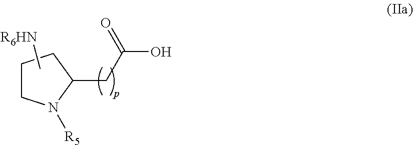

wherein one of R₅ and R₆ is BOC and the other is Fmoc, p is 0 or 1;
iii) deprotecting the BOC group;
iv) introducing a second peptide at the free amino group of the turn inducer;
v) deprotecting the Fmoc group from the turn inducer to provide a free amino group;
vi) deprotecting the N-terminal protecting groups and the side chain protecting groups; and
vii) cleaving the peptide conjugates from the lantern and linker;
   wherein the first peptide and the second peptide independently comprise the two amino acid residues in which the first amino acid residue introduced into the first peptide and the second amino acid residue introduced into the second peptide are residues have a thiol or selenol group, optionally protected;
   the method further comprising cyclizing the peptide conjugate to form a disulfide, diseleno or sulfoseleno bond, and
   wherein at least one of preparing the first peptide, introducing the turn inducer and introducing the second peptide involves a split and mix strategy to introduce variation into the amino acid sequence or turn inducer of the peptide conjugate.

In another embodiment the method of the present invention, there is provided a method of preparing a library of peptide conjugates comprising the steps of:
i) preparing a first peptide attached to a lantern solid phase support through a SCAL linker;
ii) introducing a turn inducer represented by the formula (IIb)

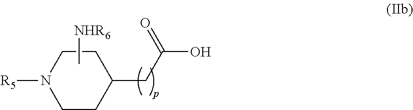

wherein one of R₅ and R₆ is BOC and the other is Fmoc, p is 0 or 1;
iii) deprotecting the BOC group;
iv) introducing a second peptide at the free amino group of the turn inducer;
v) deprotecting the Fmoc group from the turn inducer to provide a free amino group;
vi) deprotecting the N-terminal protecting groups and the side chain protecting groups; and
vii) cleaving the peptide conjugates from the lantern and linker;
   wherein the first peptide and the second peptide independently comprise the two amino acid residues in which the first amino acid residue introduced into the first peptide and the second amino acid residue introduced into the second peptide are residues have a thiol or selenol group, optionally protected;
   the method further comprising cyclizing the peptide conjugate to form a disulfide, diseleno or sulfoseleno bond, and
   wherein at least one of preparing the first peptide, introducing the turn inducer and introducing the second peptide involves a split and mix strategy to introduce variation into the amino acid sequence or turn inducer of the peptide conjugate.

In some embodiments at least a portion of the free amino group of the turn inducer exposed in step v) is substituted, acylated or sulfonylated. In some embodiments, the free amino group is optionally substituted with alkyl or substituted alkyl, alkenyl, alkynyl, cycloalkyl, aryl, heterocyclyl or heteroaryl substituent, or acylated with a carboxy containing compound to provide an N-acylated turn inducer or sulfonylated to provide a sulfonamidated turn inducer within the peptide conjugate.

The free amino group may be optionally substituted with an alkyl group, cycloalkyl group, aryl group, heteroaryl group, heterocyclyl group or a substituted alkyl group. The substitution may be achieved by methods known in the art such as reaction of the free amino group with an alkyl substituent with an appropriate aldehyde to provide an imine and subsequent reduction (reductive amination).

The coupling between the free amino group and the carboxylic acid may also be achieved using peptide coupling conditions of activation and amide formation as described above. Suitable carboxylic acids include Rₐ—CO₂H where Rₐ is —C₁₋₆alkyl, —C₀₋₆alkyl cycloalkyl, —C₀₋₆alkylNRₐC(═NRₐ)N(Rₐ)₂, —C₁₋₆alkylCON(Rₐ)₂, —C₁₋₆alkylCO₂Rₐ, —C₀₋₆alkylSH, —C₀₋₆alkyl(heterocyclyl), —C₀₋₆alkyl(heteroaryl), —C₀₋₆alkylN(Rₐ)₂, —C₀₋₆alkylSC₁₋₆alkyl, —C₀₋₆alkylaryl and —C₀₋₆alkylORₐ, wherein each Rₐ is independently selected from hydrogen —C₁₋₆alkyl, cycloalkyl, aryl, heterocyclyl and heteroaryl, and wherein each aryl, heterocyclyl or heteroaryl group may be optionally substituted with —C₁₋₃alkyl, —OH, —NH₂ or -oxo (═O), especially —C₁₋₄alkyl, —C₀₋₃alkylcycloalkyl, —C₂₋₄alkylNHC(═NH)NH₂, —C₁₋₂alkylCONH₂, —C₁₋₃alkylCO₂H, —C₁₋₃ SH, —C₀₋₃alkylheterocyclyl, —C₀₋₃alkylheteroaryl, —C₀₋₃alkylaryl, —C₁₋₅alkylNH₂, —C₁₋₃alkylSC₁₋₃alkyl, and —C₁₋₃alkylOH, wherein each aryl, heterocyclyl or heteroaryl group may be optionally substituted with —C₁₋₃alkyl, —OH, —NH₂ or -oxo (═O). Exemplary carboxylic acids include

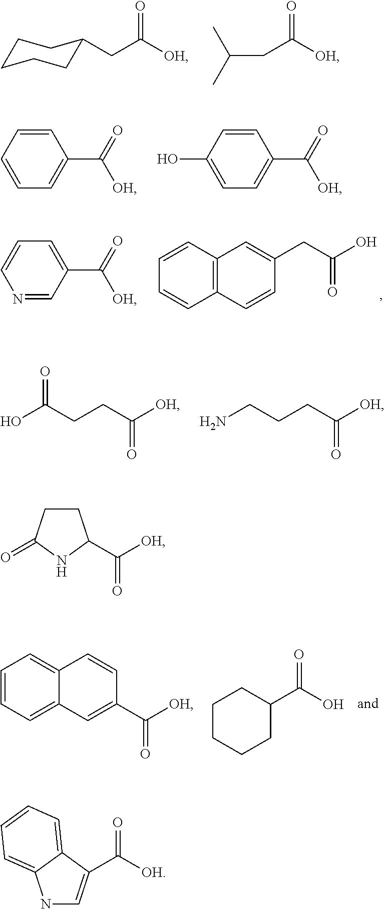

The free amino group may be optionally substituted with a sulfonyl group to provide a sulphonamide substituted turn inducer in the peptide. The sulphonamide may be prepared by methods known in the art, for example the free amino group may be reacted with an appropriate sulfonylchloride reactant. Suitable sulfonyl groups include —SO₂R_{b} where R_{b} is —C₁₋₆alkyl, —C₂₋₆alkenyl, —C₁₋₆alkynyl, —C₀₋₆alkylcycloalkyl, —C₀₋₆alkylcycloalkenyl, —C₁₋₆alkylNRₐC(═NRₐ)N(Rₐ)₂, —C₁₋₆alkylCON(Rₐ)₂—C₁₋₆alkylCO₂Rₐ, —C₁₋₆alkylSRₐ, —C₀₋₆alkyl(heterocyclyl), —C₀₋₆alkyl(heteroaryl), —C₁₋₆alkylN(Rₐ)₂, —C₁₋₆alkylSC₁₋₆alkyl, —C₀₋₆alkylaryl, —C₁₋₆alkylORₐ, —C₁₋₆alkylNSO₂Rₐ, —C₁₋₆alkylSO₃Rₐ and —C₁₋₆alkylOPO₃Rₐ wherein each Rₐ is independently selected from hydrogen, —C₁₋₆alkyl, cycloalkyl, aryl, heterocyclyl and heteroaryl, and wherein each alkyl, alkenyl, alkynyl, cycloalkyl, cycloalkenyl, aryl, heterocyclyl or heteroaryl group may be optionally substituted with —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl, especially where R_{b} is —C₁₋₄alkyl, —C₀₋₃alkylcycloalkyl, —C₂₋₄alkylNHC(═NH)NH₂, —C₁₋₂alkylCONH₂, —C₁₋₃alkylCO₂H, —C₁₋₃alkylSH, —C₀₋₃alkylheterocyclyl, —C₀₋₃alkylheteroaryl, —C₀₋₃alkylaryl, —C₁₋₅alkylNH₂, —C₁₋₃alkylSC₁₋₃alkyl, and —C₁₋₃alkylOH, wherein each aryl, heterocyclyl or heteroaryl group may be optionally substituted with —C₁₋₃alkyl, —OH, —NH₂ or -oxo (═O). Exemplary sulfonyl groups include

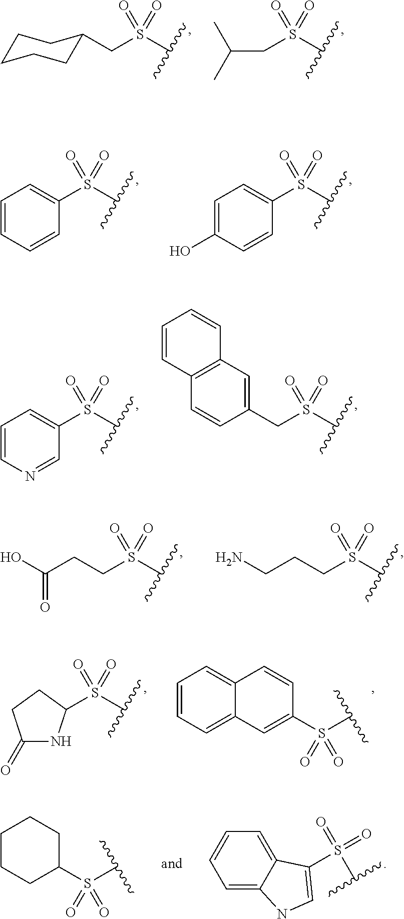

In some cases, the substituent or the R_{b} group of the carboxylic acid or sulfonyl group may have functional groups other than the required carboxylic acid, protected. In some cases, the substituent or the R_{b} groups of the carboxylic acid or sulfonyl group may be further elaborated after introduction. For example, additional carboxylic acid functional groups in the substituent or R_{b} could be amidated or esterified, hydroxy groups in the substituent or

R_{b} could be esterified or etherified, amino groups in the substituent or R_{b} could be alkylated or guanylated.

In this embodiment of the method, one or more of the following may apply:

The thiol or selenol containing amino acid residue in the first peptide is cysteine, homocysteine, penicillamine or selenocysteine, especially cysteine, homocysteine or penicillamine, most especially cysteine.

In formula (IIa) the amino substituent, NHR₆, is in the 4-position of the ring.

In formula (IIb) the amino substituent, NHR₆, is in the 4-position of the ring.

p is 0.

The thiol or selenol containing amino acid residue of the second peptide is cysteine, homocysteine, penicillamine or selenocysteine, especially cysteine, homocysteine or penicillamine, most especially cysteine.

Substitution, acylation or sulfonylation of the free amino group of the turn inducer introduces a group that mimics an amino acid side chain, especially acylation.

Before cleavage of the peptide conjugate, each lantern is placed in a separate vessel or well, such as a well of a 96 cleavage block.

Cleavage of the SCAL linker results in C-terminal amidation.

Peptide Conjugates and their Use

This aspect of the invention is based at least in part on the discovery that peptide conjugates from a peptide library described above, had significant binding to the human norepinephrine transporter.

According to this aspect of the invention there is provided a peptide conjugate comprising the formula (VI):

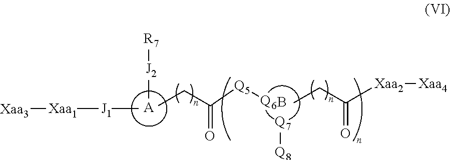

wherein Xaa₁ is absent or is an amino acid residue;
Xaa₂ is absent or is an amino acid residue;
Xaa₃ is an amino acid residue or a peptide having 2 to 4 amino acid residues wherein the amino acid residue or peptide are optionally capped with an N-terminal capping group;
Xaa₄ is an amino acid residue or a peptide having 2 to 4 amino acid residues wherein the amino acid residue or peptide are optionally capped with a C-terminal capping group;
wherein Xaa₃ and Xaa₄ are optionally linked through cyclization of an amino acid side chain of Xaa₃ and an amino acid side chain of Xaa₄, the N-terminal capping group and C-terminal capping group, an amino acid side chain of Xaa₃ and the C-terminal capping group or an amino acid side chain of Xaa₄ and the N-terminal capping group;
A and any B present are independently selected from a 5-7 membered saturated or unsaturated nitrogen-containing heterocyclic ring;
one of J₁ and J₂ is an amino group, —NH—, attached to an A ring carbon atom;
the other of J₁ and J₂ is a covalent bond with the A ring nitrogen atom;
each Q₅ is independently NH or absent;
when Q₅ is NH, Q₆ is C or CH, Q₇ is N and Q₈ is R₇;
when Q₅ is absent, Q₆ is N, Q₇ is C or CH and Q₈ is NHR₇;
each R₇ is independently selected from hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein the carbonyl containing substituents (—(CH₂)ₚCOQ₅) and/or (—(CH₂)ₚCOXaa₂) are attached to the A and/or B rings at a carbon atom in an α-, β- or γ-position with respect to the A and/or B ring nitrogen atom; or a salt thereof.

In some embodiments each R₇ is independently selected from a substituent, acyl group or sulfonyl group that mimics an amino acid side chain. In some embodiments, R₇ is a acyl group that mimics an amino acid side chain. In some embodiments, R₇ is selected from —(C═O)R where R is —C₁₋₆alkyl, —C₀₋₆alkylcycloalkyl, —C₁₋₆alkylNRₐC(═NRₐ)N(Rₐ)₂, —C₁₋₆alkylCON(Rₐ)₂, —C₁₋₆alkylCO₂Rₐ, —C₁₋₆alkylSRₐ, —C₀₋₆alkyl(heterocyclyl), —C₀₋₆alkyl(heteroaryl), —C₁₋₆alkylN(Rₐ)₂, —C₁₋₆alkylSC₁₋₆alkyl, —C₀₋₆alkylaryl and —C₁₋₆alkylORₐ, wherein each Rₐ is independently selected from hydrogen, —C₁₋₆alkyl, cycloalkyl, aryl, heterocyclyl and heteroaryl, especially hydrogen, and wherein each alkyl, aryl, heterocyclyl or heteroaryl group may be optionally substituted with —C₁₋₃alkyl, —OH, —NH₂ or -oxo (═O), especially where R is —C₁₋₄alkyl, —C₀₋₃alkylcycloalkyl, —C₂₋₄alkylNHC(═NH)NH₂, —C₁₋₂alkylCONH₂, —C₁₋₃alkylCO₂H, —C₁₋₃SH, —C₀₋₃alkylheterocyclyl, —C₀₋₃alkylheteroaryl, —C₀₋₃alkylaryl, —C₁₋₅alkylNH₂, —C₁₋₃alkylSC₁₋₃alkyl, and —C₁₋₃alkylOH, wherein each alkyl, aryl, heterocyclyl or heteroaryl group may be optionally substituted with —C₁₋₃alkyl, —OH, —NH₂ or -oxo (═O). Exemplary acyl groups include but are not limited to:

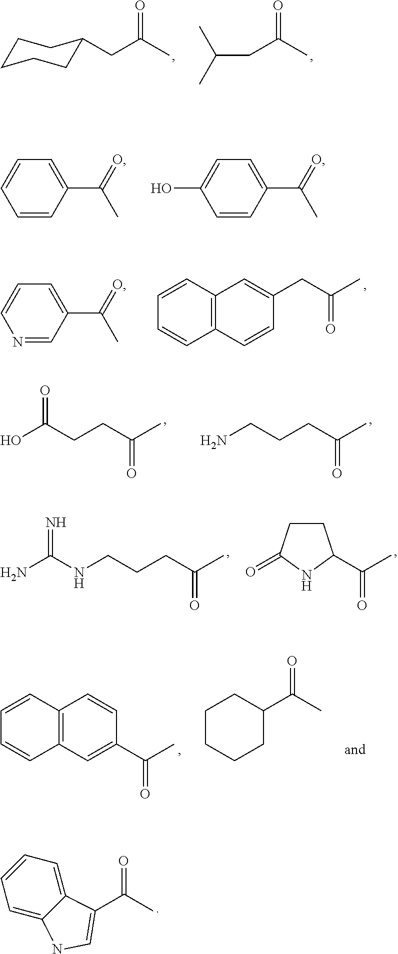

In some embodiments, J₁ is a covalent bond attached to the A ring nitrogen atom and J₂ is an amino acid group attached to an A ring carbon atom. In other embodiments J₂ is a covalent bond attached to the A ring nitrogen atom and J₁ is an amino acid group attached to an A ring carbon atom.

In some embodiments, n is 0 or 1, especially 0.

In some embodiments, p is 0.

In some embodiments, cyclization occurs between Xaa₃ and Xaa₄ where Xaa₃ and Xaa₄ are both peptides having 1 to 4 amino acid residues, especially where cyclization occurs between the side chain of the amino acid residue attached to Xaa₁ and the side chain of the amino acid residue attached to Xaa₂.

In particular embodiments, the peptide conjugate of formula (VI) is a peptide conjugate of formula (VII):

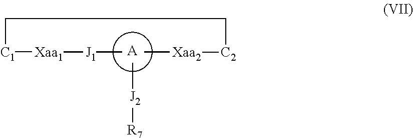

C₁ is selected from cysteine, homocysteine, penicillamine and selenocysteine, optionally capped with an N-terminal capping group;
C₂ is selected from cysteine, homocysteine, penicillamine and selenocysteine, optionally capped with an C-terminal capping group;
wherein C₁ and C₂ are oxidatively linked by a disulfide, diseleno or selenosulfo bond;
Xaa₁ is a hydrophobic amino acid residue, a polar uncharged amino acid residue, a positively charged amino acid residue or a negatively charged amino acid residue;
Xaa₂ is a hydrophobic amino acid residue, a polar uncharged amino acid residue or a positively charged amino acid residue;
A is a 5-7 membered saturated or unsaturated nitrogen-containing heterocyclic ring;
one of J₁ and J₂ is an amino group —NH— attached to an A ring carbon atom;
the other of J₁ and J₂ is a covalent bond with the A ring nitrogen atom;
R₇ is hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl; and
wherein Xaa₂ is attached to the A ring at a carbon atom in an α-, β- or γ-position with respect to the ring nitrogen atom; or a salt thereof.

In some embodiments of formula (VII) at least one of the following applies:

C₁ is selected from cysteine, homocysteine and penicillamine, especially cysteine;

C₂ is selected from cysteine, homocysteine and penicillamine, especially cysteine;

C₁ and C₂ are oxidatively linked to form a disulfide bond or are linked to form a —S—(CH₂)₁₋₃—S— group, especially —S—(CH₂)—S— group;

The C-terminal cysteine residue C₂ is capped with an amide;

Xaa₁ is a polar uncharged amino acid residue selected from L-tyrosine, L-serine, L-threonine, L-cysteine, L-asparagine, L-glutamine and an unnatural or uncommon amino acid residue with a side chain that mimics the properties of the side chain of one of these amino acid residues, especially L-tyrosine, L-serine, L-asparagine and L-glutamine; more especially L-tyrosine;
Xaa₁ is a positively charged amino acid residue selected from L-lysine, L-arginine, L-histidine, L-ornithine and an unnatural or uncommon amino acid residue with a side chain that mimics the properties of the side chain of one of these amino acid residues, especially L-lysine and L-arginine, more especially L-lysine;
Xaa₁ is a hydrophobic amino acid residue selected from L-valine, L-leucine, L-alanine, L-isoleucine, L-proline, L-methionine, L-phenylalanine, L-tryptophan and an unnatural or uncommon amino acid residue with a side chain that mimics the properties of the side chain of one of these amino acid residues, especially L-valine, L-leucine, L-isoleucine, L-alanine and L-phenylalanine, more especially, L-valine and L-leucine;
Xaa₁ is a negatively charged amino acid residue selected from L-aspartic acid, L-glutamic acid and an unnatural or uncommon amino acid residue with a side chain that mimics the properties of the side chain of one of these amino acid residues.
Xaa₂ is a hydrophobic amino acid residue selected from L-valine, L-leucine, L-alanine, L-isoleucine, L-proline, L-methionine, L-phenylalanine, L-tryptophan and an unnatural or uncommon amino acid residue with a side chain that mimics the properties of the side chain of one of these amino acid residues, especially L-leucine, L-isoleucine, Lvaline, L-alanine and L-phenylalanine, more especially L-leucine and L-isoleucine;
Xaa₂ is a polar uncharged amino acid residue selected from L-tyrosine, L-serine, L-threonine, L-cysteine, L-asparagine, L-glutamine and an unnatural or uncommon amino acid residue with a side chain that mimics the properties of the side chain of one of these amino acid residues, especially L-tyrosine, L-serine, L-asparagine and L-glutamine; more especially L-tyrosine;
Xaa₂ is a positively charged amino acid residue selected from L-lysine, L-arginine, L-histidine, L-ornithine and an unnatural or uncommon amino acid residue with a side chain that mimics the properties of the side chain of one of these amino acid residues, especially L-lysine or L-histidine.
A is a 5 or 6-membered saturated or unsaturated nitrogen-containing ring, especially a 5- or 6-membered saturated nitrogen-containing ring, more especially a pyrrolidine ring or a piperidine ring, most especially a pyrrolidine ring;
Xaa₂ is attached to the A ring at a carbon atom in an α-position with respect to the A ring nitrogen atom, especially when the A ring is a 5-membered ring such as a pyrrolidine ring;
Xaa₂ is attached to the A ring at a carbon atom in the γ-position to the A ring nitrogen atom, especially when the A ring is a 6-membered ring such as a piperidine ring;
When A is a pyrrolidine ring, J₁ is a covalent bond with the A ring nitrogen atom and Xaa₂ is in the α- or β-position with respect to the A ring nitrogen atom, especially the α-position,
J₂ is an amino group attached in the 3-, 4- or 5-position of the ring with respect to the A ring nitrogen atom, especially the 3- or 4-position, most especially the 4-position;
When A is a pyrrolidine ring, J₂ is a covalent bond with the A ring nitrogen atom and Xaa₂ is in the α- or β-position with respect to the A ring nitrogen atom, especially the α-position, J₁ is an amino group attached in the 3-, 4- or 5-position of the ring with respect to the A ring nitrogen atom, especially the 3- or 4-position, most especially the 4-position;

When A is a piperidine ring, J₁ is a covalent bond with the A ring nitrogen atom and Xaa₂ is in the α-, β- or γ-position with respect to the A ring nitrogen atom, especially the γ-position, J₂ is an amino group attached in the 2-, 3-, 4-, 5- or 6-position of the ring with respect to the A ring nitrogen atom, especially the 3- or 4-position, most especially the 4-position which may also be the position of attachment of Xaa₂;

When A is a piperidine ring, J₂ is a covalent bond with the A ring nitrogen atom and Xaa₂ is in the α-, β- or γ-position with respect to the A ring nitrogen atom, especially the γ-position, J₁ is an amino group attached in the 2-, 3-, 4-, 5- or 6-position of the ring with respect to the A ring nitrogen atom, especially the 3- or 4-position, most especially the 4-position which may also be the position of attachment of Xaa₂;

R₇ is an acyl group selected from —(C═O)R where R is —C₁₋₆alkyl, —C₀₋₆alkylcycloalkyl, —C₁₋₆alkylNRₐC(═NRₐ)N(Rₐ)₂, —C₁₋₆alkylCON(Rₐ)₂, —C₁₋₆ alkylCO₂Rₐ, —C₁₋₆ alkylSRₐ, —C₀₋₆alkyl(heterocyclyl), —C₀₋₆alkyl(heteroaryl), —C₁₋₆ alkylN(Rₐ)₂, —C₁₋₆alkylSC₁₋₆alkyl, —C₀₋₆alkylaryl and —C₁₋₆alkylORₐ, wherein each Rₐ is independently selected from hydrogen, —C₁₋₆alkyl, cycloalkyl, aryl, heterocyclyl and heteroaryl, especially hydrogen, and wherein each alkyl, aryl, heterocyclyl or heteroaryl group may be optionally substituted with —C₁₋₃alkyl, —OH, —NH₂ or -oxo (═O), especially where R is —C₁₋₄alkyl, —C₀₋₃alkylcycloalkyl, —C₂₋₄alkylNHC(═NH)NH₂, —C₁₋₂alkylCONH₂, —C₁₋₃alkylCO₂H, —C₁₋₃SH, —C₀₋₃alkylheterocyclyl, —C₀₋₃alkylheteroaryl, —C₀₋₃alkylaryl, —C₁₋₅alkylNH₂, —C₁₋₃alkylSC₁₋₃alkyl, and —C₁₋₃alkylOH, wherein each alkyl, aryl, heterocyclyl or heteroaryl group may be optionally substituted with —C₁₋₃alkyl, —OH, —NH₂ or -oxo (═O). Exemplary acyl groups include but are not limited to:

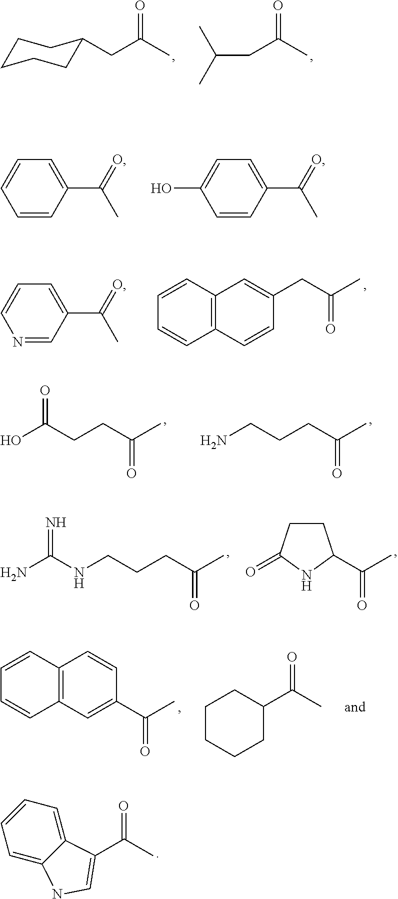

especially —C(O)CH₂CH₂CH₂NH₂.

The peptide conjugates of formula (VI) may be prepared as part of a peptide library as described above. Alternatively, the peptide can be prepared by solid phase or solution phase synthesis as known in the art where the turn inducer(s) are incorporated into the peptide conjugate in the same manner as the other amino acid residues in the peptide conjugate.

In one embodiment, the peptide conjugates of formula (VII) are prepared using a solid phase synthesis. For example, the solid phase and linker used is a Lantern with a SCAL linker attached. Boc Chemistry is used in the synthesis and a Boc protected C₂ is added to the linker. The Boc group on the N-terminus of C₂ is then removed and a Boc protected Xaa₂ is added. The Boc group of Xaa₂ is then removed and a Boc protected, Fmoc protected turn inducer introduced into the peptide sequence. The Boc group of the turn inducer is then removed and a Boc protected Xaa₁ added. The Boc group of Xaa₁ is then removed and a Boc protected C₂ is then added. The Fmoc group of the turn inducer is then removed using piperidine/DMF (50%) and the turn inducer is further elaborated at the free amino group by substitution, acylation or sulfonylation. For example, the free amino group is acylated in the same manner as a normal peptide bond is formed, such as by activation of the carboxylic acid group and reaction with the amino group. After substitution, acylation or sulfonylation of the remaining amino group of the turn inducer, and if required further elaboration of the substituent, acyl group or the sulfonyl group, the Boc group at the N-terminus and the other amino acid side chain protecting groups on Xaa₁, Xaa₂, C₁ and C₂ are removed. The peptide conjugate is then removed from the Lantern and linker. Finally, the side chains of C₁ and C₂ are oxidatively linked to form a disulfide, diselenide or sulfoseleno bond.

The use of the SCAL linker and Lantern enables copious washing of the peptide conjugate while still attached to the linker. This enables the peptide conjugate to be isolated in a purified form with reduced byproducts present. In some cases the peptide conjugate is isolated after removal from the linker essentially free from byproducts.

In some embodiments, the peptide conjugates may be cyclized to include an alkylene linker between the thiol groups or selenol groups, such as two cysteine thiol groups. The peptide conjugate having two free thiol groups or selenol groups or a thiol and selenol group is treated with a reagent such as tetrabutyl ammonium fluoride hydrate in dichloromethane. This reagent gives a methylene dithio ether, or a selenol or sulfoselenol equivalent.

In some embodiments, the peptide conjugates of formula (VI), especially formula (VII), are inhibitors of neurotransmitter reuptake.

Compounds which inhibit neurotransmitter reuptake have been found to be useful in the treatment of acute, chronic and/or neuropathic pain, migraine or inflammation. Such compounds can also be administered with other agents useful in these treatments to provide improved pain/inflammation relief and/or reduce the severity of unwanted side effects, such as nausea and stomach upset. They have also been found to be useful in the treatment of lower urinary tract disorders, such as urinary incontinence, detrusor instability and interstitial cystitis. One such compound is “imipramine” which, in addition to inhibiting norepinephrine reuptake, has been shown to affect calcium channel blockade, and to exhibit anticholinergic, local anaesthetic activity and a number of other effects. Other compounds capable of inhibiting norepinephrine reuptake are described in U.S. Pat. No. 5,441,985. These compounds are said to have a reduced anticholinergic defect relative to imipramine.

At least some of the peptide conjugates of the peptide libraries of the present invention also possess the ability to inhibit neurotransmitter reuptake, which is achieved by selectively inhibiting a neuronal neurotransmitter transporter, such as the norepinephrine transporter, which functions to rapidly clear released norepinephrine from the synapse back into the neurons.

In some embodiments, the peptide conjugates of formula (VI), especially formula (VII), are selective inhibitors of the neuronal norepinephrine transporter.

U.S. Pat. No. 5,441,985 indicates that inhibitors of norepinephrine reuptake which have negligible anticholinergic effect are particularly useful in the treatment of lower urinary tract disorders. In some embodiments the peptide conjugates of this invention also have no detectable or substantially no detectable anticholinergic effect.

A subset of peptide conjugates may act at receptors in addition to the NET allowing synergistic or additional effects. Preferably these additional interactions synergize to enhance the antinociceptive effects. More preferably, these additional interactions occur at opioid receptors, opioid receptor like receptors, GPCRs of the MRG family, the NMDA receptors, glutamate receptors, the neurokinins, cyclooxygenase receptors, serotergenic receptors, adrenergic receptors, vanilloid receptors, benzodiazepines receptors, N-type calcium channel antagonists, neuronal nicotinic receptors, muscarinic acetylcholine capsaicin receptors, TNF-α, tetrodotoxin-resistant and tetrodotoxin-sensitive Na Channels, voltage-sensitive calcium channel and endothelian receptors.

The peptide conjugates of formula (VI) may be active in inhibiting neuronal norepinephrine transporter. Accordingly, the invention provides the use of the peptide conjugates of formula (VI) as inhibitors of neuronal norepinphrine transporter, and in the treatment or prophylaxis of diseases or conditions in relation to which the inhibition of neuronal norepinephrine transporter is associated with effective treatment. Such activity in pharmacological agents is associated with activity in the prophylaxis or treatment of diseases or conditions of the urinary or cardiovascular systems, or mood disorders, or in the treatment or control of acute, chronic and/or neuropathic pain, migraine or inflammation.

Examples of the formulation and use of norepinephrine reuptake inhibitors in therapy can be found in Ardid, D. et al., (1992) Fund. Clinical Pharmacology, 6(2): 75-78; Yaksh, T. L. (1985) Pharmacology Biochemistry and Behaviour, 22:845-858; Yaksh, T. L & Takano, Y. (1992) J. Pharmacology & Experimental Therapeutics 261(2):764-772; Yaksh, T. L. & Howe, J. R. (1982) J. Pharmacology & Experimental Therapeutics 220(2): 311-321; Howe, J. R. et al., (1983) J. Pharmacology & Experimental Therapeutics 224(3):552-558; Solomon et al. (1989) J. Pharmacology & Experimental Therapeutics 251(1): 28-38; Fleetwood-Walker, S. M. et al., (1985) Brain Research 334:243-254; Takagi, H. & Harima, A. (1996) European Neuropsychopharmacology 6:43-47; Eisenach, J. C. et al. (1998) Anesth Analg. 87:591-6; Dubner, R. & Hargreaves, K. M. (1989) Clin. J. Pain, 5 PS1-6; Max, M. B. (1992) N. Engl. J. Med. 326: 1287-8; Atkinson J. H. et al. (1998) Pain 76:287-96; Mico, J. A. et al. (1997) European Neuropsychopharmacology 7:S162.

In yet another aspect of the present invention there is provided a method of treating or preventing pain, migraine, inflammation, lower urinary tract disorders, cardiovascular disorders, mood disorders, depression, schizophrenia, anxiety, psychotic disorders, memory disorders, endocrine or autocrine disfunction, oncological disorders such as cancer, autoimmune disorders, gastrointestinal disorders, pulmonary disorders, metabolic disorders, musculoskeletal disorders or ophthalmological disorders, comprising administering to a subject in need thereof an effective amount of a peptide conjugate comprising the formula (VI):

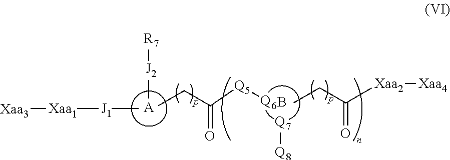

wherein Xaa₁ is absent or is an amino acid residue;
Xaa₂ is absent or is an amino acid residue;
Xaa₃ is an amino acid residue or a peptide having 2 to 4 amino acid residues wherein the amino acid residue or peptide are optionally capped with an N-terminal capping group;
Xaa₄ is an amino acid residue or a peptide having 2 to 4 amino acid residues wherein the amino acid residue or peptide are optionally capped with a C-terminal capping group;
wherein Xaa₃ and Xaa₄ are optionally linked through cyclization of an amino acid side chain of Xaa₃ and an amino acid side chain of Xaa₄, the N-terminal capping group and C-terminal capping group, an amino acid side chain of Xaa₃ and the C-terminal capping group or an amino acid side chain of Xaa₄ and the N-terminal capping group;
A and any B independently are independently selected from a 5-7 membered saturated or unsaturated nitrogen-containing heterocyclic ring;
one of J₁ and J₂ is an amino group, —NH—, attached to an A ring carbon atom;
the other of J₁ and J₂ is a covalent bond with the A ring nitrogen atom;
each Q₅ is independently NH or absent;
when Q₅ is NH, Q₆ is C or CH, Q₇ is N and Qs is R₇;
when Q₅ is absent, Q₆ is N, Q₇ is C or CH and Q₈ is NHR₇;
each R₇ is independently selected from hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein the carbonyl containing substituents (—(CH₂)ₚCOQ₅) and/or (—(CH₂)ₚCOXaa₂) are attached to the A and/or B rings at a carbon atom in an α-, β- or γ-position with respect to the A and/or B ring nitrogen atom; or a salt thereof.

In some embodiments, the peptide conjugates used in the method of treatment are peptide conjugates of formula (VII).

In performing this method, the administration of the peptide conjugate may be performed in conjunction with other therapies useful in the treatment of the condition, disease or disorder. Accordingly the peptide conjugates may be administered substantially simultaneously or sequentially with other agents useful in the treatment of the conditions, diseases or disorders. Where the co-administration is simultaneous, the peptide conjugates may be formulated in a composition with one or more of the other agents. The co-administration of other agents can be performed via the same or different route to the route of administration of the peptide conjugate. Where the method is for the treatment or control of acute, chronic and/or neuropathic pain or migraine, the peptide conjugate may be administered substantially simultaneously or sequentially with an analgesic agent selected from the group consisting of opioid analgesics, opioid receptor-like antagonists, GPCR antagonists of the MRG family, NMDA antagonists, substance P antagonists, COX 1 and COX 2 inhibitors, tricyclic antidepressants (TAC), selective serotonin reuptake inhibitors (SSRI), capsaicin receptor antagonists, anaesthetic agents, benzodiazepines, skeletal muscle relaxants, migraine therapeutic agents, anti-convulsants, anti-hypertensives, anti-arrhythmics, antihistamines, steroids, caffeine, N-type calcium channel antagonists and agonists, TNF-α antagonists and antibodies, inhibitors of tetrodotoxin-sensitive Na Channels, P-type channel inhibitors, endothelin antagonists and botulinum toxin. The peptide conjugates may also be administered simultaneously with two or more other agents, for example, mixtures of SSRIs and norepinephrine reuptake inhibitors.

Examples of conditions associated with acute, chronic and/or neuropathic pain and inflammatory pain include soft tissue and peripheral damage, such as acute trauma, osteoarthritis, rheumatoid arthritis, musculo-skeletal pain, particularly after trauma, spinal pain, dental pain, myofascial pain syndromes, headache, episiotomy pain, and burns; deep and visceral pain, such as heart pain, muscle pain, eye pain, orofacial pain, for example, odontalgia, abdominal pain, gynaecological pain, for example, dysmenorrhea, and labor pain; pain associated with nerve and root damage, such as pain associated with peripheral nerve disorders, for example, nerve entrapment and brachial plexus avulsions, amputation, peripheral neuropathies, neuralgia, tic douloureaux, atypical facial pain, nerve root damage, pain and/or chronic nerve compression, and arachnoiditis; pain associated with carcinoma, often referred to as cancer pain; pain associated with AIDS, central nervous system pain, such as pain due to spinal cord or brain stem damage; low back pain; sciatica; headache including migraine, acute or chronic tension headache, cluster headache, temporomandibular pain and maxillary sinus pain; ankylosing spondylitis, gout, post operative pain; phantom pains; diabetic neuropathy; shingles and scar pain.

Examples of diseases or conditions of the urinary system include urinary and fecal incontinence. Examples of cardiovascular diseases or conditions include arrhythmias of various origins and coronary heart failure. Examples of mood disorders include depression, anxiety, cravings, an addictive disorder and withdrawal syndrome, an adjustment disorder, age-associated learning and mental disorders, anorexia nervosa, apathy, attention-deficit disorders due to general medical conditions, attention-deficit hyperactivity disorder, bipolar disorder, bulimia nervosa, chronic fatigue syndrome, chronic or acute stress, conduct disorder, cyclothymic disorder depression, dysthymic disorder, fibromyalgia and other somatoform disorders, generalised anxiety disorder, incontinence, inhalation disorders, intoxication disorders, mania, obesity, obsessive compulsive disorders and related spectrum disorders, oppositional defiant disorder, panic disorder, peripheral neuropathy, post-traumatic stress disorder, premenstrual dysphoric disorder, psychotic disorders, seasonal affective disorder, sleep disorders, social phobia, specific developmental disorders, selective serotonin reuptake inhibition (SSRI) “poop out” syndrome and TIC disorders.

Examples of the use of selective norepinephrine reuptake inhibitors in the treatment of diseases or conditions of the urinary system include Springer, J P., Kropp, B P. & Thor K B. (1994) J. Urol. 152(2):515-9 (relates to lower urinary tract); Penttila, O. et al. (1975) Ann. Clin. Res. 7:32-6 (relates to treatment of ulcerative colitis) and Dinan, T G et al. (1990) J. Psychosom. Res. 34:575-80 (relates to treatment of irritable bowel syndrome).

It is also noted that norepinephrine transporter is expressed not only by nerve cells, but also by other tissues including the placenta, pulmonary endothelial cells and the uterus. The peptide conjugates of formula (VI) may also be effective in inhibiting these norepinephrine transporter, and may be useful in treating conditions in which these transporters are implicated.

Preferably the mammal is in need of such treatment although the peptide may be administered in a prophylactic sense.

In some embodiments, the peptide conjugates are in the form of a pharmaceutical composition. The composition may also include other active agents useful in the treatment of the condition, disorder or disease present in the pharmaceutical composition.

According to another aspect of the invention there is provided a pharmaceutical composition comprising a peptide conjugate comprising the formula (VI):

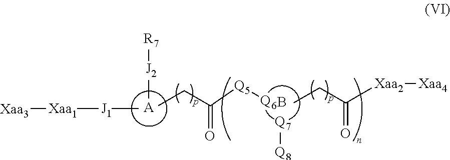

wherein Xaa₁ is absent or is an amino acid residue;
Xaa₂ is absent or is an amino acid residue;
Xaa₃ is an amino acid residue or a peptide having 2 to 4 amino acid residues wherein the amino acid residue or peptide are optionally capped with an N-terminal capping group;
Xaa₄ is an amino acid residue or a peptide having 2 to 4 amino acid residues wherein the amino acid residue or peptide are optionally capped with a C-terminal capping group;
wherein Xaa₃ and Xaa₄ are optionally linked through cyclization of an amino acid side chain of Xaa₃ and an amino acid side chain of Xaa₄, the N-terminal capping group and C-terminal capping group, an amino acid side chain of Xaa₃ and the C-terminal capping group or an amino acid side chain of Xaa₄ and the N-terminal capping group;
A and any B present are independently selected from a 5-7 membered saturated or unsaturated nitrogen-containing heterocyclic ring;
one of J₁ and J₂ is an amino group, —NH—, attached to an A ring carbon atom;
the other of J₁ and J₂ is a covalent bond with the A ring nitrogen atom;
each Q₅ is independently NH or absent;
when Q₅ is NH, Q₆ is C or CH, Q₇ is N and Q₈ is R₇;
when Q₅ is absent, Q₆ is N, Q₇ is C or CH and Q₈ is NHR₇;
each R₇ is independently selected from hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein the carbonyl containing substituents (—(CH₂)ₚCOQ₅) and/or (—(CH₂)ₚCOXaa₂) are attached to the A and/or B rings at a carbon atom in an α-, β- or γ-position with respect to the A and/or B ring nitrogen atom; or a salt thereof, together with a pharmaceutically acceptable carrier.

In particular embodiments, the pharmaceutical composition comprises a peptide conjugate of formula (VII).

As will be readily appreciated by those skilled in the art, the route of administration and the nature of the pharmaceutically acceptable carrier will depend on the nature of the condition and the mammal to be treated. It is believed that the choice of a particular carrier or delivery system, and route of administration could be readily determined by a person skilled in the art. In the preparation of any formulation containing the peptide conjugates care should be taken to ensure that the activity of the peptide conjugate is not destroyed in the process and that the peptide is able to reach its site of action without being destroyed. In some circumstances it may be necessary to protect the peptide conjugate by means known in the art, such as, for example, microencapsulation. Similarly the route of administration chosen should be such that the peptide conjugate reaches its site of action.

For example, particular routes of administration for the treatment of urinary diseases are oral, topical, intranasal, intrarectal, intramucosal, intramuscular and intravenous. The same may be used for the treatment of pain and mood disorders, in addition to intrathecal and epidural administration.

The pharmaceutical forms suitable for injectable use include sterile injectable solutions or dispersions, and sterile powders for the extemporaneous preparation of sterile injectable solutions. They should be stable under the conditions of manufacture and storage and may be preserved against oxidation and the contaminating action of microorganisms such as bacteria or fungi.

Those skilled in the art may readily determine appropriate formulations for the peptide conjugates of formula (VI) using conventional approaches. Identification of preferred pH ranges and suitable excipients, for example, antioxidants, is routine in the art. Buffer systems are routinely used to provide pH values of a desired range and include carboxylic acid buffers, for example, acetate, citrate, lactate and succinate. A variety of antioxidants are available for such formulations including phenolic compounds such as BHT or vitamin E, reducing agents such as methionine or sulfite and metal chelators such as EDTA.

Conventional approaches for the formulation of pharmaceutically active peptides are described in the following articles, the methodology of which are incorporated by reference: Ryan, J. et al. (1986) Clin Pharmacol Ther, 39:40-2, (a clinical trial detailing the oral administration of the peptide nifalatide); Krames E. S. et al. (1986) Pain, 24:205-9 (describes the intrathecal delivery of a peptide); WO 96/14079A1 (which describes oral and rectal administration of formulations of the peptide cyclosporine); WO 96/40064 A1 (which describes formulations for peptide stability); WO 98/05309 A1 (describes peptide formulations—a pharmaceutical composition of cyclosporine or internal use and WO 98/02148 A1 (which describes sustained release rectal and oral peptide formulations).

The solvent or dispersion medium for the injectable solution or dispersion may contain any of the conventional solvent or carrier systems for peptide actives, and may contain, for example, water, ethanol, polyol (for example, glycerol, propylene glycol and liquid polyethylene glycol and the like), suitable mixtures thereof, and vegetable oils. The proper fluidity can be maintained, for example, by the use of a coating such as lecithin, by the maintenance of the required particle size in the case of dispersion and by the use of surfactants. The prevention of the action of microorganisms can be brought about where necessary by the inclusion of various antibacterial and antifungal agents, for example, parabens, chlorobutanol, phenol, sorbic acid, thimerosal and the like. In many cases, it will be preferable to include agents to adjust osmolality, for example, sugar or sodium chloride. A formulation for injection will be isotonic with blood. Prolonged absorption of the injectable compositions can be brought about by the use in the compositions of agents delaying absorption, for example, aluminium monostearate and gelatin. Pharmaceutical forms suitable for injectable use may be delivered by any appropriate route including intravenous, intramuscular, intracerebral, intrathecal, epidural injection or infusion.

Sterile injectable solutions are prepared by incorporating the peptide conjugates in the required amount in the appropriate solvent with various of other ingredients such as those enumerated above, as required, followed by sterilization. Generally dispersions are prepared by incorporating the various sterilized peptide conjugates into a sterile vehicle which contains the basic dispersion medium and the required other ingredients from those enumerated above. In the case of sterile powders for the drying or freeze-drying of a previously sterile filtered solution of the peptide conjugate plus any additional desired ingredients.

The peptide conjugates may be orally administered, for example, with an inert diluent or with an assimilable edible carrier, or it may be enclosed in hard or soft shell gelatin capsule, or it may be compressed into tablets, or it may be incorporated directly with the food of the diet. For oral therapeutic administration, the peptide conjugate may be incorporated with excipients and used in the form of ingestible tablets, buccal tablets, troches, capsules, elixirs, suspensions, syrups, wafers and the like. Such compositions and preparations may contain at least 1% by weight of peptide conjugate. The percentage of the compositions and preparations may, of course, be varied and may be conveniently be between about 5 to about 80% of the weight of the unit. The amount of peptide conjugate in such therapeutically useful compositions is such that a suitable dosage will be obtained.

The tablets, troches, pills, capsules and the like may also contain the components as listed hereafter: A binder such as gum, acacia, corn starch or gelatin; excipients such as dicalcium phosphate; disintegrating agents such as corn starch, potato starch, alginic acid and the like; lubricants such as magnesium stearate; sweetening agents such as sucrose, lactose or saccharine, flavouring agents such as peppermint, oil of wintergreen, cherry flavouring.

When the dosage unit form is a capsule, it may contain, in addition to materials of the above type, a liquid carrier. Various other materials may be present as coatings or to otherwise modify the physical form of the dosage unit. For instance, tablets, pills, or capsules may be coated with shellac, sugar or both. A syrup or elixir may contain the active compound, sucrose as a sweetening agent, methyl and propylparabens as preservatives, a dye and flavouring agents such as cherry or orange flavour. Of course, any material used in preparing any dosage unit form should be pharmaceutically pure and substantially non-toxic in the amounts employed. In addition, the peptide conjugates may be incorporated into sustained-release preparations and formulations.

The peptide conjugates may also be incorporated in other forms for administration, for example, topical application such as creams, lotions, transdermal patches, sprays and gels or compositions suitable for inhalation or intranasal delivery, for example solutions or dry powders.

Parenteral dosage forms are preferred, including those suitable for intravenous, subcutaneous, intrathecal, intracerebral or epidural delivery.

The composition may also be formulated for delivery via slow release implants, including implantable pumps, such as osmotic pumps.

Pharmaceutically acceptable carriers and/or diluents include any and all solvents, dispersion media, coatings, antibacterial and antifungal agents, isotonic and absorption delaying agents and the like. The use of such media and agents for pharmaceutically active substances is well known in the art. Except insofar as any conventional media or agent is incompatible with the active ingredient, use thereof in the therapeutic composition is contemplated. Supplementary active ingredients can also be incorporated into the compositions.

It is especially advantageous to formulate parenteral compositions in dosage unit form for ease of administration and uniformity of dosage. Dosage unit form as used herein refers to physically discrete units suited as unitary dosages for mammalian subjects to be treated, each unit containing a predetermined quantity of active material calculated to produce the desired therapeutic effect in association with the required pharmaceutical carrier. The specification for the dosage unit forms are dictated and directly dependent on (a) the unique characteristics of the peptide conjugate and the particular therapeutic effect to be achieved, and (b) the limitations inherent in the art of compounding an active material for the treatment of disease in living subjects having a diseased conditions in which bodily health is impaired as herein disclosed in detail.

The peptide conjugates are compounded for convenient and effective administration in effective amounts with a suitable pharmaceutically acceptable carrier in dosage unit form. A unit dosage form can, for example, contain the peptide conjugates in amounts ranging from 0.25 μg to about 2000 mg. Expressed in proportions, the peptide conjugate is generally present in from about 0.25 μg to about 200 mg/mL of carrier. In the case of compositions containing supplementary active ingredients, the dosages are determined by reference to the usual dose and manner of administration of the said ingredients.

In yet another embodiment there is provided use of a peptide conjugate of formula (VI)

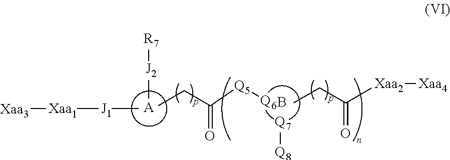

wherein Xaa₁ is absent or is an amino acid residue;
Xaa₂ is absent or is an amino acid residue;
Xaa₃ is an amino acid residue or a peptide having 2 to 4 amino acid residues wherein the amino acid residue or peptide are optionally capped with an N-terminal capping group;
Xaa₄ is an amino acid residue or a peptide having 2 to 4 amino acid residues wherein the amino acid residue or peptide are optionally capped with a C-terminal capping group;
wherein Xaa₃ and Xaa₄ are optionally linked through cyclization of an amino acid side chain of Xaa₃ and an amino acid side chain of Xaa₄, the N-terminal capping group and C-terminal capping group, an amino acid side chain of Xaa₃ and the C-terminal capping group or an amino acid side chain of Xaa₄ and the N-terminal capping group;
A and any B present are independently selected from a 5-7 membered saturated or unsaturated nitrogen-containing heterocyclic ring;
one of J₁ and J₂ is an amino group, —NH—, attached to an A ring carbon atom;
the other of J₁ and J₂ is a covalent bond with the A ring nitrogen atom;
each Q₅ is independently NH or absent;
when Q₅ is NH, Q₆ is C or CH, Q₇ is N and Q₈ is R₇;
when Q₅ is absent, Q₆ is N, Q₇ is C or CH and Q₈ is NHR₇;
each R₇ is independently selected from hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein the carbonyl containing substituents (—(CH₂)ₚCOQ₅) and/or (—(CH₂)ₚCOXaa₂) are attached to the A and/or B rings at a carbon atom in an α-, β- or γ-position with respect to the A and/or B ring nitrogen atom; or a salt thereof,
in the manufacture of a medicament for the treatment or prevention of pain, migraine, inflammation, lower urinary tract disorders, cardiovascular disorders or mood disorders.

In particular embodiments, the peptide conjugate used is a compound of formula (VII).

The invention will now be described with reference to the accompanying Examples. However, it is to be understood that the particularity of the following description is not to supersede the generality of the preceding description of the invention.

### BRIEF DESCRIPTION OF THE FIGURES

FIG. 1 is a schematic diagram showing an embodiment of the method of making a library of peptide conjugates of the invention, using Boc chemistry and Fmoc protection of the remaining non-N-terminal amino group of the turn inducer. “Turn decoration” refers to substitution, acylation or sulfonation of the remaining amino group of the turn inducer.

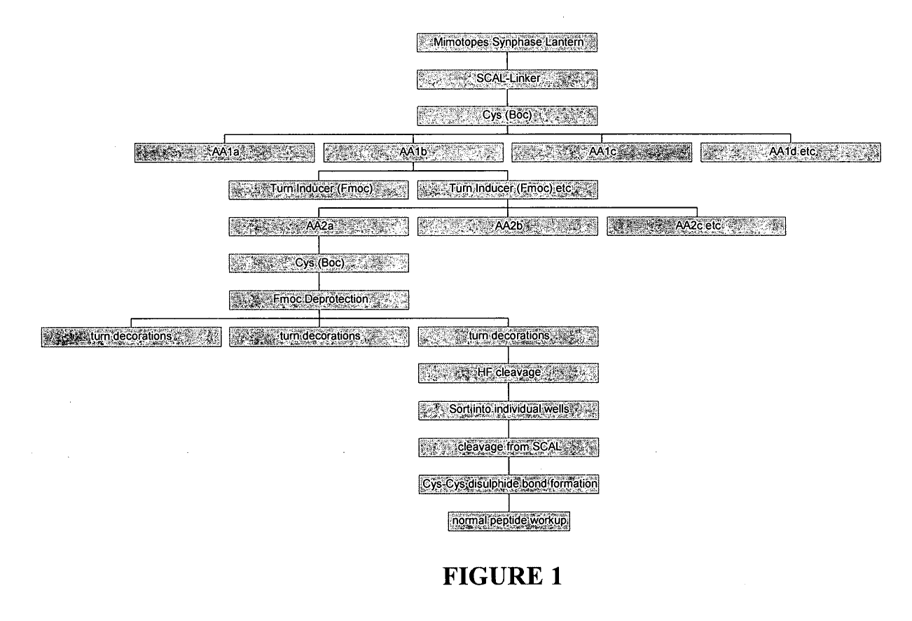

FIG. 2 shows examples of “hits” (>80% inhibition at 10 μM) for a transporter (1), a GPCR (2) and an ion channel (3). Multiple target hits are shown as 4.

FIG. 3A shows cyclization of the peptide conjugates using a disulfide bridge. FIG. 3B shows cyclization using a dithioether approach.

FIG. 4 shows the structure of a peptide of SEQ ID NO:1 and the main pharmacophore region arranged in an inverse turn (a) and the pharmacophore region and schematic formula with stabilizing hydrogen bonds as determined by NMR.

### EXAMPLES

### Example 1

### Preparation of a Library of Cyclized Peptide Conjugates

### Reagents:

Protected BOC-amino acid derivatives were purchased from Auspep P/L (Melbourne, Australia). The following side chain protected BOC-amino acids were used: Cys(Mbzl), Val, Ile, Leu, Met, Phe, Tyr(2BrZ), Ser(Bzl), Thr(Bzl), Asn(Xan), Gln(Xan), Asp(OcHx), Glu(OcHx), Lys(2C1Z), Arg(Tos), His(Tos). Turn inducer (2S,4S)-Fmoc-4-amino-1-BOC-pyrrolidine-2-carboxylic acid, (2S,4R)-Fmoc-4-amino-1-BOC-pyrrolidine-2-carboxylic acid and (2S,4S)-Boc-4-amino-1-Fmoc-pyrrolidine-2-carboxylic acid as well as Fmoc-4-amino-butyric acid was purchased from NeoMPS (Strasbourg, France). Dimethylformamide (DMF), dichloromethane (DCM), diisopropylethylamine (DIEA), Trifluoroacetic acid (TFA) were all peptide synthesis grade supplied by Auspep P/L (Melbourne, Australia). Benzoic acid, 2-naphthoic acid, 4-hydroxy-benzoic acid, cyclohexyl acetic acid, nicotinic acid, succinic acid anhydride, isovaleric acid, p-cresol, Ammonium Iodide, dimethylsulfoxide, tetrabutylammonium fluoride hydrate, 2-(1H-benzotriazol-1-yl)-1,1,3,3-tetramethyluronium hexafluorophosphate (HBTU), dimethyl sulfide (DMS), HPLC grade acetonitrile, diethyl ether and methanol was supplied by Sigma Aldrich (Australia). Bis-BOC-guanyl-pyrazole was purchased from Advanced Chemtech (Louisville, Ky., USA). The resin used was PS-D-Series-lanterns-aminomethylated-TFA salt purchased by Mimotopes (Melbourne, Australia). Fmoc-SCAL-Linker was purchased from CSPS-Pharmaceuticals (San Diego, Calif.-USA). Rat plasma was purchased from Herston Medical Research Centre (Brisbane, Australia).

### Peptide Assembly:

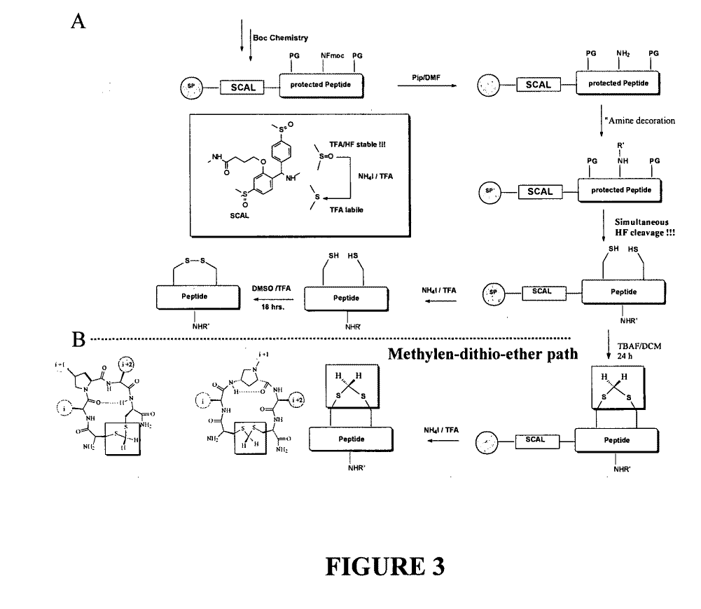

The assembly of a 150 peptide sub library (in this instance, no diversification on the first variable amino acid position) is described here, but can be upsized or varied as required. For example, further sublibraries can be constructed using a range of different amino acids on the first or other variable amino acid positions. Using these methods, a library of 5400 peptide conjugates has been rapidly constructed. The general method is depicted in FIG. 3A.

PS-D-Series lanterns (35 μmol each, 5.25 mmol combined, amino-methyl-TFA-salt) are swelled in DCM/DMF (50%) for 30 min. Neutralization of the TFA salt is performed using 2% DIEA in DMF (2×10 min). After washing with DMF, the attachment of the linker is performed by two couplings for 24 h using each time; Fmoc-SAL-linker (6 mmol, 3.9 g) activated with HBTU (6 mmol, 2.3 g) and 1.04 mL DIEA dissolved in 20 mL DMF and 10 mL DCM to just cover the lanterns. After alternating washes (6×5 min) with DMF and DCM/DMF (50%) the Lanterns are covered twice for 10 min with Piperidine/DMF (50%) to remove the Fmoc-protection from the linker. Excess Piperidine is removed by alternating washes (8×5 min) with DMF and DMF/DCM (50%).

The coupling of the first cysteine is performed for 24 h using BOC-Cys(Mbzl)-OH (21 mmol, 6.8 g), HBTU/DIEA (21 mmol, 7.95 g/3.6 mL) activation in enough DMF to cover all lanterns.

After washing several times using DMF and DMF/DCM (each 3 times, 5 min) the Lanterns are washed a final time using DCM to prevent heat stress (exothermic reaction between TFA and DMF) during subsequent BOC-deprotection with neat TFA (2×5 min). After removal of TFA and intensive washing using DCM (2×), DCM/DMF alternated with DMF (4×5 min) the lanterns are neutralized with 2% DIEA in DMF (2×5 min). Now any required BOC amino acid can be attached to introduce diversification in this position (16 mmol) using HBTU/DIEA activation. After washing, BOC-deprotection and neutralization as described before, any required turn inducer can be introduced (10 mmol, 4.35 g) activated by HATU/DIEA (10 mmol, 3.8 g/1.9 mL) employing a repeat coupling (2×24 h).

After washing, BOC-deprotection and neutralization as described before the 150 lanterns are split into 15 falcon tubes (50 mL, 10 lanterns each) to introduce the diversification in this position of the peptide chain. Each pool of 10 Lanterns is now individually coupled over night with 2 mmol of 15 selected BOC-amino acid using HBTU/DIEA activation (2 mmol).

Again the same washing, BOC-deprotection and neutralization as previously described is performed and the final Cysteine was introduced (2 mmol) using HBTU/DIEA activation (18 h). The N-terminal BOC-protecting group is not removed at this stage to allow for selective diversification on the turn inducer. One Lantern out of each pool of ten Lanterns is now transferred into one new vessel. Finally 10 new mixed pools of 15 lanterns are obtained that are different diversified at an amino acid position.

After Fmoc deprotection of the peptide lanterns using Pip/DMF (50%, 2×10 min) and intensive washing, the free amino group of the turn inducer was introduced as follows: benzoic acid, 2-naphthoic acid, cyclohexyl acetic acid, nicotinic acid, isovaleric acid and pyroglutamic acid are coupled using HBTU/DIEA activation (24 h, 10 mmol). 4-Hydroxybenzoic acid requires double coupling with HBTU/DIEA activation (2×24 h, 10 mmol), succinic anhydride (10 mmol) is coupled using DIEA (10 mmol) in DMF for 2 times 24 h. Fmoc-4-amino-butyric acid is introduced using HBTU/DIEA activation (10 mmol) followed by Fmoc deprotection with Pip/.DMF (50%). Guanyl-4-aminobutyric acid is introduced as in previous described, Fmoc-4-amino-butyric acid coupling and deprotection sequence now followed by guanylation of the amino function using bis-BOC-guanyl-pyrazole (10 mmol) in DMF (2×18 h).

All pools of diversified peptides were washed multiple times and the N-terminal BOC-protection was removed by final TFA treatment (2×5 min) and washing (10×) with DCM. The pools of peptides are kept together and are labelled according to their known first introduced amino acid and the turn inducer used as well as the substitution used on the turn inducer. After drying of the Lanterns in vacuum to remove residual DCM the dried lanterns were ready for cleavage.

### HF-Cleavage:

Three pools of 15 Lanterns (45 combined) are cleaved together in one HF cleavage vessel (3 h at 0° C.) using 25 mL HF and 200 μL p-Cresol. After removal of excess HF in vacuum the lanterns were washed using Diethylether (2×), DCM (2×), DCM/Methanol (50%), Methanol (2×), DCM (2×).

### SCAL-Linker Cleavage:

Lanterns were dried in vacuum and were then transferred into individual wells of an 96 well cleavage block (ACT-Labtech). To perform the SCAL linker activation, resulting in peptide cleavage from the resin, 50 mg of NH₄I, 100 μL of Me₂S and 2.0 mL of neat TFA are added to each lantern. The cleavage was performed whilst shaking for 10 hours at RT. After completion of cleavage the peptide solution was drained into a vial containing 100 μL of DMSO. Oxidation of peptides occurred in the TFA/DMSO solution while standing for additional 8 hours. Cold diethyl ether (12 mL) was added to the cleavage mixtures resulting in the precipitation of the oxidized peptides. The precipitate was collected by centrifugation and subsequently washed with further cold diethyl ether (2×10 mL) to remove scavengers and linker residues. The final product was dissolved in 50% aqueous acetonitrile (10 mL) and lyophilized to yield a fluffy white solid. The crude peptides were then characterized by reverse phase HPLC for purity and the molecular weight confirmed by Electrospray Ionization Mass Spectrometry (ESI-MS).

The known information of first used amino acid, turn inducer and the 3 turn diversifications introduced per batch of 45 products were used to create the 45 possible mutations in a database which calculates the molecular masses of the expected products and allows for sequence assignment by comparison with experimental obtained molecular masses.

Freeze-dried crude peptides were prepared in 1 mg/mL solution and were plated into 96 well plates (20 μL/well) to reconstitute with 100 μL of water to a concentration of approximately 100 μMol and were used directly for screening.

### HPLC Analysis

Analytical HPLC runs were performed using a Shimadzu HPLC system with a UV detector set at 214 nm. A reversed-phase C-18 column (Zorbax 300-SB C18; 4.6×50 mm) with a flow rate of 2 mL/min was used. Gradient elution was performed with the following buffer systems: A, 0.05% TFA in water and B, 0.043% TFA in 90% acetonitrile in water, from 0% B to 80% B in 8 min at a temperature of 40° C. If required crude peptides were purified by semi-preparative HPLC on a Shimadzu HPLC system associated with a reversed-phase C-18 column (Vydac C-18, 25 cm×10 mm) at a flow rate of 5 ml/min with a 1% gradient of 0-40% B. The purity of the final product was evaluated by analytical HPLC.

### Electrospray Mass Spectrometry (ESI-MS)

Electrospray mass spectra were collected inline during analytical HPLC runs on an Applied Biosystems, quadrupole spectrometer (API-150) operating in the positive ion mode with an declustering potential (DP) of 10 V, a focusing potential (FP) of 160 V and a Turbospray heater temperature of 350° C. Masses between 300 and 2200 amu were detected (Step 0.1 amu, Dwell 0.1 ms).

### Plasma & Buffer Stability

The stability of the peptides can be assessed by preparing a 1 mg/mL solution of the peptide in PBS Buffer pH 7.4, and diluting aliquots of the solution to 0.5 mg/mL with either PBS buffer or Rat Plasma and incubating at 37° C. After incubating (Buffer: Initial, 6 h, 24 h; Plasma: Initial, 15 min, 30 min, 1 h, 2 h, 4 h, 6 h and 24 h) the aliquots were quenched with 10% Acetonitrile and 2% TFA in water. After centrifuging the samples were analysed by LCMS using reverse-phase C18 column (Zorbax 300SB C18; 4.6×250 mm) with a 1 mL/min flow rate, 214 nm UV detection and gradient elution of (5 to 45) % Buffer B in 24 min (Buffer A: 0.05% TFA in Water; Buffer B: 0.043% TFA, 90% Acetonitrile, 10% Water). Mass Spectrometry was performed inline as previously described.

### Example 2

### Preparation of a Library Using Dithioether Cyclization to Form Methylendithioether Peptide Conjugates

Similar methods used in Example 1 are used with the following variations. Lanterns (30) obtained from. HF cleavage are covered with a solution of 6 g tetrabutyl ammonium fluoride hydrate in DCM (20 mL) for a period of 18 h. The lanterns than are washed multiple times with DCM and then dried in vacuum. The obtained dithioether peptides are then treated as described in example 1 to obtain SCAL linker cleavage with the exception that a final DMSO oxidation is not required. The workup is identical to that described in Example 1. The method used is depicted in FIG. 3B.

### Example 3

### Library Validation

Using the methods described in Examples 1 and 2, a library of 5400 peptide conjugates was constructed according to formula I, with a range of variants for A, R₁, R₂ and R₃ thereby representing significant structural and chemical diversity. The peptide conjugates were plated in a format suitable for high or medium throughput screening.

To provide proof-of-concept for the methods and demonstrate the utility of the resulting peptide conjugates, a subset of the library (400 compounds) was tested against examples of three different classes of drug target, namely ion channels, GPCRs and transporters.

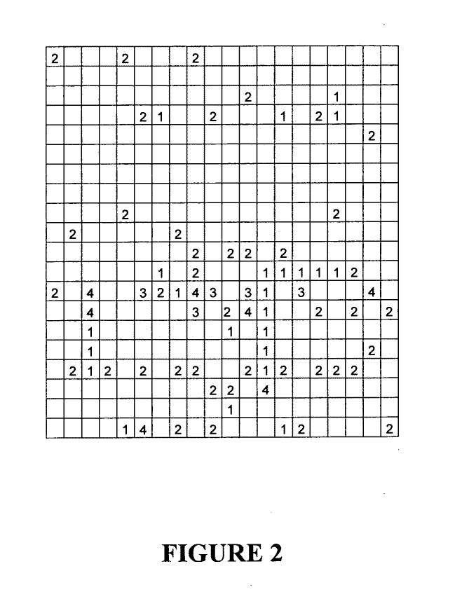

Detailed descriptions of these experiments and results are provided in Examples 4 to 7. In brief, the validation program yielded numerous hits at all three targets (FIG. 2) supporting the broad applicability of the library to a variety of target types. These screens also revealed the significant target specificity or selectivity that can be achieved with individual hits.

### Example 4

### Design of a Focussed Peptide Conjugate Library

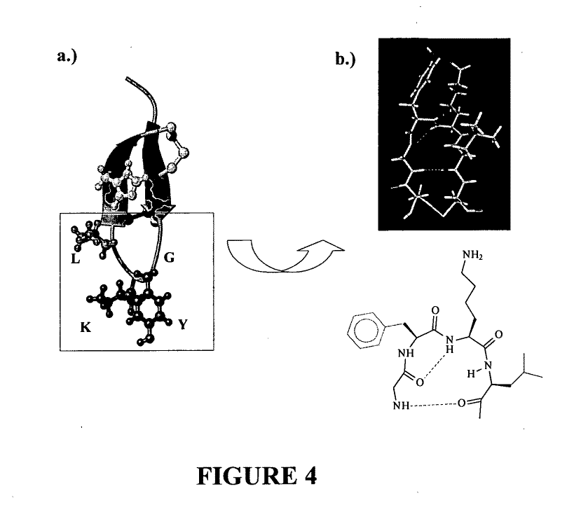

To validate the approach of using the peptide-turn mimetic library of the present invention, a library was designed based on Xen2174, a known inhibitor of hNET. Xen2174 has the sequence UGVCCGYKLCHOC (SEQ ID NO. 1). SAR studies and NMR structural studies have provided identification of important binding residues. The important residues for binding and activity include the pharmacophore YKL. The YKL pharmacophore is shown in FIG. 4 and a turn is prominent. Although based on the structural data, Xen2174 is considered to have a γ-turn, defining the turn more loosely, relying only on intramolecular hydrogen bonding, the turn could also be considered a β-turn.

A peptide-turn mimetic library was prepared as set out in Example 1. The first peptide used was Cys(MBzl), followed by leucine. The lanterns were divided into three aliquots and each was reacted with one of 4S,2S-Fmoc-4-amino-1-BOC-pyrrolidine-2-carboxylic acid, 4S,2R-Fmoc-4-amino-1-BOC-pyrrolidine-2-carboxylic acid and 4S,2S-BOC-4-amino-1-Fmoc-pyrrolidine-2-carboxylic acid. The three aliquots were kept separate for further reactions.

The next amino acid introduced was (2BrZ)-tyrosine and finally Cys(MBzl). The Fmoc deprotection on the turn inducer was removed and the amino group was acylated with Fmoc-4-amino-butyric acid.

The N-terminal BOC group was removed, then the Fmoc protection on the 4-amino-butyric acid was removed, followed by removal of the side chain protecting groups.

The peptides were cleaved from the linker and lantern and oxidized to form an intramolecular disulfide bond between the two cysteine residues. The peptides were then purified.

The focussed peptide-turn mimetic library included the following peptides:

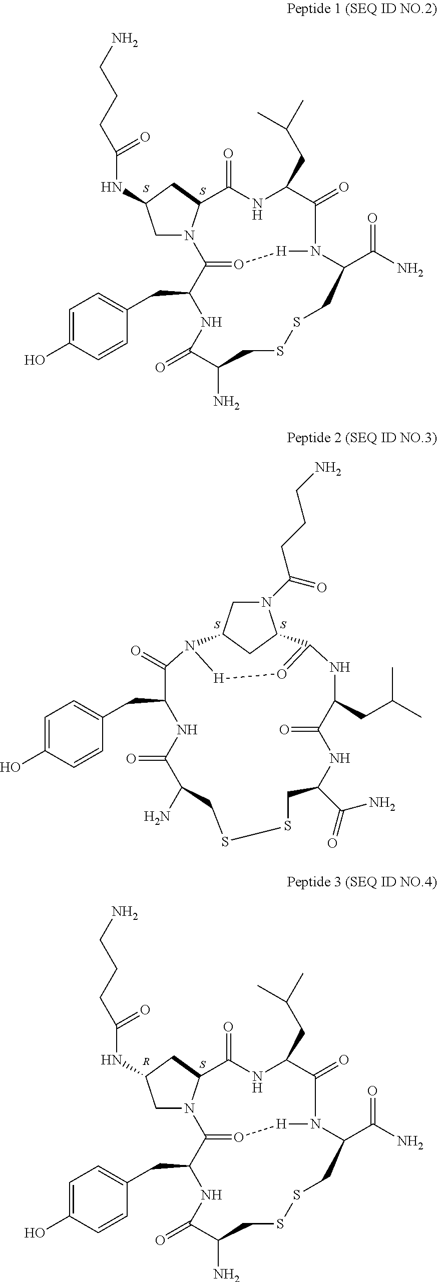

### Example 5

### Analysis of Peptide Conjugate Library in hNET Assay

Preparation of a larger library (400 compounds) in a similar manner to Example 2 in which peptide conjugates having the structure:

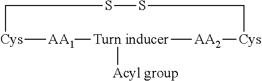

were prepared. This library which included the small focussed library (SEQ ID NOs 2, 3 and 4) was tested against a transporter target to test the concept that this approach can be used to rapidly generate libraries of bioactive turn mimetics. The ability of compounds to act as inhibitors of the human norepinephrine transporter (hNET) was measured by competitive inhibition of ³H-nisoxetine from membrane expressing hNET.

### Methods

Total assay volume 150 μL (50 μL peptide conjugate, 50 μL tritiated compound and 50 μL membrane) with each data point performed in triplicate. Assay buffer used was TrisHCl (50 mM, pH 7.4), NaCl (120 mM) and KCl (5 mM). Peptide conjugates were initially screened at a single concentration of 10 μM. Confirmation of any hits was performed using full dose response of the peptide conjugate using various concentrations (10⁻⁴ to 10⁻¹¹ M) or control ligand (nisoxetine) were added to the assay plate followed by 4 nM ³H-nisoxetine (Perkin Elmer cat #NET 1084)—this resulted in the determination of IC₅₀ value. hNET membrane was purchased from Perkin Elmer Life Sciences (cat #RBHNETM400UA) and used at a concentration of 1 μL/well. After the addition of the membrane the assay was incubated for 1 h at RT after which the reaction was filtered onto GF filtermats B (Perkin Elmer cat #1450-521) pretreated with 0.6% PEI using a Tomtec cell harvester and washed 3 times using wash buffer (20 mM HEPES pH 7.4, 125 mM NaCl @ 4° C.). Filtermats were then dried, placed in a filter bag, 9 mL betaplate scintillant (Perkin Elmer cat #1205-440) added and filtermats counted on a Wallac Microbeta instrument.

### Results

The screening of 400 library compounds against hNET yielded several hits (>60) of which selected examples are provided in Table 3. Of particular interest is the peptide conjugate corresponding to SEQ ID NO. 4 which, at 2 μM, is equi-potent with the positive comparator, SEQ ID NO. 1 (Xen2174) which has a potency of only 1.5 μM. Thus, a simple screening exercise successfully yielded a number of potential candidates which provides important information on the key binding determinants crucial for hNET binding, and in particular, a lead candidate for potential development as a hNET inhibitor.

TABLE 3
the % inhibition and binding potency of several
library compounds screened against hNET.

| | % inhib @ | | | | | |
|---|---|---|---|---|---|---|
| SEQ ID | 10 μM | Av IC₅₀ | Turn | AA1 | Acyl | AA2 |
| 5 | 101% | ND¹ | 12302² | H | <NH₂(CH₂)₃CO> | K |
| 6 | 94% | ND | 12302 | V | <H₂NNH═CHNH(CH₂)₃CO> | K |
| 7 | 93% | ND | 12302 | R | <(CH3)2CHCH2—CO> | L |
| 8 | 90% | 2.5 μM | 12302 | H | <Nap-(2)-CO | K |
| 9 | 88% | ND | 12302 | R | <Nap-(2)-CO | H |
| 10 | 86% | ND | 12302 | R | {Bzo}/<Py-3-CO> | H |
| 11 | 83% | ND | 12302 | V | {Bzo} | L |
| 12 | 77% | ND | 12307³ | S | <4-HO—Ph—CO> | L |
| 13 | 77% | ND | 12301 | S | <HOOC—(CH₂)₂—CO> | L |
| 14 | 74% | ND | 12302 | R | <Cyclohex-CO> | Y |
| 15 | 74% | ND | 12307 | M | <HOOC—(CH₂)₂—CO> | L |
| 16 | 73% | ND | 12302 | L | <NH2(CH₂)₃CO> | Y |
| 17 | 72% | ND | 12302 | R | <4-HO—Ph—CO> | Y |
| 2 | | 23 μM | 12307 | Y | <NH₂(CH₂)₃CO> | L |
| 3 | | 21 μM | 12301⁴ | Y | <NH₂(CH₂)₃CO> | L |
| 4* | | 2 μM | 12302 | Y | <NH₂(CH₂)₃CO> | L |

¹ND, not determined;
²12302 is the turn inducer is derived from (2S,4R)-Fmoc-4-amino-1- BOC-pyrrolidine-2-carboxylic acid;
³12307 is the turn inducer is derived from (2S,4S)- BOC-4-amino-1-Fmoc-pyrrolidine-2-carboxylic acid;
⁴12301 is the turn inducer is derived from (2S,4S)-Fmoc-4-amino-1-BOC-pyrrolidine-2-carboxylic acid;
*Compared to Xen2174 (SEQ ID NO. 1) which has an IC₅₀ of 1.5 μM; the compound corresponding to SEQ ID NO: 4 is a far more potent inhibitor of hNET.

### Example 6

### Screening of the Peptide Conjugate Library Against a GPCR Target

Expansion of the utility of the peptide libraries was demonstrated by screening against a GPCR target, the human Vasopressin 1b (hV1b) receptor. Preparation of a library in a similar manner to Example 2 in which peptide conjugates having the structure:

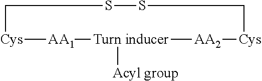

were prepared. The peptide conjugates prepared were then assessed for inhibition of GPCR-human Vasopressin 1b receptor as set out below.

A homogeneous assay was used to determine the ability of compounds to act as inhibitors of the human vasopressin 1b receptor (V1b) as measured by competitive inhibition of ³H-AVP from membrane expressing the V1b receptor.

Total assay volume was 80 μL (20 μL competing ligand, 20 μL SPA beads, 20 μL membrane and 20 μL tritiated ligand). Assay buffer used was Tris HCl (50 mM, pH 7.4), MgCl₂ (10 mM and BSA (0.1%). Peptides were initially screened at a single concentration of 10 μM. Confirmation of any hits was performed using full dose response of the peptide using various concentrations (10⁻⁴ to 10⁻¹¹ M) or control ligand (R8-AVP)—this resulted in the determination of IC₅₀ values. The competing ligands were added to the assay plate followed by Flashblue GPCR scintillating beads at a concentration of 200 μg/well (Perkin Elmer cat #FBB001) and hV1b membrane (Perkin Elmer Life Sciences cat #RBHV1BM) at a concentration of 3.75 μg of protein per well. This was followed by 0.5 nM ³H-AVP (Perkin Elmer cat #NET800A), after which the plate was sealed and incubated at RT for 1 h with shaking. The plate was then counted on a Wallac Microbeta instrument.

The results are shown in Table 4. A number of peptide conjugates demonstrated high levels of inhibition at the concentration tested providing support that this approach can be successfully used to develop libraries to screen for modulators of the important family of GPCR drug targets.

TABLE 4
Peptide conjugates tested at the V1b receptor having >70% inhibition at 10 μM.

| | % inhib @ | | Turn | | | |
|---|---|---|---|---|---|---|
| SEQ ID | 10 μM | Av IC₅₀ | inducer | AA1 | Acyl | AA2 |
| 18 | 100% | ND | 12302 | H | <4-HO—Ph—CO> | L |
| 19 | 99% | ND | 12302 | R | {Bzo} | Y |
| 9 | 97% | 561 nM | 12302 | R | <Nap-(2)-CO | H |
| 20 | 97% | 587 nM | 12302 | R | <Nap-(2)-CO | K |
| 21 | 96% | ND | 12302 | R | <Nap-(2)-CO | Y |
| 22 | 96% | ND | 12302 | R | <4-HO—Ph—CO> | K |
| 23 | 96% | ND | 12302 | Y | <Nap-(2)-CO | K |
| 24 | 94% | ND | 12302 | R | <Cyclohex-CH2—CO> | K |
| 25 | 91% | ND | 12302 | Y | <Nap-(2)—CO | H |
| 26 | 91% | ND | 12302 | R | {Bzo} | Y |
| 27 | 89% | ND | 12302 | R | <Cyclohex-CH₂—CO> | Y |
| 28 | 88% | ND | 12302 | Y | <H2NNH═CHNH(CH₂)₃CO> | K |
| 29 | 88% | ND | 12302 | R | {Bzo} | K |
| 17 | 86% | ND | 12302 | R | <4-HO—Ph—CO> | Y |
| 30 | 85% | ND | 12302 | R | <4-HO—Ph—CO> | L |
| 31 | 84% | ND | 12302 | R | <Cyclohex-CH2—CO> | L |
| 14 | 83% | ND | 12302 | R | <Cyclohex-CO> | Y |
| 32 | 81% | ND | 12302 | Y | <Cyclohex-CH2—CO> | K |
| 33 | 78% | ND | 12302 | R | <Nap-(2)-CO | L |
| 34 | 77% | ND | 12301 | F | <4-HO—Ph—CO> | L |
| 35 | 73% | ND | 12301 | S | <NH₂(CH₂)₃CO> | L |
| 36 | 72% | ND | 12301 | M | <H2NNH═CHNH(CH₂)₃CO> | L |
| 44 | >80% | 1.1 μM | 12301 | R | <cyclohex-CH₂—CO> | Y |

### Example 7

### Screening of the Peptide Conjugate Library Against an Ion Channel Target

Ion channels represent an important family of drug targets. Compounds active at sodium, potassium, calcium, chloride and many other voltage-gated and ligand-gated ion channel types are useful in a number of diseases and conditions including pain, CNS disorders and cystic fibrosis. Animal venoms are a rich source of peptidic ion channel modulators. However, these are often too large to be conveniently administered to humans. For example, Prialt™, a N-type Calcium channel blocker is used for severe pain but because of its large size, can only be administered intrathecally (into the spine) to be effective. Thus there is a great need to develop small molecules or mimetics that can access sites of biological activity through convenient routes of administration.

The current invention provides a way of providing large numbers of compounds that are active against ion channels, useful for developing as drug candidates. By way of exemplary support, the following results demonstrate the utility of the invention in providing a number of hits against the sodium channel, in particular, rat Nav 1.2.

Preparation of a library in a similar manner to Example 2 in which peptide conjugates having the structure:

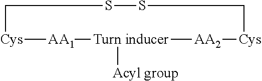

were prepared. The peptide conjugates prepared were then assessed for inhibition of rat Nav1.2 Channel Assay as described below.

A homogeneous assay was used to determine the ability of compounds to act as inhibitors of the rat sodium channel 1.2 (rNav1.2) as measured by competitive inhibition of ¹²⁵H-TIIIA from rat brain homogenate.

Total assay volume was 80 μL (20 μL competing ligand, 20 μL, SPA beads, 20 μL rat brain homogenate and 20 μL iodinated ligand). Assay buffer used was HEPES (20 mM pH7.2), MgCl2 (75 mM), EDTA (0.2 mM), EGTA (0.2 mM), BSA (0.1%) and 2% diluted protease inhibitors (Roche cat #1826145). Peptides were initially screened at a single concentration of 10 μM. Confirmation of any hits was performed using full dose response of the peptide using various concentrations (10⁻⁴ to 10⁻¹¹ M) or control ligand (TIIIA)—this resulted in the determination of IC₅₀ values. The competing ligands were added to the assay plate followed by Flashblue GPCR scintillating beads at a concentration of 100 μg/well (Perkin Elmer cat #FBB001), rat brain membrane and 30 pM ¹²⁵H-TIIIA. After the addition of all reagents the plate was sealed and incubated at RT for 1 h with shaking. The plate was then counted on a Wallac Microbeta instrument.

The results, shown in Table 5, identify several peptides that are inhibitors of the Nav1.2 channel, providing support that this approach is useful in screening for modulaters of ion channels.

TABLE 5
Results of screening peptide conjugate library against Nav1.2 channel

| | % inhib @ | | | | | |
|---|---|---|---|---|---|---|
| SEQ ID | 10 μM | Ave IC₅₀ | Turn | AA1 | Acyl | AA2 |
| 37 | >80% | 4.3 μM | 12302 | F | <H2NNH═CHNH(CH₂)₃CO> | K |
| 22 | >80% | 1.3 μM | 12302 | R | <4-HO—Ph—CO> | K |
| 38 | >80% | 1.3 μM | 12307 | R | <NH₂(CH₂)₃CO> | Y |
| 28 | >70% | 4.7 μM | 12302 | Y | <H2NNH═CHNH(CH2)₃CO> | K |
| 24 | >70% | ND | 12302 | R | <Cyclohex-CH₂—CO> | K |
| 6 | >70% | ND | 12302 | V | <H2NNH═CHNH(CH₂)₃CO> | K |
| 29 | >70% | 2.0 μM | 12302 | R | {Bzo} | K |
| 20 | >70% | ND | 12302 | R | <Nap-(2)-CO | K |
| 39 | >70% | 1.9 μM | 12307 | R | <4-HO—Ph—CO> | K |
| 40 | >70% | 3.4 μM | 12307 | R | <Py-3-CO> | K |
| 41 | >70% | 3.2 μM | 12307 | R | <Nap-(2)-CO | K |
| 42 | >70% | 1.6 μM | 12307 | R | <4-HO—Ph—CO> | H |
| 43 | >70% | 2.2 μM | 12307 | R | {Bzo} | H |
| 45 | >80% | 1.2 μM | 12307 | H | <py-3-CO> | K |

### Example 8

### Screening of Peptide Conjugate Library Against GPCR-human delta2 Opioid Receptor (hδ₂OR)

As discussed in Example 5, the peptide libraries are useful for screening against GPCR targets. In this assay, the GPCR target was hδ₂OR.

Preparation of a library in a similar manner to Example 2 in which peptide conjugates having the structure:

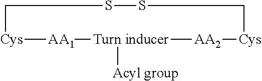

were prepared. The peptide conjugates prepared were then assessed for inhibition of GPCR-hδ₂OR as set out below.

A homogeneous assay was used to determine the ability of compounds to act as inhibitors of the hδ₂OR as measured by competitive inhibition of ³H-Naltrindole from membrane expressing hδ₂OR.

Total assay volume was 80 μL (20 μL competing ligand, 20 μL SPA beads, 20 μL, membrane and 20 μL tritiated ligand). Assay buffer used was Tris HCl (50 mM, pH 7.4), MgCl₂ (5 mM) and BSA (0.1%). Peptides were initially screened at a single concentration of 10 μM. Confirmation of any hits was performed using full dose response of the peptide using various concentrations (10⁻⁴ to 10⁻¹¹M) or control ligand (Naltriben). The competing ligands were added to the assay plate followed by SPA beads at a concentration of 100 μg/well (GE Healthcare, Amersham Cat. #FBB001) and hV1b membrane (Perkin Elmer Life Sciences Cat #RPNQ001). This was followed by 1.6 nM ³H-AVP [for a final concentration 0.4 nM] (Perkin Elmer Cat #NET1065), after which the plate was sealed and incubated at RT for 1 hr with shaking. The plate was then counted on a Wallac Microbeta instrument.

The results are shown in Table 6:

TABLE 6
Results of screening peptides conjugate library against hδ2OR

| | % inh @ | Turn | | | |
|---|---|---|---|---|---|
| SEQ ID | 10 μM | inducer | AA₁ | Acyl | AA₂ |
| 46 | >80% | 12302 | F | <cyclohex-CH₂—CO> | Y |
| 47 | >80% | 12302 | F | <(CH₃)₂CHCH₂CO> | Y |

### Example 9

### Peptide Library Containing a 4-amino-4-carboxypiperidine Turn Inducer

A small library of peptides was prepared as described in Example 1 with the exception that the turn inducers used were:
Boc-4-amino-1-Fmoc-piperidine-4-carboxylic acid (17503)
Fmoc-4-amino-1-Boc-piperidine-4-carboxylic acid (17501)

The peptide library was prepared with the sequence:

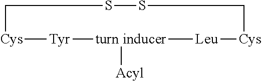

The free amino group of the piperidine ring was decorated with different acyl groups. The peptide conjugates in the library are shown in Table 7:

TABLE 7

| SEQ ID | Turn inducer | Acyl |
|---|---|---|
| 48 | 17503 | <H₂NNH═CHNH(CH₂)₃CO> |
| 49 | 17503 | <4-HO—Ph—CO> |
| 50 | 17503 | <NH₂(CH₂)₃CO> |
| 51 | 17503 | {Bzo} |
| 52 | 17503 | <Nap-2-CO> |
| 53 | 17503 | <4-OH—Ph—CO> |
| 54 | 17503 | <Py-3-CO> |
| 55 | 17503 | <(CH₃)₂CHCH₂CO> |
| 56 | 17503 | <Cyclohex-CH₂—CO> |
| 57 | 17503 | <HOOC—(CH₂)₂CO> |
| 58 | 17501 | <H₂NNH═CHNH(CH₂)₃CO> |
| 59 | 17501 | <4-HO—Ph—CO> |
| 60 | 17501 | <NH₂(CH₂)₃CO> |
| 61 | 17501 | {Bzo} |
| 62 | 17501 | <Nap-2-CO> |
| 63 | 17501 | <4-OH—Ph—CO> |
| 64 | 17501 | <Py-3-CO> |
| 65 | 17501 | <(CH₃)₂CHCH₂CO> |
| 66 | 17501 | <Cyclohex-CH₂—CO> |
| 67 | 17501 | <HOOC—(CH₂)₂CO> |

### Example 10

### Peptide Library Containing a 4-amino-piperidinyl Acetic Acid Turn Inducer

A small library of peptides was prepared as described in Example 1 with the exception that the turn inducer used was:
(4-Fmoc-amino-1-Boc-piperidine-4-yl)acetic acid

The peptide library was prepared with the sequence:

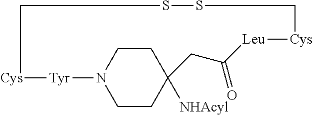

The free amino group in the 4-position was decorated with different acyl to provide the library shown in Table 8:

TABLE 8

| SEQ ID | Acyl Group |
|---|---|
| 68 | <H₂NNH═CHNH(CH₂)₃CO> |
| 69 | <4-HO—Ph—CO> |
| 70 | <NH₂(CH₂)₃CO> |
| 71 | {Bzo} |
| 72 | <Nap-2-CO> |
| 73 | <4-OH—Ph—CO> |
| 74 | <Py-3-CO> |
| 75 | <(CH₃)₂CHCH₂CO> |
| 76 | <Cyclohex-CH₂—CO> |
| 77 | <HOOC—(CH₂)₂CO> |

1. A library of peptide conjugates comprising two or more different peptide conjugates represented by formula (I): 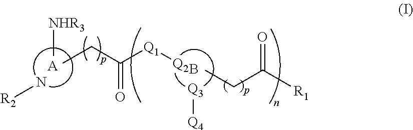
wherein:
A and any B present are independently selected from a 5-7 membered saturated or unsaturated nitrogen-containing heterocyclic ring;
R₁ is an amino acid or a peptide having 2 to 5 amino acid residues, wherein the amino acid or peptide is optionally capped with a C-terminal capping group;
one of R₂ and R₃ is an amino acid or a peptide having 2 to 5 amino acid residues wherein the amino acid or peptide is optionally capped with an N-terminal capping group;
the other of R₂ and R₃ is hydrogen, —C₁₋₁₀alkyl, —C₂₋₁₀alkenyl, —C₂₋₁₀alkynyl, —C₃₋₈ cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group (—CORₐ) or a sulfonyl group (—SO₂—Rₐ); wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆ alkyl, —NH₂, —NH(C₁₋₆ alkyl), —N(C₁₋₆alkyl)₂, —NHC(═NH)NH₂, oxo (═O), —CO₂H, —CO₂C₁₋₆alkyl, —SH or —SC₁₋₆alkyl;
each Q₁ is independently NH or absent;
when Q₁ is NH, Q₂ is C or CH, Q₃ is N and Q₄ is R₄;
when Q₁ is absent, Q₂ is N, Q₃ is C or CH and Q₄ is NHR₄;
each R₄ is independently selected from hydrogen, —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group;
wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2; and
each p is independently 0 or 1;
wherein the carbonyl containing substituents (—(CH₂)ₚCOQ₁) and/or (—(CH₂)ₚCOR₁) are in an α-, β- or γ-position of the A and/or B rings with respect to the A and/or B ring nitrogen atoms;
or a salt thereof.

2. A library of peptide conjugates according to claim 1 wherein at least a portion of the peptide conjugates are cyclic as a result of cyclization between a side chain functional group in R₂ or R₃ or the N-terminus or the N-terminal capping group and a side chain functional group in R₁ or the C-terminus or C-terminal capping group.

3. A library of peptide conjugates according to claim 2 wherein the cyclic peptide conjugates comprise a disulfide, diseleno or sulfoselenium bond between a cysteine, homocysteine, penicillamine or selenocysteine residue in R₁ and a cysteine, homocysteine, penicillamine or selenocysteine residue or a thiol group in the N-terminal capping group of R₂ or R₃.

4. A library of peptide conjugates according to claim 3 wherein the cyclic peptide conjugates comprise a disulfide bond or methylenedithio linker between a cysteine residue in R₁ and a cysteine residue in R₂ or R₃.

5. A library of peptide conjugates according to claim 1 wherein ring A is a 5- or 6-membered saturated or unsaturated nitrogen-containing heterocyclic ring.

6. A library of peptide conjugates according to claim 5 wherein ring A is a 5- or 6-membered saturated nitrogen-containing heterocyclic ring.

7. A library of peptide conjugates according to claim 6 wherein ring A is pyrrolidine or piperidine.

8. A library of peptide conjugates according to claim 1 wherein n is 0.

9. A library of peptide conjugates according to claim 1 wherein R₁ is an amino acid residue or a peptide having 2 to 3 amino acid residues optionally capped with an amide.

10. A library of peptide conjugates according to claim 1 wherein at least a portion of the peptide conjugates have R₂ as an amino acid residue or a peptide having 2 to 3 amino acid residues and R₃ as hydrogen or an acyl group.

11. A library of peptide conjugates according to claim 1 wherein at least a portion of the peptide conjugates have R₃ as an amino acid residue or a peptide having 2 to 3 amino acid residues and R₂ as hydrogen or an acyl group.

12. A library of peptide conjugates according to claim 1 wherein at least a portion of the peptide conjugates have —C(O)R₁ in the α-position with respect to the ring nitrogen atom.

13. A library of peptide conjugates according to claim 1 wherein at least a portion of the peptide conjugates have an A ring which is a 6-membered ring and —C(O)R₁ is in γ-position with respect to the ring nitrogen.

14. A library of peptide conjugates according to claim 1 wherein at least a portion of the peptide conjugates have an acyl group R₂ or R₃ selected from —(C═O)R where R is —C₁₋₆alkyl, —C₀₋₆alkylcycloalkyl, —C₀₋₆alkylNHC(═NH)NH₂, —C₁₋₆alkylCONH₂, —C₁₋₆alkylCO₂H, —C₀₋₆alkylSH, —C₁₋₆alkylCO₂H, —C₀₋₆alkyl(heterocyclyl), —C₀₋₆alkyl(heteroaryl), —C₀₋₆alkylNH₂, —C₀₋₆alkylSC₁₋₆alkyl, —C₀₋₆alkylaryl and —C₀₋₆alkylOH, wherein each aryl, heterocyclyl or heteroaryl group may be optionally substituted with —C₁₋₃alkyl, —OH, —NH₂ or -oxo (C═O).

15. A library of peptide conjugates according to claim 1 comprising two or more peptide conjugates represented by formula III and/or formula IV 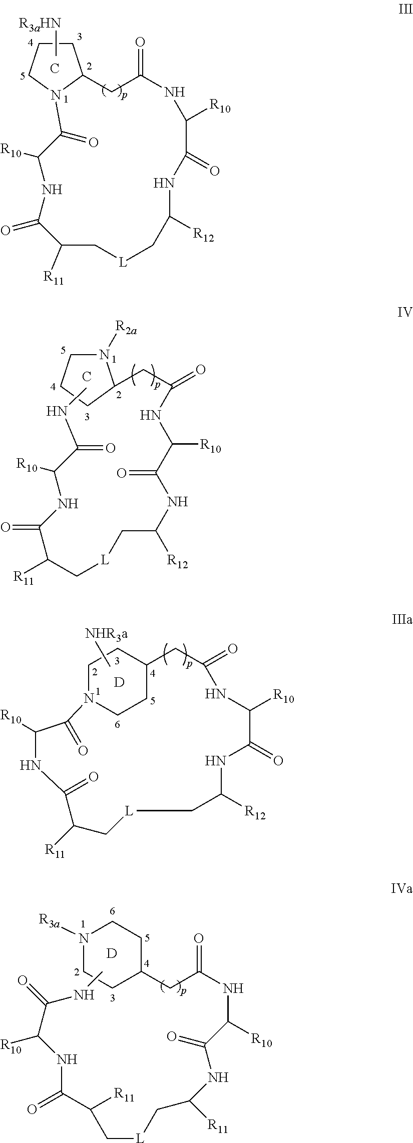
wherein
R₂ₐ and R₃ₐ are hydrogen, acyl, sulfonyl or —C₁₋₆alkyl;
each R₁₀ is independently selected from an amino acid side chain;
R₁₁ is absent or is NR₁₃H where R₁₃ is hydrogen, an N-terminal capping group or an amino acid residue or peptide having 2 or 3 amino acid residues optionally capped with an N-terminal capping group;
R₁₂ is absent or is C(O)R₁₄ where R₁₄ is —OH or —NH₂; and
L is a linker that forms a cyclic peptide; or a salt thereof.

16. A library of peptide conjugates according to claim 15 wherein L is a linker selected from —S—S—, —S—(CH₂)₁₋₃—S—, —Se—Se—, —Se—S—, —S—Se—, —C(O)NH—, —NHC(O)—, —OC(O)—, —C(O)O—, —O—, —NH—, —S— or —CH═CH—.

17. A library of peptide conjugates according to claim 16 wherein L is —S—S—, —S—(CH₂)—S—, —Se—Se—, —Se—S— or —S—Se—.

18. A library of peptide conjugates according to claim 15 wherein the peptides are represented by formula III and/or formula IV.

19. A method of producing a focussed peptide conjugate library, said method comprising the steps of:
i) identifying a bioactive turn-containing peptide and its target receptor or enzyme;
ii) identifying amino acid residues around the turn in the bioactive peptide;
iii) preparing a focussed library comprising two or more peptide conjugates of formula (V) 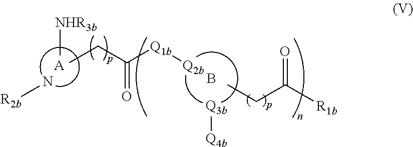
wherein A and any B present are independently selected from a 5-7 membered saturated or unsaturated nitrogen-containing heterocyclic ring;
R_{1b} is an amino acid residue or a peptide of 2 to 5 residues wherein the amino acid residue or peptide is optionally capped with a C-terminal capping group;
one of R_{2b} and R_{3b} is hydrogen, a substituent selected from —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
the other of R_{2b} and R_{3b} is an amino acid or a peptide of 2 to 5 residues wherein the amino acid or peptide is optionally capped with an N-terminal capping group;
each Q_{1b} is independently NH or absent;
when Q_{1b} is NH, Q_{2b} is C or CH, Q_{3b} is N and Q_{4b} is R_{4b};
when Q_{1b} is absent, Q_{2b} is N, Q_{3b} is C or CH and Q_{4b} is NHR_{4b};
each R_{4b} is independently selected from hydrogen, a substituent selected from —C₁₋₁₀alkyl, —C₂₋₁₀alkenyl, —C₂₋₁₀alkynyl, —C₃₋₈cycloalkyl, —C₀₋₆alkylaryl, —C₀₋₆alkylheterocyclyl, —C₀₋₆alkylheteroaryl, —C₁₋₆alkylCON(Rₐ)₂, —C₁₋₆alkylN(Rₐ)₂, —C₁₋₆alkylCO₂Rₐ, —C₁₋₆alkylORₐ, —C₁₋₆alkylSRₐ, —C₁₋₆alkylNRₐC(═NRₐ)N(Rₐ)₂, —C₁₋₆alkylNRₐSO₂Rₐ, —C₁₋₆alkylSO₂Rₐ, —C₁₋₆alkylOPO₃Rₐ, an acyl group or a sulfonyl group; wherein each Rₐ is independently selected from hydrogen, —C₁₋₆alkyl, cycloalkyl, aryl, heterocyclyl and heteroaryl and wherein each alkyl, alkenyl, alkynyl, cycloalkyl, aryl, heterocyclyl and heteroaryl group is optionally substituted with one or more of —C₁₋₆alkyl, —C₂₋₆alkenyl, —C₂₋₆alkynyl, halo, —OH, —OC₁₋₆alkyl, —NH₂, —NH(C₁₋₆alkyl), —N(C₁₋₆alkyl)₂, —NHC(═NH)NH₂, oxo (═O), —CO₂H, —CO₂C₁₋₆alkyl, —SH or —SC₁₋₆alkyl;
n is 0, 1 or 2;
each p is independently 0 or 1;
wherein at least one amino acid of R_{1b}, R_{2b} or R_{3b} is an amino acid that forms part of the peptide turn in the bioactive turn-containing peptide or an amino acid that is a conservative substitution thereof and/or at least one of R_{2b}, R_{3b} or R_{4b} is a substituent, acyl group or sulfonyl group that mimics the side chain of an amino acid residue that forms part of the peptide turn in the bioactive turn-containing peptide or a conservative substitution thereof; and
wherein the carbonyl containing substituents (—(CH₂)ₚCOQ_{1b}) and/or (—(CH₂)ₚCOR_{1b}) are in an α-, β- or γ-position of the A and/or B rings with respect to the A and/or B ring nitrogen atoms; or a salt thereof.

20. A method of preparing a library of peptide conjugates comprising the steps of:
i) preparing a first peptide attached to a compartmentalized solid phase support through a safety catch linker,
ii) introducing a turn inducer represented by the formula (II) 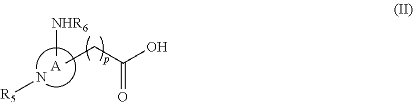
wherein A is a 5-7 membered saturated or unsaturated nitrogen-containing heterocyclic ring, p is 0 or 1, R₅ and R₆ are independently orthogonal amino protecting groups wherein at least one protecting group is stable under conditions used to deprotect the other amino protecting group, wherein the carboxylic acid or acetyl substituent is in the α-, β- or γ-position of the ring with respect to the ring nitrogen atom;
iii) deprotecting one of the amino protecting groups R₅ or R₆ on the N-terminal turn inducer;
iv) optionally repeating steps ii) and iii) one or two more times;
v) introducing a second peptide at the free amino group of the N-terminal turn inducer;
vi) deprotecting the remaining turn inducer protecting group(s), R₅ or one to three R₆s, the N-terminal protecting group and side chain protecting groups; and
vii) cleaving the peptide conjugates from the compartmentalized solid support and linker;
wherein the first peptide and second peptide independently comprise 1 to 5 amino acid residues; and
wherein at least one of preparing the first peptide, introducing the turn inducer(s), and introducing the amino acids of the second peptide involves a split and mix strategy to introduce variation into the amino acid sequence or turn inducer of the peptide conjugate.

21. A method of preparing a library of peptide conjugates according to claim 20 further comprising the step of cyclizing the peptide conjugate.

22. A method of preparing a library of peptide conjugates according to claim 21 wherein cyclization occurs between a cysteine, homocysteine, penicillamine or selenocysteine residue in the first peptide and a cysteine, homocysteine, penicillamine or selenocysteine residue or a thiol group in the N-terminal capping group in the second peptide.

23. A method of preparing a library of peptide conjugates according to claim 21 wherein cyclization occurs between a cysteine residue in the first peptide and a cysteine residue in the second peptide.

24. A method of preparing a library of peptide conjugates according to claim 23 wherein cyclization occurs after peptide conjugate cleavage from the solid phase support and linker.

25. A method of preparing a library of peptide conjugates according to claim 20 wherein the compartmentalized solid phase support is a resin coated Lantern.

26. A method of preparing a library of peptide conjugates according to claim 20 wherein the safety catch linker is SCAL linker.

27. A method of preparing a library of peptide conjugates according to claim 20 wherein the peptide conjugates are synthesized using BOC chemistry.

28. A method of preparing a library of peptide conjugates according to claim 20 wherein one of R₅ and R₆ is BOC and the other is Fmoc.

29. A method of preparing a library of peptide conjugates according to claim 20 further comprising acylating at least a portion of the free amino group of the turn inducer after deprotection in step vi) with an acylating agent.

30. A method of preparing a library of peptide conjugates according to claim 29, wherein the acylating agent mimics the side chain of an amino acid.

31. A method of preparing a library of peptide conjugates according to claim 20 comprising the step of:
i) preparing a first peptide attached to a lantern solid phase support through a SCAL linker;
ii) introducing a turn inducer represented by the formula (IIa) 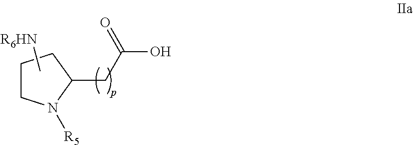
wherein one of R₅ and R₆ is BOC and the other is Fmoc, p is 0 or 1;
iii) deprotecting the BOC group;
iv) introducing a second peptide at the free amino group of the turn inducer;
v) deprotecting the Fmoc group from the turn inducer to provide a free amino group;
vi) deprotecting the N-terminal protecting groups and the side chain protecting groups; and
vii) cleaving the peptide conjugates from the lantern and linker;
wherein the first peptide and the second peptide independently comprise the two amino acid residues in which the first amino acid residue introduced into the first peptide and the second amino acid residue introduced into the second peptide are residues have a thiol or selenol group, optionally protected;
the method further comprising cyclizing the peptide conjugate to form a disulfide, diseleno or sulfoseleno bond, and
wherein at least one of preparing the first peptide, introducing the turn inducer and introducing the second peptide involves a split and mix strategy to introduce variation into the amino acid sequence or turn inducer of the peptide conjugate.

32. A method of preparing a library of peptide conjugates according to claim 20 comprising the step of:
(i) preparing a first peptide attached to a lantern solid phase support through a SCAL linker;
(ii) introducing a turn inducer represented by the formula (IIb) 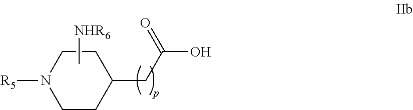
wherein one of R₅ and R₆ is BOC and the other is Fmoc, p is 0 or 1;
(iii) deprotecting the BOC group;
(iv) introducing a second peptide at the free amino group of the turn inducer;
(v) deprotecting the Fmoc group from the turn inducer to provide a free amino group;
(vi) deprotecting the N-terminal protecting groups and the side chain protecting groups; and
(vii) cleaving the peptide conjugates from the lantern and linker;
wherein the first peptide and the second peptide independently comprise the two amino acid residues in which the first amino acid residue introduced into the first peptide and the second amino acid residue introduced into the second peptide are residues have a thiol or selenol group, optionally protected;
the method further comprising cyclizing the peptide conjugate to form a disulfide, diseleno or sulfoseleno bond, and
wherein at least one of preparing the first peptide, introducing the turn inducer and introducing the second peptide involves a split and mix strategy to introduce variation into the amino acid sequence or turn inducer of the peptide conjugate.

33. A method according to claim 31 further comprising acylating at least a portion of the free amino group of the turn inducer after deprotection in step v), with an acylating agent.

34. A method according to claim 33, wherein the acylating agent mimics the side chain of an amino acid.

35. (canceled)

36. (canceled)

37. (canceled)

38. (canceled)

39. A method according to claim 32 further comprising acylating at least a portion of the free amino group of the turn inducer after deprotection in step v), with an acylating agent.

40. A method according to claim 39, wherein the acylating agent mimics the side chain of an amino acid.


SEQUENCE LISTING (77 sequences)

SEQ ID NO: 1 - protein, 13 aa, Artificial Sequence
  Synthetic
XGVCCGYKLCHXC

SEQ ID NO: 2 - protein, 5 aa, Artificial Sequence
  Synthetic
CYXLC

SEQ ID NO: 3 - protein, 5 aa, Artificial Sequence
  Synthetic
CYXLC

SEQ ID NO: 4 - protein, 5 aa, Artificial Sequence
  Synthetic
CYXLC

SEQ ID NO: 5 - protein, 5 aa, Artificial Sequence
  Synthetic
CHXKC

SEQ ID NO: 6 - protein, 5 aa, Artificial Sequence
  Synthetic
CVXKC

SEQ ID NO: 7 - protein, 5 aa, Artificial Sequence
  Synthetic
CRXLC

SEQ ID NO: 8 - protein, 5 aa, Artificial Sequence
  Synthetic
CHXKC

SEQ ID NO: 9 - protein, 5 aa, Artificial Sequence
  Synthetic
CRXHC

SEQ ID NO: 10 - protein, 5 aa, Artificial Sequence
  Synthetic
CRXHC

SEQ ID NO: 11 - protein, 5 aa, Artificial Sequence
  Synthetic
CVXLC

SEQ ID NO: 12 - protein, 5 aa, Artificial Sequence
  Synthetic
CSXLC

SEQ ID NO: 13 - protein, 5 aa, Artificial Sequence
  Synthetic
CSXLC

SEQ ID NO: 14 - protein, 5 aa, Artificial Sequence
  Synthetic
CRXYC

SEQ ID NO: 15 - protein, 5 aa, Artificial Sequence
  Synthetic
CMXLC

SEQ ID NO: 16 - protein, 5 aa, Artificial Sequence
  Synthetic
CLXYC

SEQ ID NO: 17 - protein, 5 aa, Artificial Sequence
  Synthetic
CRXYC

SEQ ID NO: 18 - protein, 5 aa, Artificial Sequence
  Synthetic
CHXLC

SEQ ID NO: 19 - protein, 5 aa, Artificial Sequence
  Synthetic
CRXYC

SEQ ID NO: 20 - protein, 5 aa, Artificial Sequence
  Synthetic
CRXKC

SEQ ID NO: 21 - protein, 5 aa, Artificial Sequence
  Synthetic
CRXYC

SEQ ID NO: 22 - protein, 5 aa, Artificial Sequence
  Synthetic
CRXKC

SEQ ID NO: 23 - protein, 5 aa, Artificial Sequence
  Synthetic
CYXKC

SEQ ID NO: 24 - protein, 5 aa, Artificial Sequence
  Synthetic
CRXKC

SEQ ID NO: 25 - protein, 5 aa, Artificial Sequence
  Synthetic
CYXHC

SEQ ID NO: 26 - protein, 5 aa, Artificial Sequence
  Synthetic
CRXYC

SEQ ID NO: 27 - protein, 5 aa, Artificial Sequence
  Synthetic
CRXYC

SEQ ID NO: 28 - protein, 5 aa, Artificial Sequence
  Synthetic
CYXKC

SEQ ID NO: 29 - protein, 5 aa, Artificial Sequence
  Synthetic
CRXKC

SEQ ID NO: 30 - protein, 5 aa, Artificial Sequence
  Synthetic
CRXLC

SEQ ID NO: 31 - protein, 5 aa, Artificial Sequence
  Synthetic
CRXLC

SEQ ID NO: 32 - protein, 5 aa, Artificial Sequence
  Synthetic
CYXKC

SEQ ID NO: 33 - protein, 5 aa, Artificial Sequence
  Synthetic
CRXLC

SEQ ID NO: 34 - protein, 5 aa, Artificial Sequence
  Synthetic
CFXLC

SEQ ID NO: 35 - protein, 5 aa, Artificial Sequence
  Synthetic
CSXLC

SEQ ID NO: 36 - protein, 5 aa, Artificial Sequence
  Synthetic
CMXLC

SEQ ID NO: 37 - protein, 5 aa, Artificial Sequence
  Synthetic
CFXKC

SEQ ID NO: 38 - protein, 5 aa, Artificial Sequence
  Synthetic
CRXYC

SEQ ID NO: 39 - protein, 5 aa, Artificial Sequence
  Synthetic
CRXKC

SEQ ID NO: 40 - protein, 5 aa, Artificial Sequence
  Synthetic
CRXKC

SEQ ID NO: 41 - protein, 5 aa, Artificial Sequence
  Synthetic
CRXKC

SEQ ID NO: 42 - protein, 5 aa, Artificial Sequence
  Synthetic
CRXHC

SEQ ID NO: 43 - protein, 5 aa, Artificial Sequence
  Synthetic
CRXHC

SEQ ID NO: 44 - protein, 5 aa, Artificial Sequence
  Synthetic
CRXYC

SEQ ID NO: 45 - protein, 5 aa, Artificial Sequence
  Synthetic
CHXKC

SEQ ID NO: 46 - protein, 5 aa, Artificial Sequence
  Synthetic
CFXYC

SEQ ID NO: 47 - protein, 5 aa, Artificial Sequence
  Synthetic
CFXYC

SEQ ID NO: 48 - protein, 5 aa, Artificial Sequence
  Synthetic
CYXLC

SEQ ID NO: 49 - protein, 5 aa, Artificial Sequence
  Synthetic
CYXLC

SEQ ID NO: 50 - protein, 5 aa, Artificial Sequence
  Synthetic
CYXLC

SEQ ID NO: 51 - protein, 5 aa, Artificial Sequence
  Synthetic
CYXLC

SEQ ID NO: 52 - protein, 5 aa, Artificial Sequence
  Synthetic
CYXLC

SEQ ID NO: 53 - protein, 5 aa, Artificial Sequence
  Synthetic
CYXLC

SEQ ID NO: 54 - protein, 5 aa, Artificial Sequence
  Synthetic
CYXLC

SEQ ID NO: 55 - protein, 5 aa, Artificial Sequence
  Synthetic
CYXLC

SEQ ID NO: 56 - protein, 5 aa, Artificial Sequence
  Synthetic
CYXLC

SEQ ID NO: 57 - protein, 5 aa, Artificial Sequence
  Synthetic
CYXLC

SEQ ID NO: 58 - protein, 5 aa, Artificial Sequence
  Synthetic
CYXLC

SEQ ID NO: 59 - protein, 5 aa, Artificial Sequence
  Synthetic
CYXLC

SEQ ID NO: 60 - protein, 5 aa, Artificial Sequence
  Synthetic
CYXLC

SEQ ID NO: 61 - protein, 5 aa, Artificial Sequence
  Synthetic
CYXLC

SEQ ID NO: 62 - protein, 5 aa, Artificial Sequence
  Synthetic
CYXLC

SEQ ID NO: 63 - protein, 5 aa, Artificial Sequence
  Synthetic
CYXLC

SEQ ID NO: 64 - protein, 5 aa, Artificial Sequence
  Synthetic
CYXLC

SEQ ID NO: 65 - protein, 5 aa, Artificial Sequence
  Synthetic
CYXLC

SEQ ID NO: 66 - protein, 5 aa, Artificial Sequence
  Synthetic
CYXLC

SEQ ID NO: 67 - protein, 5 aa, Artificial Sequence
  Synthetic
CYXLC

SEQ ID NO: 68 - protein, 5 aa, Artificial Sequence
  Synthetic
CYXLC

SEQ ID NO: 69 - protein, 5 aa, Artificial Sequence
  Synthetic
CYXLC

SEQ ID NO: 70 - protein, 5 aa, Artificial Sequence
  Synthetic
CYXLC

SEQ ID NO: 71 - protein, 5 aa, Artificial Sequence
  Synthetic
CYXLC

SEQ ID NO: 72 - protein, 5 aa, Artificial Sequence
  Synthetic
CYXLC

SEQ ID NO: 73 - protein, 5 aa, Artificial Sequence
  Synthetic
CYXLC

SEQ ID NO: 74 - protein, 5 aa, Artificial Sequence
  Synthetic
CYXLC

SEQ ID NO: 75 - protein, 5 aa, Artificial Sequence
  Synthetic
CYXLC

SEQ ID NO: 76 - protein, 5 aa, Artificial Sequence
  Synthetic
CYXLC

SEQ ID NO: 77 - protein, 5 aa, Artificial Sequence
  Synthetic
CYXLC